(19) United States
(12) Patent Application Publication
(10) Pub. No.: US 2024/0414772 A1
(43) Pub. Date: Dec. 12, 2024

(54) METHOD AND APPARATUS FOR CHANGING CONDITIONAL PSCELL IN CONSIDERATION OF CELL GROUP ACTIVATION OR DEACTIVATION IN NEXT-GENERATION MOBILE COMMUNICATION SYSTEM

(71) Applicant: Samsung Electronics Co., Ltd., Suwon-si, Gyeonggi-do (KR)

(72) Inventor: Donggun KIM, Suwon-si (KR)

(21) Appl. No.: 18/700,997

(22) PCT Filed: Oct. 19, 2022
(86) PCT No.: PCT/KR2022/015966

§ 371 Date: Apr. 12, 2024

(30) Foreign Application Priority Data
Oct. 20, 2021 (KR) 10-2021-0139877

(51) Int. Cl. H04W 74/0833; H04W 36/36; H04W 76/27

(52) U.S. Cl. CPC H04W 74/0833; H04W 36/362; H04W 76/27

(57) ABSTRACT

The present disclosure relates to a 5G or 6G communication system for supporting a higher data transmission rate. According to embodiments of the present disclosure, a method and apparatus for quickly activating cells in a next-generation mobile communication system may be provided.

### TECHNICAL FIELD

The disclosure relates to a method and an apparatus capable of quickly activating a cell in a next-generation mobile communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G.

In the initial stage of 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as V2X for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In a next-generation mobile communication system, carrier aggregation (CA) or dual connectivity (DC) may be used to provide UEs with services having high data transmission rates and low transmission delay. However, there is a need for a method for preventing processing delay that may occur when the CA or DC is configured for a UE connected to a network and then activated, or when the CA or DC is used and then deactivated. Particularly, if a UE maintains multiple cells activated in order to use the CA or DC, the UE's battery consumption may become severe because the UE needs to perform PDCCH monitoring with regard to each cell. On the other hand, if the multiple cells are maintained deactivated in order to reduce the UE's battery consumption, data transmission/reception may be delayed due to the delay occurring when the multiple cells are activated by using the CA or DC.

Therefore, an aspect of an embodiment of the disclosure is to provide a new dormant mode or suspension mode or deactivated mode such that a UE in a radio resource control (RRC) connected mode, which has configured connection with a network in a next-generation mobile communication system, can quickly activate and deactivate the CA or DC.

In addition, another aspect of an embodiment of the disclosure is to provide a method wherein a new hibernation or dormancy or suspension mode can be operated at a bandwidth part level or at a cell level or at a cell group level (for example, with regard to a secondary cell group) such that the CA or DC can be quickly activated, and the UE's battery can be saved.

In addition, another aspect of an embodiment of the disclosure is to temporarily configure or allocate or send a large amount of transmission resources which may be used by a UE to perform channel measurement when a base station instructs the UE to activate a cell (PCell or PScell or SCell), and to enable the UE to quickly activate the cell, based on the channel measurement, or by quickly reporting the channel measurement result to the base station.

The technical subjects pursued in the disclosure may not be limited to the above-mentioned technical subjects, and other technical subjects which are not mentioned may be clearly understood, through the following descriptions, by those skilled in the art to which the disclosure pertains.

### Solution to Problem

In order to solve the above-mentioned problems, a method performed by a terminal in a wireless communication system according to an embodiment of the disclosure may include: receiving a first message including configuration information related to conditional reconfiguration from a base station; selecting a cell or a cell group in case that a preconfigured condition is satisfied based on the configuration information related to the conditional reconfiguration; and performing a random access procedure with the cell or the cell group, wherein, in case that the first message includes the configuration information related to the conditional reconfiguration, the first message may not include information indicating that a secondary cell group (SCG) is in a deactivated state.

In addition, the conditional reconfiguration may include at least one of conditional handover, conditional primary cell (PCell) addition, conditional PCell change, conditional primary secondary cell (PSCell) addition, or conditional PSCell addition.

In addition, the method may further include receiving a second message for radio resource control (RRC) reconfiguration from the base station, and, in case that the conditional reconfiguration is configured for the terminal according to the first message, the second message may not include information indicating that the SCG is in a deactivated state.

In addition, the method may further include, in case that the first message includes configuration information related to frequency measurement, the terminal is configured for dual connectivity (DC), the SCG is not in a deactivated state, and a signaling radio bearer 3 (SRB3) is configured for the terminal, submitting a frequency measurement report message to a lower layer device to transmit the frequency measurement report message via the SRB3.

In addition, in order to solve the above-mentioned problems, a method performed by a base station in a wireless communication system according to an embodiment of the disclosure may include: transmitting a first message including configuration information related to conditional reconfiguration to a terminal; and receiving, from the terminal, a random access preamble regarding a cell or a cell group related to the base station selected in case that a preconfigured condition is satisfied, based on the configuration information related to the conditional reconfiguration, wherein, in case that the first message includes configuration information related to the conditional reconfiguration, the first message may not include information indicating that a secondary cell group (SCG) is in a deactivated state.

In addition, the conditional reconfiguration may include at least one of conditional handover, conditional primary cell (PCell) addition, conditional PCell change, conditional primary secondary cell (PSCell) addition, or conditional PSCell addition.

In addition, the method may further include transmitting a second message for radio resource control (RRC) reconfiguration to the terminal, and, in case that the conditional reconfiguration is configured for the terminal according to the first message, the second message may not include information indicating that the SCG is in a deactivated state.

In addition, in order to solve the above-mentioned problems, a terminal in a wireless communication system according to an embodiment of the disclosure may include: a transceiver; and a controller coupled with the transceiver and configured to receive a first message including configuration information related to conditional reconfiguration from a base station, select a cell or a cell group in case that a preconfigured condition is satisfied based on the configuration information related to the conditional reconfiguration, and perform a random access procedure with the cell or the cell group, wherein, in case that the first message includes the configuration information related to the conditional reconfiguration, the first message may not include information indicating that a secondary cell group (SCG) is in a deactivated state.

In addition, in order to solve the above-mentioned problems, a base station in a wireless communication system according to an embodiment of the disclosure may include: a transceiver; and a controller coupled with the transceiver and configured to transmit a first message including configuration information related to conditional reconfiguration to a coupled with, and receive, from the coupled with, a random access preamble regarding a cell or a cell group related to the base station selected in case that a preconfigured condition is satisfied, based on the configuration information related to the conditional reconfiguration, wherein, in case that the first message includes the configuration information related to the conditional reconfiguration, the first message may not include information indicating that a secondary cell group (SCG) is in a deactivated state.

### Advantageous Effects of Invention

An embodiment of the disclosure proposes a new dormant mode or suspension mode or deactivated mode such that a UE in a radio resource control (RRC) connected mode, which has configured connection with a network in a next-generation mobile communication system, can quickly activate and deactivate CA or DC.

An embodiment of the disclosure proposes a method wherein a new hibernation or dormancy or suspension mode can be operated at a bandwidth part level or at a cell level or at a cell group level (for example, with regard to a secondary cell group) such that the CA or DC can be quickly activated, and the UE's battery can be saved.

In addition, an embodiment of the disclosure temporarily configures or allocates or sends a large amount of transmission resources which may be used by a UE to perform channel measurement when a base station instructs the UE to activate a cell (PCell or PScell or SCell), and enables the UE to quickly activate the cell, based on the channel measurement, or by quickly reporting the channel measurement result to the base station.

Advantageous effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

FIG. 1A illustrates the structure of an LTE system according to an embodiment of the disclosure.

FIG. 1B illustrates the structure of a radio protocol structure in an LTE system according to an embodiment of the disclosure.

FIG. 1C illustrates the structure of a next-generation mobile communication system according to an embodiment of the disclosure.

FIG. 1D illustrates the structure of a radio protocol structure in a next-generation mobile communication system according to an embodiment of the disclosure.

FIG. 1EA illustrates a procedure for providing a service to a UE by efficiently using a substantially large frequency bandwidth in a next-generation mobile communication system according to an embodiment of the disclosure.

FIG. 1EB illustrates a procedure for providing a service to a UE by efficiently using a substantially large frequency bandwidth in a next-generation mobile communication system according to an embodiment of the disclosure.

FIG. 1F illustrates a procedure in which a UE switches from an RRC idle mode to an RRC connected mode in a next-generation mobile communication system according to an embodiment of the disclosure, and illustrates a procedure in which bearer configuration information for connection or cell group or cell configuration information or channel measurement configuration information is configured for a UE.

FIG. 1G illustrates a bandwidth part-specific state transition or bandwidth part switching procedure according to an embodiment of the disclosure.

FIG. 1H illustrates a DRX configurating or DRX operating method which can save a UE's battery according to an embodiment of the disclosure.

FIG. 1I illustrates the concept of a method for operating a dormant bandwidth part in an activated SCell or PSCell according to an embodiment of the disclosure.

FIG. 1J illustrates an embodiment in which embodiments proposed in the disclosure are expanded and applied to an RRC deactivated mode UE.

FIG. 1K illustrates a signaling procedure in which dual connectivity is configured or released in a next-generation mobile communication system according to an embodiment of the disclosure, or in which a secondary cell group configured by the dual connectivity is activated or resumed or suspended or deactivated.

FIG. 1L illustrates a second signaling procedure in which dual connectivity according to an embodiment of the disclosure is configured or released, or in which a secondary cell group configured by the dual connectivity is configured or released or activated or resumed or suspended or deactivated.

FIG. 1M illustrates a third signaling procedure in which dual connectivity according to an embodiment of the disclosure is configured or released, or in which a secondary cell group configured by the dual connectivity is configured or released or activated or resumed or suspended or deactivated.

FIG. 1N illustrates operations of a UE according to an embodiment of the disclosure.

FIG. 1O illustrates signaling procedures regarding a conditional handover method according to an embodiment of the disclosure.

FIG. 1P illustrates a procedure in which a conditional reconfiguration procedure according to an embodiment of the disclosure is started through a secondary base station (or a cell or a cell group or a secondary node (SN) or an SCG) or configured or instructed through a source base station (or a cell or a cell group or a master node (MN) or an MCG).

FIG. 1Q illustrates a procedure in which a conditional reconfiguration procedure according to an embodiment of the disclosure is started or configured or instructed through a secondary base station (or a cell or a cell group or a secondary node (SN) or an SCG).

FIG. 1R illustrates the structure of a UE according to an embodiment of the disclosure.

FIG. 1S illustrates the block configuration of a base station according to an embodiment of the disclosure.

### MODE FOR THE INVENTION

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, terms and names defined in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “eNB” may be interchangeably used with the term “gNB”. That is, a base station described as “eNB” may indicate “gNB”.

In the foregoing or in the disclosure, a cell may indicate a primary cell (PCell) or a secondary cell (SCell) (e.g., a SCell configured for a master cell group (MCG)) or a primary secondary cell (primary SCG cell, PSCell) (e.g., a PCell of a secondary Cell group (SCG)) or SCell (e.g., an SCell configured for a secondary cell group (SCG)) or a special cell (SpCell).

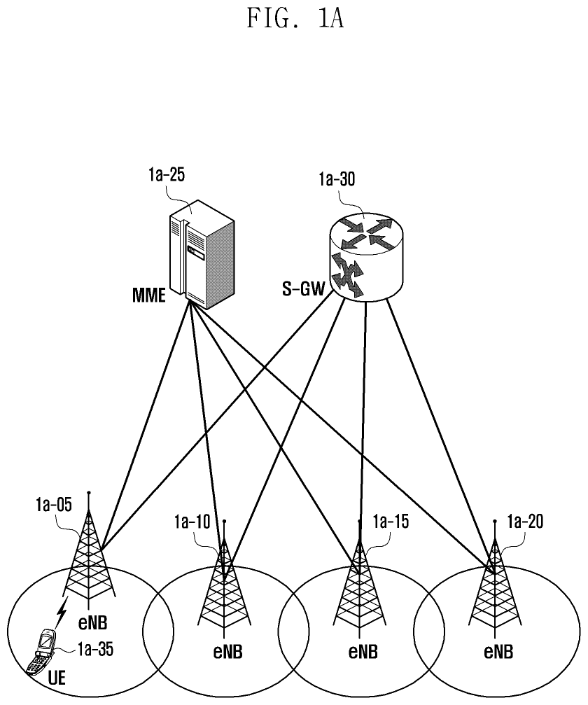

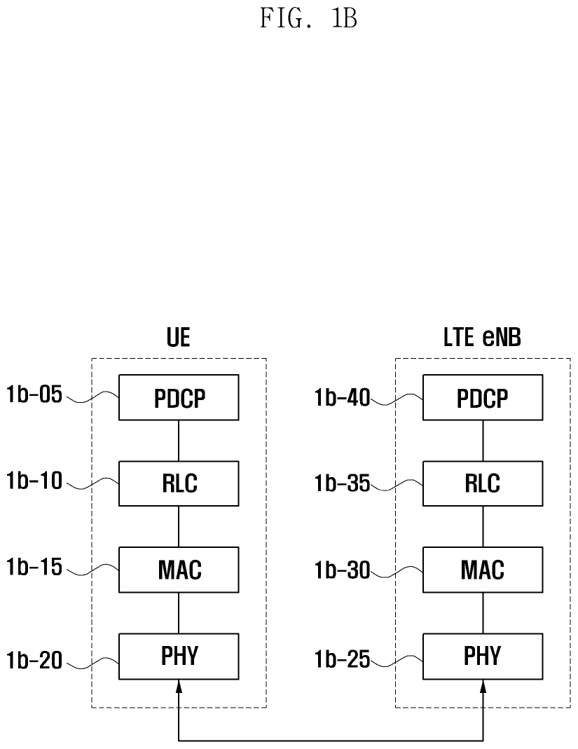

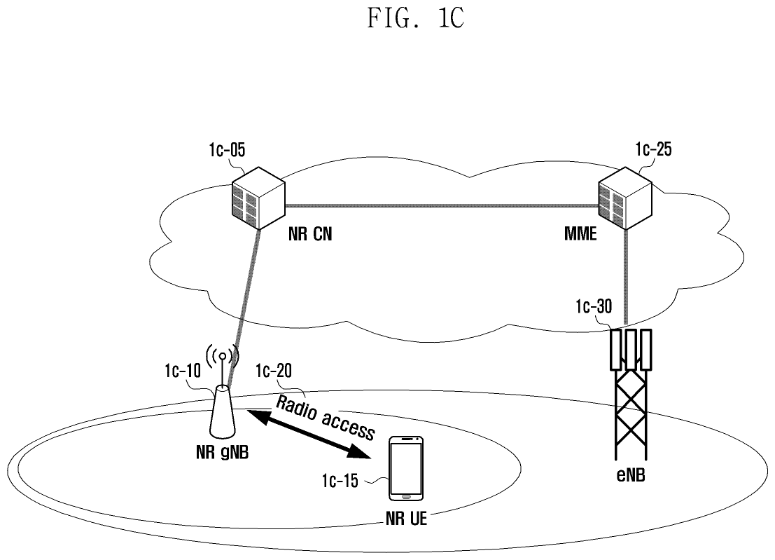

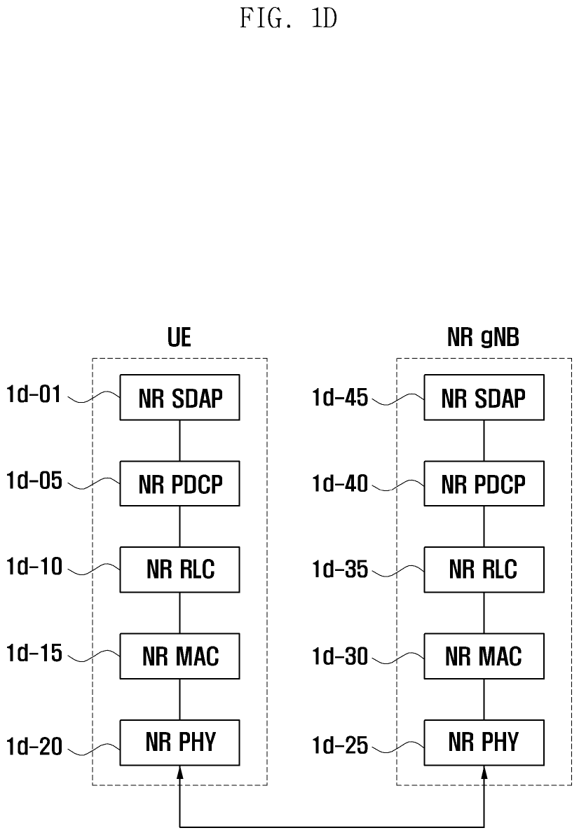

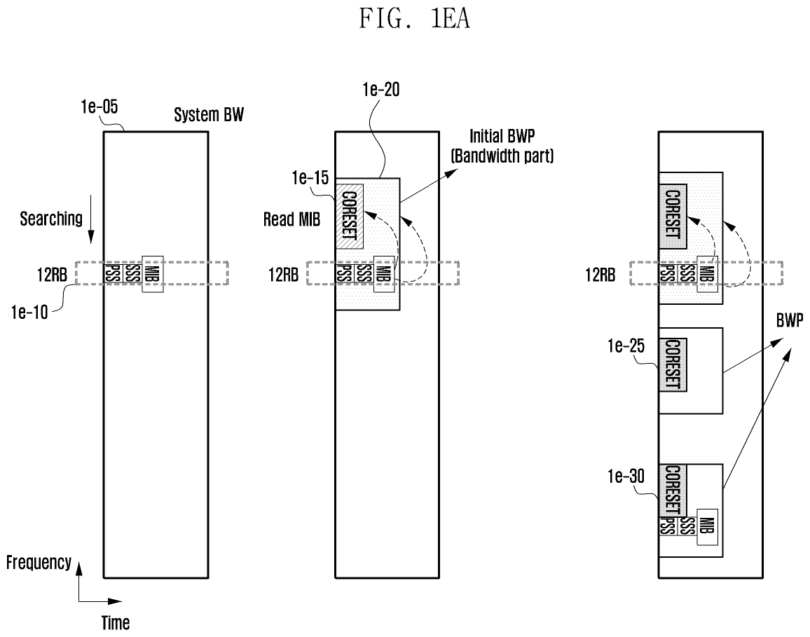

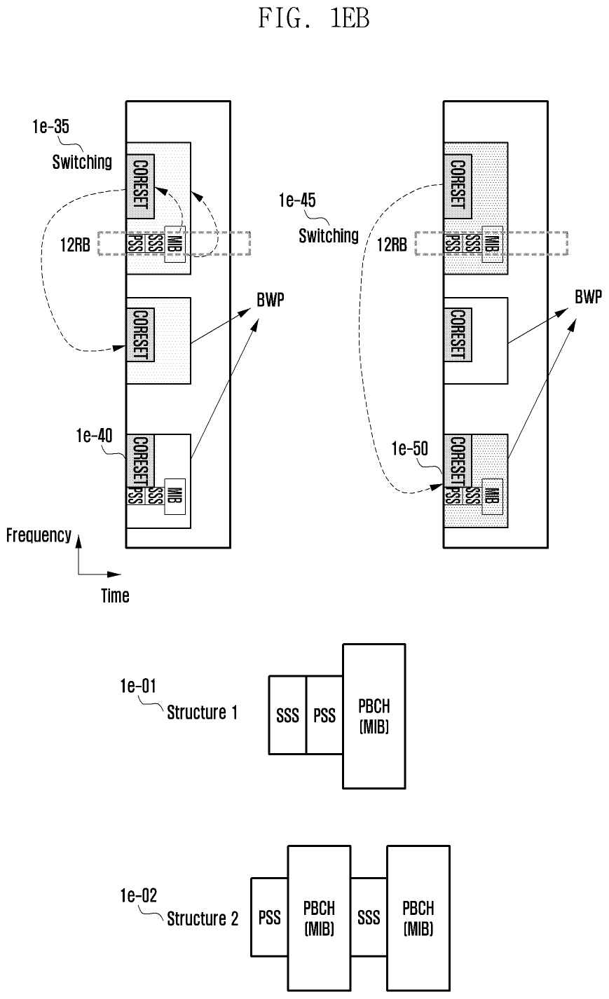

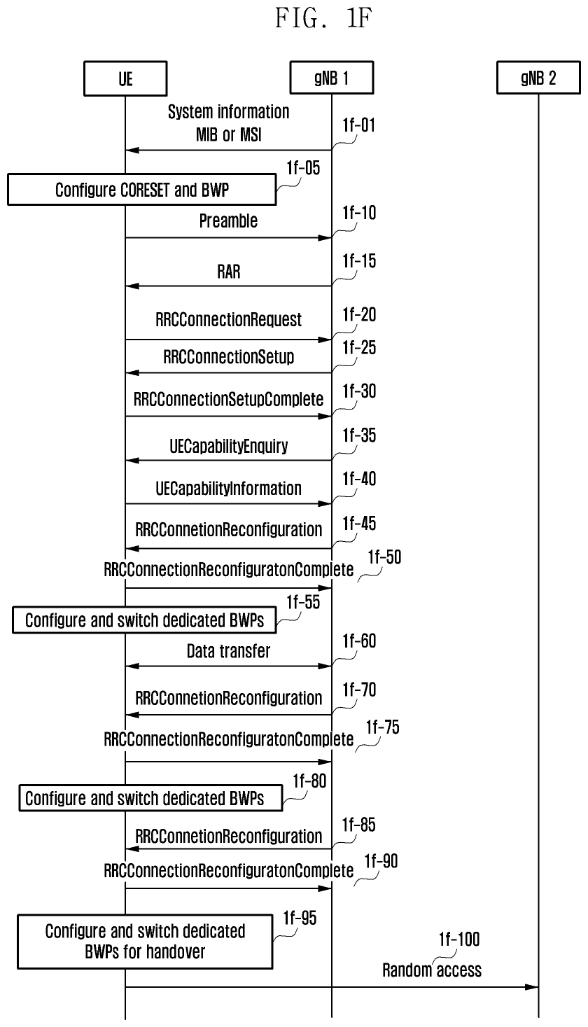

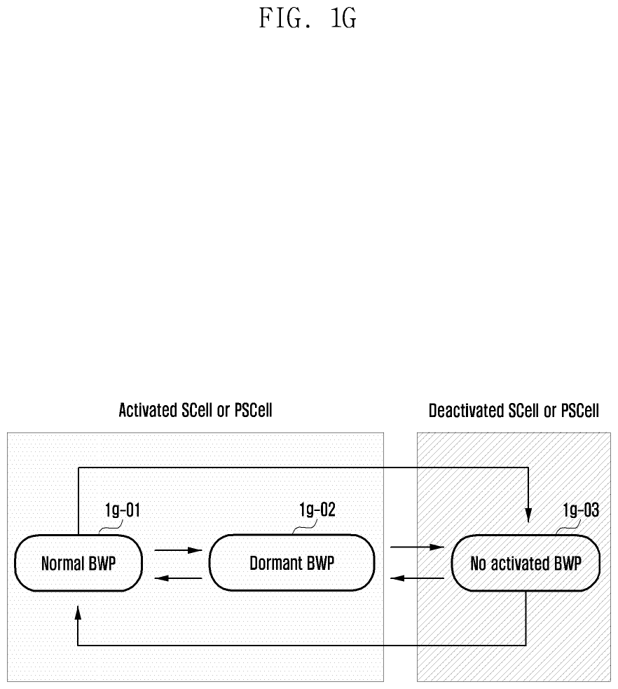

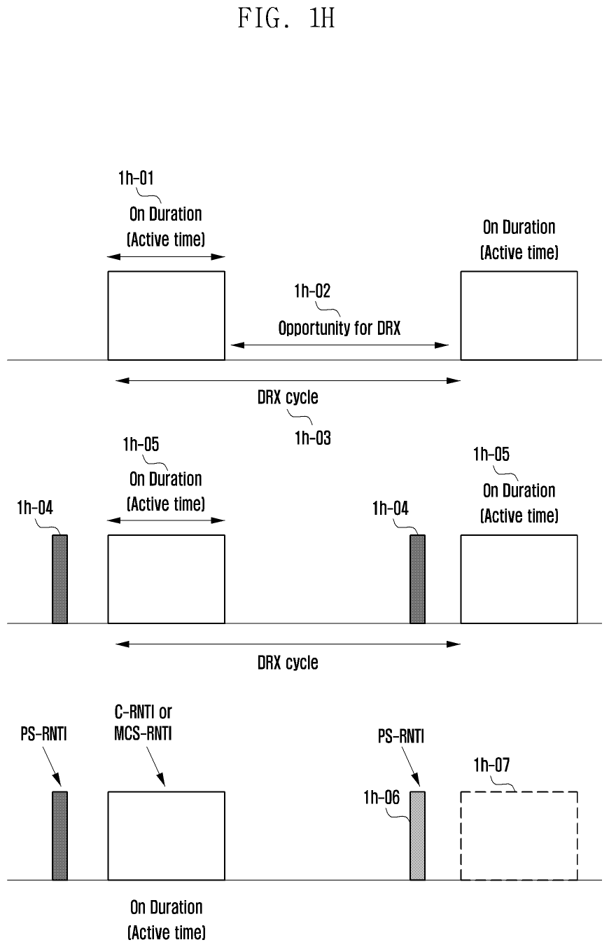

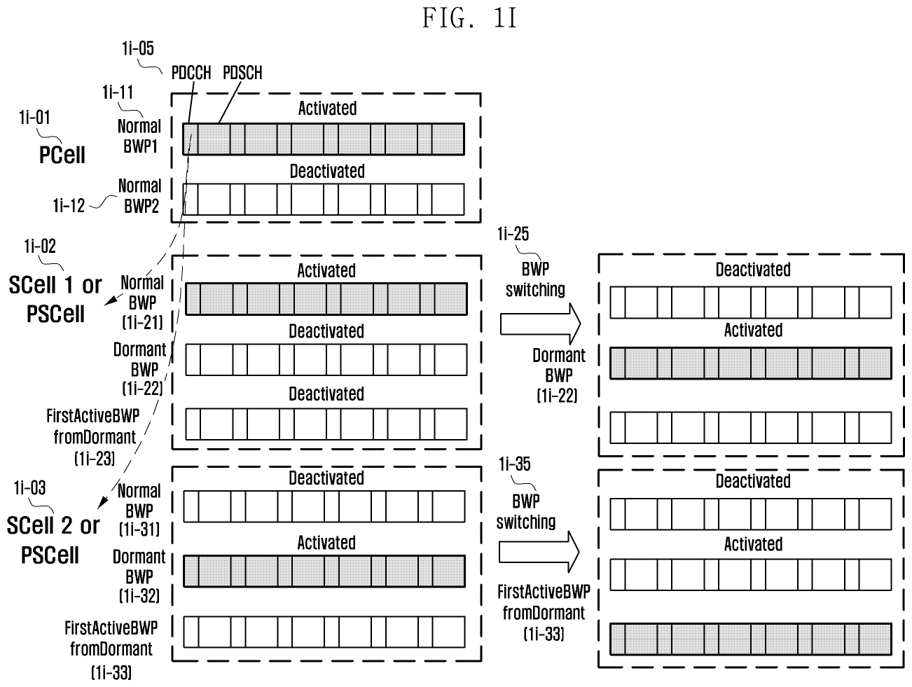

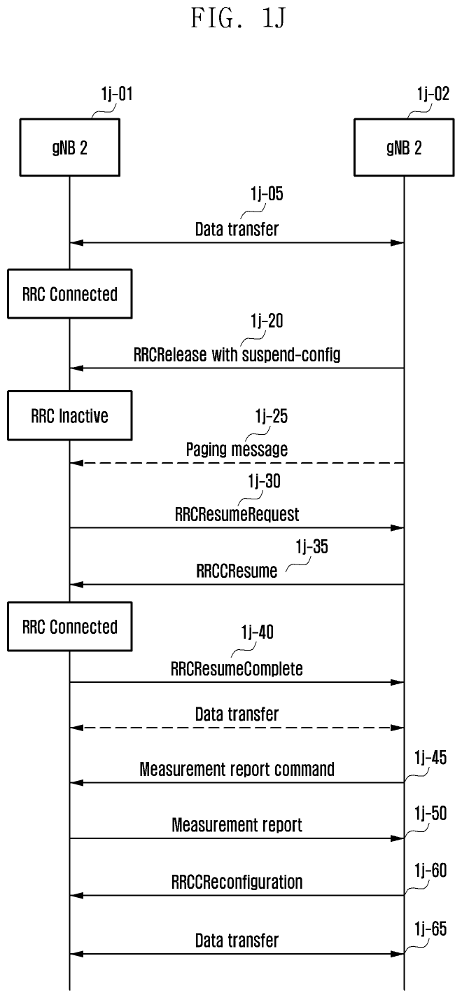

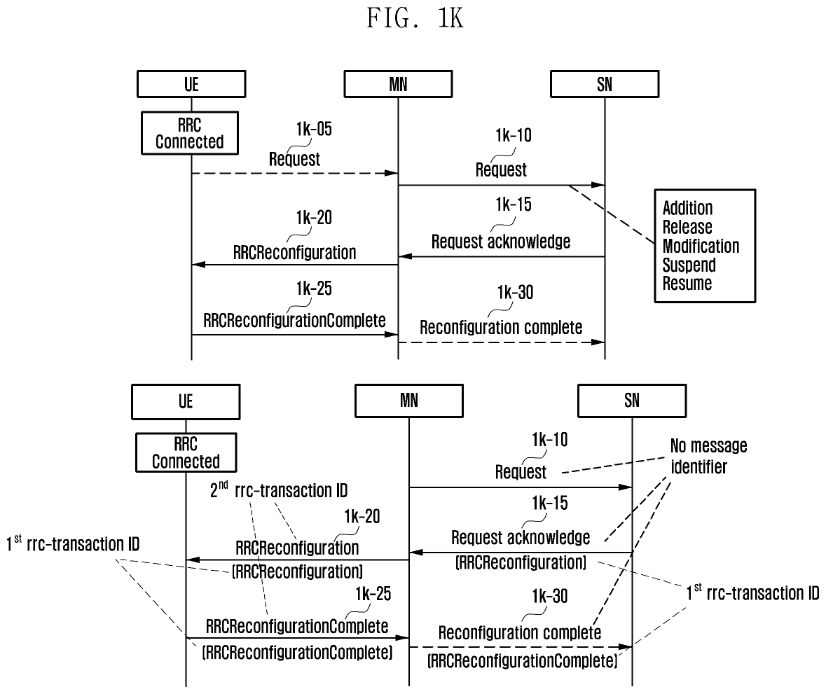

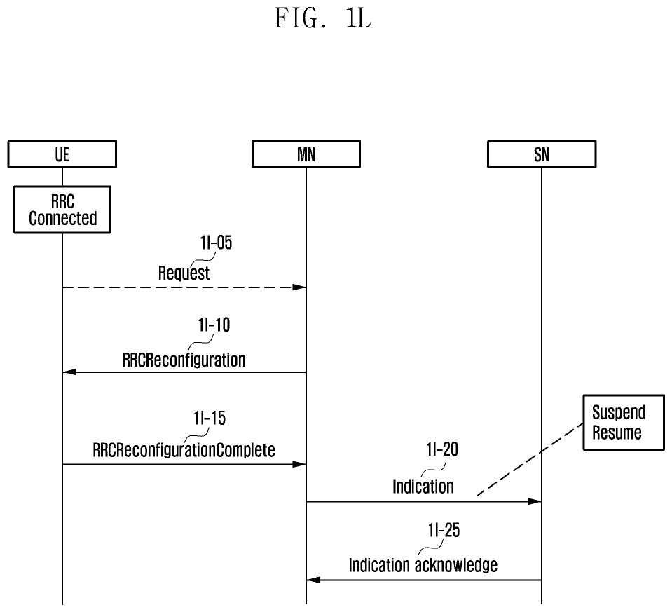

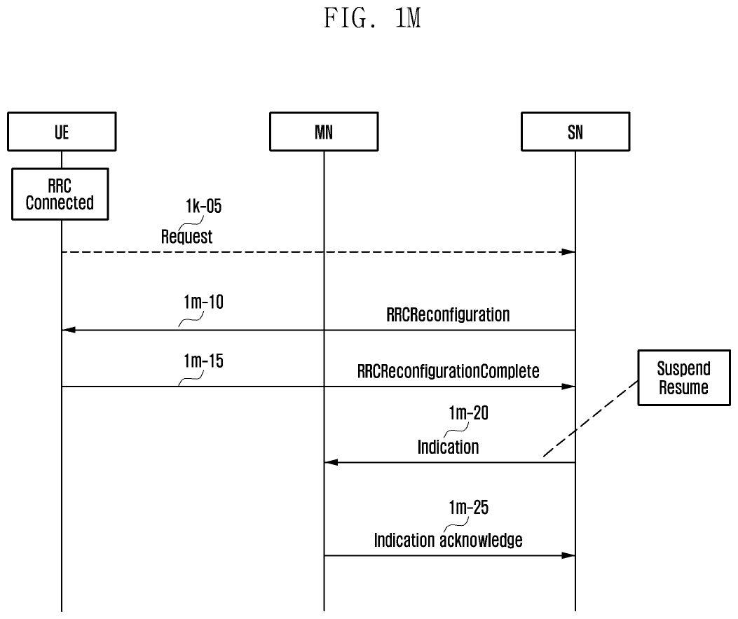

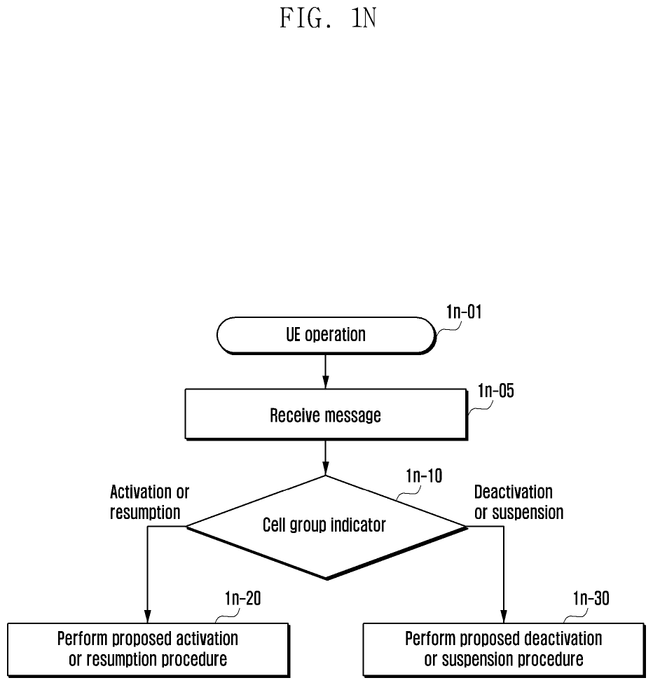

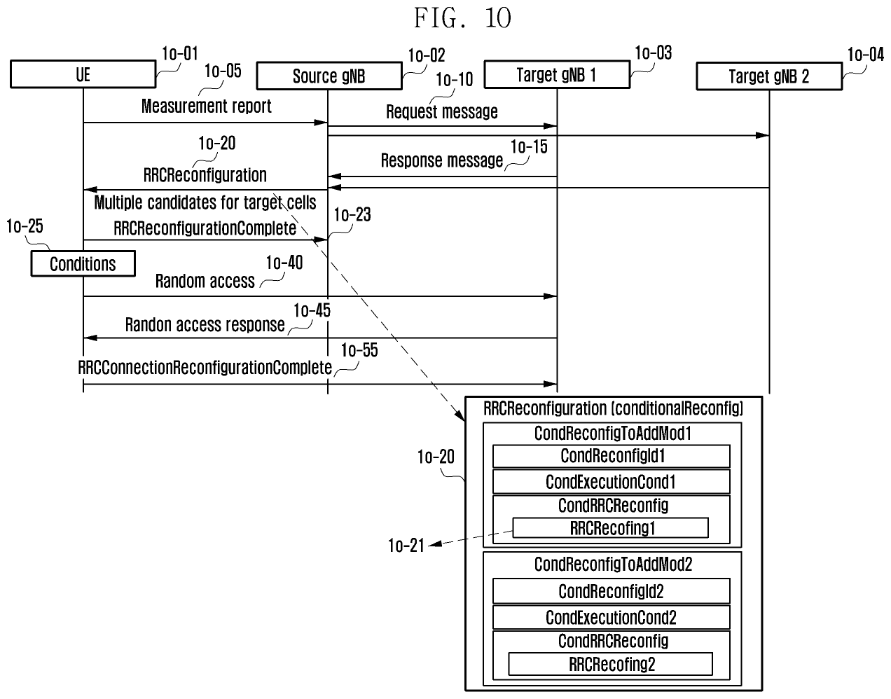

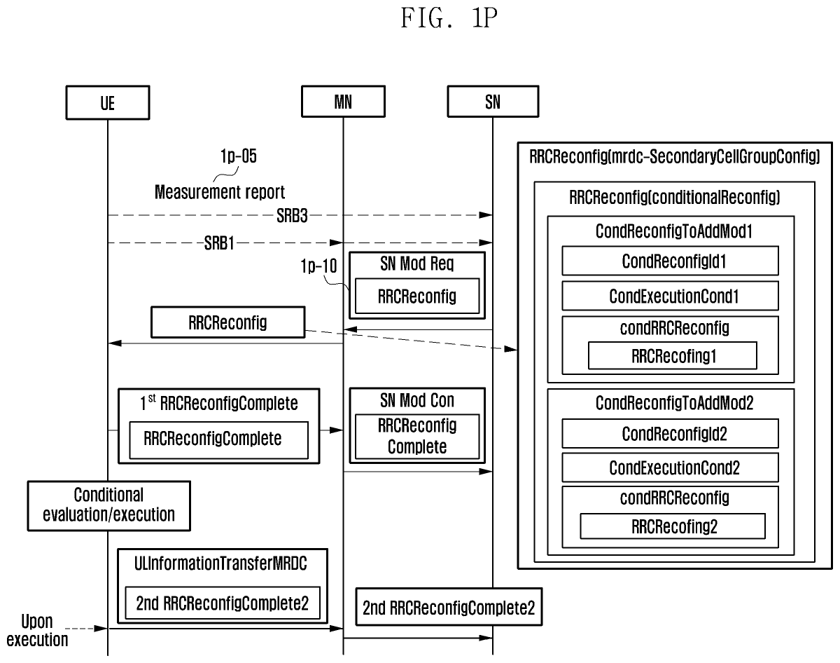

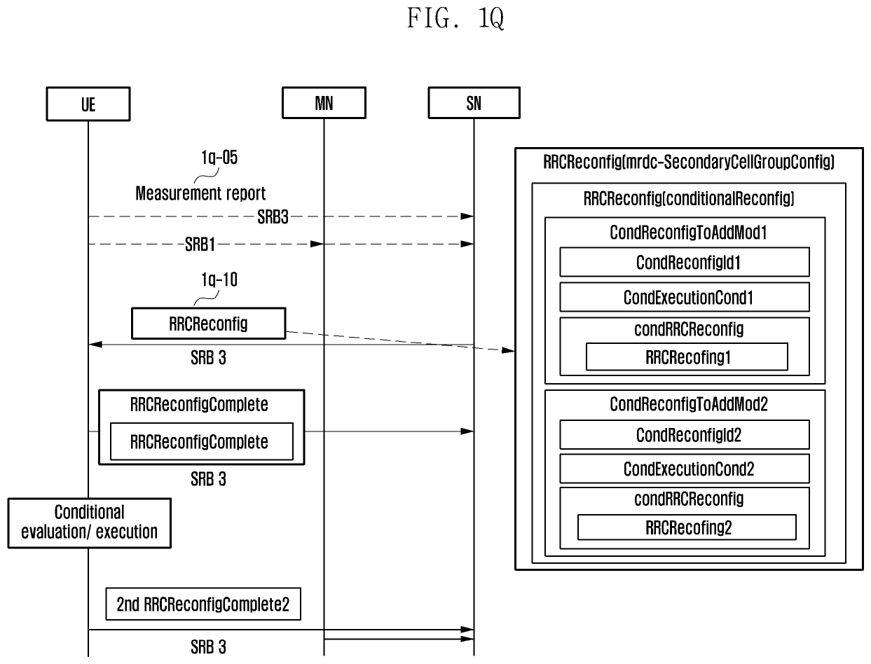

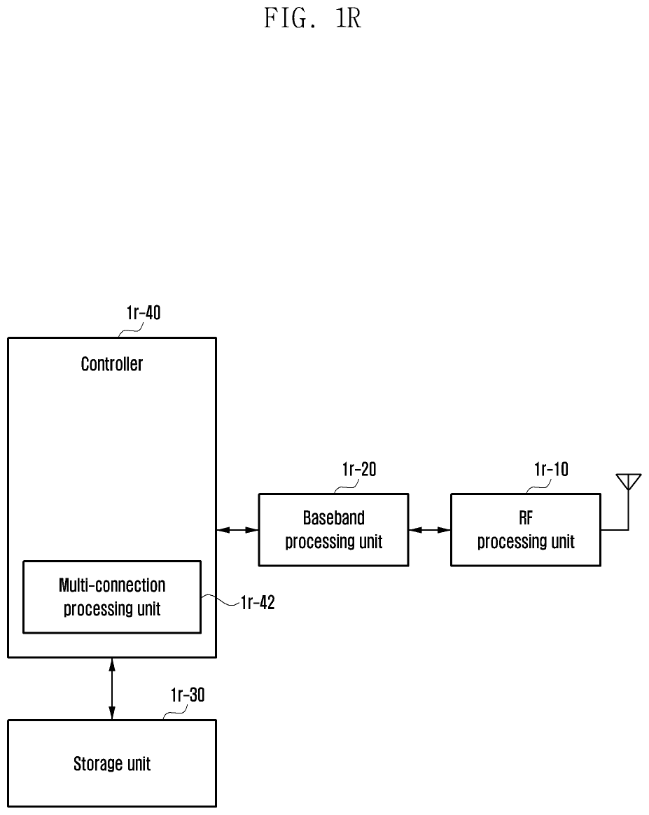

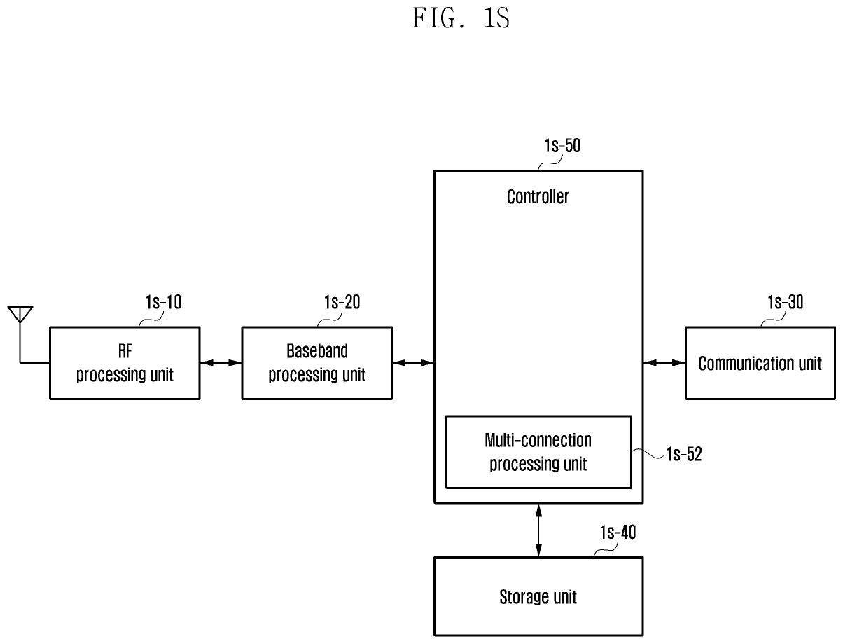

FIG. 1A illustrates a structure of an LTE system according to an embodiment of the disclosure.

Referring to FIG. 1A, as illustrated therein, a radio access network of an LTE system includes next-generation base stations (referred to as evolved node Bs, hereinafter ENBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 accesses an external network through the ENBs 1a-05 to 1a-20 and the S-GW 1a-30.

In FIG. 1A, the ENBs 1a-05 to 1a-20 correspond to conventional node Bs of a universal mobile telecommunication system (UMTS). The ENBs 1a-05 to 1a-20 are connected to the UE 1a-35 through a radio channel, and perform more complicated roles than the conventional node Bs. In the LTE system, since all user traffic including real-time services, such as voice over IP (VOIP) via the Internet protocol, is serviced through a shared channel, a device that collects state information, such as buffer states, available transmit power states, and channel states of UEs 1a-35, and performs scheduling accordingly is required, and the ENBs 1a-05 to 1a-20 may serve as the device. In general, one ENB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. In addition, the LTE system employs an adaptive modulation & coding (hereinafter referred to as AMC) scheme for determining a modulation scheme and a channel coding rate according to the channel state of a UE. The S-GW 1a-30 is a device that provides a data bearer, and may generate or remove a data bearer under the control of the MME 1a-25. The MME 1a-25 is responsible for various control functions as well as a mobility management function for a UE 1a-35, and may be connected to multiple base stations 1a-05 to 1a-20.

FIG. 1B illustrates a radio protocol structure in an LTE system according to an embodiment of the disclosure.

Referring to FIG. 1B, a radio protocol of an LTE system includes a packet data convergence protocol (PDCP) 1b-05 or 1b-40, a radio link control (RLC) 1b-10 or 1b-35, and a medium access control (MAC) 1b-15 or 1b-30 in each of a UE and an ENB. The packet data convergence protocol (PDCP) 1b-05 or 1b-40 serves to perform operations, such as IP header compression/reconstruction. The main functions of the PDCP 1b-05 or 1b-40 are summarized as follows.
Header compression and decompression (ROHC only)
Transfer of user data
In-sequence delivery (In-sequence delivery of upper layer PDUs at PDCP re-establishment procedure for RLC AM)
Reordering (For split bearers in DC (only support for RLC AM): PDCP PDU routing for transmission and PDCP PDU reordering for reception)
Duplicate detection (Duplicate detection of lower layer SDUs at PDCP re-establishment procedure for RLC AM)
Retransmission (Retransmission of PDCP SDUs at handover and, for split bearers in DC, of PDCP PDUs at PDCP data-recovery procedure, for RLC AM)
Ciphering and deciphering
Timer-based SDU discard (Timer-based SDU discard in uplink)

The radio link control (hereinafter referred to as RLC) 1b-10 or 1b-35 reconfigures a PDCP protocol data unit (PDU) into an appropriate size to perform an ARQ operation. The main functions of the RLC 1b-10 or 1b-35 are summarized as follows.
Data transfer (Transfer of upper layer PDUs)
ARQ (Error Correction through ARQ (only for AM data transfer))
Concatenation, segmentation and reassembly (Concatenation, segmentation and reassembly of RLC SDUs (only for UM and AM data transfer))
Re-segmentation (Re-segmentation of RLC data PDUs (only for AM data transfer))
Reordering (Reordering of RLC data PDUs (only for UM and AM data transfer))
Duplicate detection (only for UM and AM data transfer)
Error detection (Protocol error detection (only for AM data transfer))
RLC SDU discard (only for UM and AM data transfer)
RLC re-establishment

The MAC 1b-15 or 1b-30 is connected to several RLC layer devices configured in a single terminal, and multiplexes RLC PDUs to a MAC PDU and demultiplexes a MAC PDU to RLC PDUs. The main functions of the MAC 1b-15 or 1b-30 are summarized as follows.
Mapping (Mapping between logical channels and transport channels)
Multiplexing and demultiplexing (Multiplexing/demultiplexing of MAC SDUs belonging to one or different logical channels into/from transport blocks (TB) delivered to/from the physical layer on transport channels)
Scheduling information reporting
HARQ (Error correction through HARQ)
Priority handling between logical channels (Priority handling between logical channels of one UE)
Priority handling between UEs (Priority handling between UEs by means of dynamic scheduling)
MBMS service identification
Transport format selection
Padding

A physical layer 1b-20 or 1b-25 performs channel coding and modulation of higher layer data, makes the data into OFDM symbols, and transmits the OFDM symbols through a wireless channel, or performs demodulation and channel decoding of OFDM symbols received through a wireless channel and then transfers the OFDM symbols to a higher layer.

FIG. 1C illustrates a structure of a next-generation mobile communication system according to an embodiment of the disclosure.

Referring to FIG. 1C, as illustrated therein, a radio access network of a next-generation mobile communication system (hereinafter NR or 5G) includes a next-generation base station (new radio node B, hereinafter NR gNB or NR base station) 1c-10, and a new radio core network (NR CN) 1c-05. A user terminal (new radio user equipment, hereinafter NR UE or NR terminal) 1c-15 accesses an external network via the NR gNB 1c-10 and the NR CN 1c-05.

In FIG. 1C, the NR gNB 1c-10 corresponds to an evolved node B (eNB) of a conventional LTE system. The NR gNB 1c-10 is connected to the NR UE 1c-15 through a radio channel and may provide outstanding services as compared to a conventional node B. In the next-generation mobile communication system, since all user traffic is serviced through a shared channel, a device that collects state information, such as buffer statuses, available transmit power states, and channel states of UEs 1c-15, and performs scheduling accordingly, and the NR NB 1c-10 serves as the device. In general, one NR gNB 1c-10 controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE 1c-15. The NR CN 3-05 performs functions such as mobility support, bearer configuration, and QoS configuration. The NR CN 1c-05 is a device responsible for various control functions as well as a mobility management function for a UE, and is connected to multiple base stations. In addition, the next-generation mobile communication system may interwork with the existing LTE system, and the NR CN 1c-05 is connected to an MME 3-25 via a network interface. The MME 1c-25 is connected to an eNB 1c-30 that is an existing base station.

FIG. 1D illustrates a radio protocol structure of a next-generation mobile communication system according to an embodiment of the disclosure.

Referring to FIG. 1D, a radio protocol of a next-generation mobile communication system includes an NR SDAP 1d-01 or 1d-45, an NR PDCP 1d-05 or 1d-40, an NR RLC 1d-10 or 1d-35, and an NR MAC 1d-15 or 1d-30 in each of a UE and an NR base station.

The main functions of the NR SDAP 1d-01 or 1d-45 may include some of functions below.
Transfer of user data (transfer of user plane data)
Mapping between a QoS flow and a data bearer for uplink and downlink (mapping between a QoS flow and a DRB for both DL and UL)
Marking a QoS flow ID in uplink and downlink (marking QoS flow ID in both DL and UL packets)
Mapping a reflective QoS flow to a data bearer with respect to UL SDAP PDUs (reflective QoS flow to DRB mapping for the UL SDAP PDUs)

Whether to use a header of the SDAP layer device, or whether to use a function of the SDAP layer device may be configured for the UE with respect to the SDAP layer device through an RRC message for each PDCP layer device, each bearer, or each logical channel. Furthermore, in a case where an SDAP header is configured, an NAS QoS reflective configuration one-bit indicator (NAS reflective QoS) and an As QoS reflective configuration one-bit indicator (AS reflective QoS) of the SDAP header may indicate the terminal to update or reconfigure mapping information relating to a QoS flow and a data bearer for uplink and downlink. The SDAP header may include QoS flow ID information indicating a QoS. The QoS information may be used as data processing priority, scheduling information, etc. for smoothly supporting the service.

The main functions of the NR PDCP 1d-05 or 1d-40 may include some of functions below.
Header compression and decompression (ROHC only)
Transfer of user data
In-order delivery (In-order delivery of upper layer PDUs)
Out-of-order delivery (Out-of-order delivery of upper layer PDUs)
Reordering (PDCP PDU reordering for reception)
Duplicate detection (Duplicate detection of lower layer SDUs)
Retransmission (Retransmission of PDCP SDUs)
Ciphering and deciphering
Integrity protection or verification
Timer-based SDU discard (Timer-based SDU discard in uplink)

The reordering of the NR PDCP device refers to a function of reordering PDCP PDU received from a lower layer in an order based on PDCP sequence numbers (SNs), and may include a function of transferring data to a higher layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 1d-10 or 1d-35 may include some of functions below.
Data transfer (Transfer of upper layer PDUs)
In-order delivery (In-order delivery of upper layer PDUs)
Out-of-order delivery (Out-of-order delivery of upper layer PDUs)
ARQ (Error correction through ARQ)
Concatenation, segmentation and reassembly (Concatenation, segmentation and reassembly of RLC SDUs)
Re-segmentation (Re-segmentation of RLC data PDUs)
Reordering (Reordering of RLC data PDUs)
Duplicate detection
Error detection (Protocol error detection)
RLC SDU discard
RLC re-establishment

The in-order delivery of the NR RLC device may indicate a function of transferring RLC SDUs received from a lower layer to a higher layer in sequence. Furthermore, the in-order delivery may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to a higher layer, may include a function of, although there is a lost RLC SDU, if a predetermined timer has expired, sequentially transferring, to a higher layer, all the RLC SDUs received before the timer is started, or may include a function of, although there is a lost RLC SDU, if a predetermined timer has expired, sequentially transferring all the RLC SDUs received up to the current, to a higher layer. In addition, the NR RLC device may process RLC PDUs in a reception order (an order in which the RLC PDUs have arrived, regardless of an order based on sequence numbers) and then transfer the processed RLC PDUs to a PDCP device regardless of order (out-of-order delivery). In a case of segments, the NR RLC device may receive segments stored in a buffer or to be received in the future, reconfigure the segments to be one whole RLC PDU, then process the RLC PDU, and transfer the processed RLC PDU to a PDCP device. The NR RLC layer may not include a concatenation function, and the concatenation function may be performed in an NR MAC layer or replaced with a multiplexing function of an NR MAC layer.

The out-of-sequence delivery function of the NR RLC device may indicate a function of immediately transferring RLC SDUs received from a lower layer, to an upper layer regardless of the order thereof. Furthermore, the out-of-sequence delivery function may include a function of, if one original RLC SDU is divided into several RLC SDUs and then the RLC SDUs are received, reassembling the several RLC SDUs and transferring the reassembled RLC SDUs, and may include a function of storing an RLC sequence number (SN) or a PDCP sequence number (SN) of received RLC PDUs and arranging order to record lost RLC PDUs.

The NR MAC 1d-15 or 1d-30 may be connected to several NR RLC layer devices configured in a single UE, and the main functions of the NR MAC may include some of functions below.
Mapping (Mapping between logical channels and transport channels)
Multiplexing and demultiplexing (Multiplexing/demultiplexing of MAC SDUs)
Scheduling information reporting
HARQ (Error correction through HARQ)
Priority handling between logical channels (Priority handling between logical channels of one UE)
Priority handling between UEs (Priority handling between UEs by means of dynamic scheduling)
MBMS service identification
Transport format selection
Padding

An NR PHY layer 1d-20 or 1d-25 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer.

Next-generation mobile communication systems may use substantially high frequency bands, and the frequency bandwidth may thus be substantially large. However, a high degree of implementation complexity is needed to support a substantially large bandwidth in connection with UE implementation, thereby incurring high costs. Therefore, the concept of a bandwidth part (BWP) may be introduced in next-generation mobile communication systems such that multiple BWPs can be configured for a single cell (special cell (Spcell) or secondary cell (Scell)), and data can be transmitted/received in one PBW or multiple BWPs as instructed by a base station.

The disclosure is characterized by proposing a state transition method or a BWP switching method, which considers the state of a Scell and multiple BWPs configured for the Scell when the dormant BWP proposed in the disclosure is introduced, and specific operations. In addition, the disclosure proposes a method for managing a dormant mode at the BWP level and transitioning the state, or a BWP switching method, respectively, and proposes specific BWP operations according to the state of each SCell or the state or mode (activated or deactivated or dormant) of each BWP. In addition, in the disclosure, in order to quickly activate a SCell or BWP, first channel measurement configuration information may be configured with regard to the SCell or BWP by using a radio resource control (RRC) message or a medium access control (MAC) control element (CE), a UE may be instructed to apply and use (activate) the first channel measurement configuration information by using the RRC message or MAC CE such that the UE can quickly measure a channel signal (for example, a reference signal) regarding the SCell or BWP and can quickly report the measurement result to the base station, thereby quickly activating the SCell or BWP. The description that the SCell or BWP is activated may refer to procedures in which the UE monitors a physical downlink control channel (PDCCH) in the SCell or BWP, or the base station transmits the PDCCH to the UE, or the base station transmits a physical downlink shared channel (PDSCH) to the UE, or the UE transmits a physical uplink shared channel (PUSCH), or the UE transmits a measurement result or a hybrid automatic repeat request (HARQ) acknowledgement (ACK) or negative acknowledgement (NACK) through a physical uplink control channel (PUCCH), or the UE transmits a sounding reference signal (SRS), or the UE measures a channel measurement signal (synchronization signal block (SSB) or channel state information reference signal (CSI-RS) or reference signal (RS)) transmitted by the base station, or the UE measures a channel measurement signal transmitted by the base station and reports the result. The first channel measurement configuration information may include configuration information regarding a channel measurement signal used by the base station for a specific UE (or UEs) in the SCell or BWP. For example, the first channel measurement configuration information may include the cycle or the channel measurement signal or the number of transmitted signals or the period of time during which signals are transmitted or the offset regarding the signal transmission time or the time length between transmitted signals or a list regarding multiple channel measurement signals that may be transmitted or a time transmission resource (or frequency transmission resource) indicating the location of transmitted signals or transmission resources (time transmission resources or frequency transmission resources) to report the measurement result or the cycle to report the measurement result or the like. In addition, the first channel measurement configuration information configured by an RRC message may include multiple pieces of channel measurement signal information, and an RRC message or a MAC CE or downlink control information (DCI) may be used to indicate a specific piece of channel measurement signal information among the configured multiple pieces of channel measurement signal information, or beam configuration information such that the UE can perform channel measurement or perform channel measurement reporting by applying or using the indicated channel measurement signal information or beam configuration information. As another method, the RRC message or MAC CE may be used to configure or indicate channel measurement signal information such that the UE can perform channel measurement or perform channel measurement reporting by using the configured (or indicated) channel measurement signal information. In addition, the first channel measurement configuration information may be configured differently for each cell or each BWP with regard to multiple cells or BWPs configured in the RRC message, and beam-related configuration information (transmission configuration indication (TCI) state or quasi co-location (QCL)) such as the beam direction or beam number or beam location may be configured together such that the UE can easily measure transmission resources for channel measurement. In addition, the first channel measurement configuration information may be used to configure a timing advance (TA) value (or offset value) for synchronizing the base station's downlink signal or the base station's uplink signal, or a time alignment timer (TAT) indicating the validity of the TA value, or a TAT value such that the UE correctly performs channel measurement or channel measurement reporting.

The first channel measurement configuration information proposed in the disclosure may be characterized in that the same can be configured with regard to only downlink BWP configuration information of each cell. That is, the first channel measurement configuration information proposed in the disclosure may not be configured with regard to uplink BWP configuration information of each cell. This is because the UE needs to measure the downlink channel first such that the UE then can report the measurement result regarding the channel or cell, correctly receive the PDCCH, and follow the base station's instruction.

The first channel measurement configuration information proposed in the disclosure may be characterized in that the same is initially deactivated when configured by an RRC message or after a handover, and may be activated by a MAC control element proposed in the disclosure later, or DCI information of the PDCCH, or the RRC message. When configured by the RRC message as described above, the initial state needs to be deactivated such that the base station can easily manage the UE's cell state or the channel measurement performing procedure, and the UE can be accurately timed regarding when and how channel measurement is to be performed, without the processing delay problem of the RRC message.

In addition, the disclosure is characterized in that multiple BWPs may be configured for a single cell (Spcell or Pcell or Pscell or Scell) with regard to each downlink or uplink, and an active DL or UL BWP, or a dormant BWP or dormant DL BWP, or an inactive or deactivated DL/UL BWP may be configured and operated through BWP switching. That is, the DL or UL BWP may be transitioned to an active state with regard to the single cell such that the data transmission rate is increased by a method similar to carrier aggregation. In addition, the DL BWP may be transitioned or switched to a dormant BWP such that the UE performs no PDCCH monitoring regarding the cell, thereby saving the battery. The UE is allowed to perform channel measurement with regard to the DL BWP and to report the channel measurement result, thereby supporting quick activation of the cell or BWP later. In addition, the DL (or UL) BWP may be transitioned to an inactive state in the single cell, thereby reducing the UE's battery consumption. The instruction for BWP-specific state transition regarding each cell or the BWP switching instruction may be configured and instructed by using an RRC message or a MAC CE or DCI of the PUCCH.

The dormant BWP may be expanded and applied to dual connectivity as well, and may also be applied to the PSCell of the secondary cell group, for example. As another method, the same may be expanded to the concept of cell group suspension or cell group deactivation such that a single cell group (for example, secondary cell group) of a UE having dual connectivity configured therefor is instructed to suspend or deactivate the cell group such that the cell group suspends data transmission or reception as instructed, or suspends PDCCH monitoring, or perform sporadic PDCCH monitoring, based on a substantially long cycle, thereby reducing the UE's power consumption. In addition, if instructed to suspend or deactivate the cell group, the UE may perform a channel measurement procedure in the cell group to be suspended or deactivated and may report the channel measurement result to the network (for example, to the master cell group or to the secondary cell group), thereby supporting quick activation of the dual connectivity. The UE may perform the procedure with regard to the cell group which is to be suspended or deactivated as instructed, or cell group configuration information may not be discarded or released but maintained and stored, or the cell group configuration information may be restored according to an instruction to activate or resume the cell group of the network. For example, configuration information of the cell group configured for the UE (for example, configuration information of each PDCP or RLC or MAC layer device) or bearer configuration information or cell-specific configuration information may be stored or maintained with no change. However, if the cell group is suspended or deactivated, the bearers or the bearer's RLC bearer may be suspended, or the cell group may suspend transmission (or data transmission, for example, SCG transmission). If the UE receives an instruction to resume or activate the cell group which has been suspended or deactivated as instructed previously, the UE may resume or restore or again apply the cell group's configuration information, the UE may resume transmission regarding the bearer or RLC bearer or cell group (for example, SCG transmission), or the UE may restart data transmission or reception, or the UE may restart PDCCH monitoring, or the UE may perform channel measurement reporting, or the UE may reactivate configured transmission resources periodically.

The description that, if the cell group is suspended or deactivated, the bearer (the bearer that uses an RLC unacknowledged mode (UM) or the bearer that uses an RLC acknowledged mode (AM)) is suspended may mean that the PDCP layer device or RLC layer device is suspended (or data transmission or reception or data processing is suspended), and the MAC layer device does not transmit (or receive) data regarding the bearer (or data corresponding to the logical channel identifier corresponding to the bearer) (or the logical channel identifier is not selected as a target in a logical channel prioritization (LCP) procedure). The PDCP layer device suspension procedure may apply specific embodiments proposed below by the disclosure.

The description that, if the cell group is suspended or deactivated, the RLC bearer (the RLC bearer that uses the RLC UM mode or the RLC bearer that uses the RLC AM mode) is suspended may mean that the RLC layer device is suspended (or data transmission or reception or data processing is suspended), and the MAC layer device does not transmit (or receive) data regarding the bearer (or data corresponding to the logical channel identifier corresponding to the bearer) (or the logical channel identifier is not selected as a target in an LCP procedure). The description that the RLC bearer is suspended may mean that the PDCP layer device connected to the RLC layer device can continuously process data. For example, the PDCP layer device connected to the suspended RLC bearer may process and transmit data or receive and process data through another RLC bearer (for example, an RLC bearer belonging to a cell group (for example, MCG) other than the cell group (for example, SCG)).

The description that, if the cell group is suspended or deactivated, transmission (for example, SCG transmission) regarding the cell group is suspended may mean that the MAC layer device does not transmit (or receive) data regarding a bearer (a bearer that uses the RLC UM mode or a bearer that uses the RLC AM mode) belonging to the cell group (or data corresponding to the logical channel identifier corresponding to the bearer) (or the logical channel identifier is not selected as a target in the LCP procedure). However, the description that transmission (for example, SCG transmission) regarding the cell group is suspended may mean that the PDCP layer device or RLC layer device can process or preprocess data. For example, data (or uplink data) of the upper layer device is not transmitted in the cell group, but the PDCP layer device or RLC layer device or MAC layer device may preprocess data for transmission.

The description that, if the cell group is resumed or activated, the bearer (the bearer that uses the RLC UM mode the bearer that uses the RLC AM mode) is resumed may mean that the PDCP layer device or RLC layer device is resumed (or data transmission or reception or data processing is resumed), and the MAC layer device transmits (or receives) data regarding the bearer (or data corresponding to the logical channel identifier corresponding to the bearer) (or the logical channel identifier is selected as a target in the LCP procedure).

The description that, if the cell group is resumed or activated, the RLC bearer (the RLC bearer that uses the RLC UM mode or the RLC bearer that uses the RLC AM mode) is resumed may mean that the RLC layer device is resumed (or data transmission or reception or data processing is resumed), and the MAC layer device transmits (or receives) data regarding the bearer (or data corresponding to the logical channel identifier corresponding to the bearer) (or the logical channel identifier is selected as a target in the LCP procedure). The description that the RLC bearer is resumed may mean that data is transferred to the PDCP layer device connected to the RLC layer device, or that data is received from the PDCP layer device.

The description that, if the cell group is resumed or activated, transmission (for example, SCG transmission) regarding the cell group is resumed mean that the MAC layer device transmits (or receives) data regarding a bearer (a bearer that uses the RLC UM mode or a bearer that uses the RLC AM mode) belonging to the cell group (or data corresponding to the logical channel identifier corresponding to the bearer) (or the logical channel identifier is not selected as a target in the LCP procedure). However, the description that transmission (for example, SCG transmission) regarding the cell group is resumed may mean that the PDCP layer device or RLC layer device can process or preprocess data. For example, data (or uplink data) of the upper layer device may be transmitted in the cell group, and the PDCP layer device or RLC layer device or MAC layer device may preprocess data for transmission.

As another method, if the cell group is suspended or deactivated, the bearer (or RLC bearer) that uses the RLC UM mode may be suspended such that the PDCP layer device or RLC layer device is suspended, data transmission or reception is suspended, or data processing is suspended, or the MAC layer device suspends data transmission or reception. However, cell group-related transmission may be suspended with regard to the bearer (or RLC bearer) that uses the RLC AM mode such that data processing can be continuously performed with regard to the PDCP layer device or RLC layer device, or such that the MAC layer device suspends data transmission or reception. This is because, if the security key is changed, the RLC AM bearer has a retransmission (or regeneration) procedure in a PDCP reestablishment procedure (therefore, if the security key is not changed, the data processing speed may be decreased. In addition, if the security key is changed, no data loss occurs due to the retransmission (or regeneration) procedure), but the RLC UM bearer has no retransmission (or regeneration) procedure, and data loss may occur inside the UE if the RLC UM bearer pre-performs a data processing procedure (if the security key is not changed, the data processing speed may be decreased. However, if the security key is changed, data loss occurs because there is no retransmission (or regeneration) procedure, and the PDCP layer device and the RLC layer device discard all data in the reestablishment procedure). Therefore, different procedures may be applied to the bearer (or RLC bearer) that uses the RLC AM mode and the bearer (or RLC bearer) that uses the RLC UM mode. The PDCP layer device suspension procedure may apply specific embodiments proposed below by the disclosure.

In the cell group configuration information or cell (SPCell (Pcell or PSCell) or SCell) configuration information, or in previously configured cell group configuration information or cell (SPCell (Pcell or PSCell) or SCell) configuration information, or in a message (for example, RRC message or RRCReconfiguration or MAC control element or DCI of PDCCH) that instructs cell group or cell (SPCell (Pcell or PSCell) or SCell) activation or resumption, first channel measurement configuration information may be configured to be included therein for quick cell group or cell (SPCell (Pcell or PSCell) or SCell) activation. In order to quickly activate the cell group, the first channel measurement configuration information may include configuration information, such as the cycle regarding a frequent channel measurement signal (for example, radios resource or temporary reference signal (TRS) or synchronization signal block (SSB) or channel state information reference signal (CSI-RS) or reference signal (RS)) such that the base station can temporarily transmit a channel measurement signal a lot or often such that channel measurement can be quickly performed in the cell in configuration information of a cell (for example, Pcell or PSCell or SCell) of the cell group, or transmitted transmission resource information (frequency or time transmission resource used to transmit the frequent channel measurement signal) or an interval or the number of times (the number of times the frequent channel measurement signal is transmitted) or a timer value (the time during which the frequent channel measurement signal is transmitted) or a time interval (interval in which the frequent channel measurement signal is transmitted (for example, offset of time unit (slot or subframe or symbol or the like) or a transmission resource or cycle or interval or timing or offset by which the UE needs to report the measurement report. The first channel measurement configuration information may be characterized by configuring a short reporting cycle (or transmission resource) at which the UE can report the channel measurement result, or configuring a transmission resource for channel measurement such that the base station can transmit many channel measurement signals (or transmission resources or (for example, radio resources or temporary reference signals (TRS)) a lot or frequently in order for the base station to support the UE's quick channel measurement or many signal measurements. The first channel measurement configuration information may include configuration information regarding a channel measurement signal for a specific UE (or UEs) in the cell or BWP used by the base station. For example, the first channel measurement configuration information may include the cycle of the channel measurement signal or the number of transmitted signals or an offset regarding the period of time during which signals are transmitted or the time at which signals are transmitted or the time length between transmitted signals or a list of multiple transmittable channel measurement signals or time transmission resources (or frequency transmission resources) indicating the location of transmitted signals or transmission resources (time transmission resources or frequency transmission resources) to be used to report measurement results or the measurement result reporting cycle or the like. In addition, the first channel measurement configuration information may be configured differently with regard to multiple cells or BWPs configured in the RRC message or for each cell or each BWP, and beam-related configuration information (transmission configuration indication (TCI) state or quasi co-location (QCL)) such as the beam direction or beam number or beam location may be configured together such that the UE can easily measure transmission resources for channel measurement. In addition, the first channel measurement configuration information may be used to configure a timing advance (TA) value (or offset value) for synchronizing the base station's downlink signal or the base station's uplink signal, or a time alignment timer (TAT) indicating the validity of the TA value, or a TAT value such that correct channel measurement or channel measurement reporting can be performed. In addition, the first channel measurement configuration information configured by an RRC message may include multiple pieces of channel measurement signal information, and the RRC message or MAC CE or DCI may be used to indicate a specific piece of channel measurement signal information among the configured multiple pieces of channel measurement signal information, or beam configuration information such that the UE can perform channel measurement or perform channel measurement reporting by applying or using the indicated channel measurement signal information or beam configuration information. According to the method of indication, mapping between a bitmap or an index or an identifier and each piece of channel measurement signal information configured above may be defined, and an indication is made based thereon. As another method, the RRC message or MAC CE may be used to configure or indicate channel measurement signal information such that the UE can perform channel measurement or perform channel measurement reporting by applying or using the configured (or indicated) channel measurement signal information.

The first channel measurement configuration information proposed in the disclosure may be characterized in that the same is initially deactivated when configured by an RRC message or after a handover, and may be activated by a MAC control element proposed in the disclosure later, or DCI information of the PDCCH, or the RRC message. When configured by the RRC message as described above, the initial state needs to be deactivated such that the base station can easily manage the UE's cell state or the channel measurement performing procedure, and the UE can be accurately timed regarding when and how channel measurement is to be performed, without the processing delay problem of the RRC message.

The first channel measurement configuration information proposed in the disclosure may be characterized in that the same can be configured with regard to only downlink BWP configuration information of each cell. That is, the first channel measurement configuration information proposed in the disclosure may not be configured with regard to uplink BWP configuration information of each cell. This is because the UE needs to measure the downlink channel first such that the UE then can report the measurement result regarding the channel or cell, correctly receive the PDCCH, and follow the base station's instruction.

In addition, the message (for example, RRC message or RRCReconfiguration or MAC control element or DCI of PDCCH) that instructs activation or resumption of the cell group or cell (SPCell (Pcell or PSCell) or SCell) may include second channel measurement signal information for measuring signals of the cell (PSCell or PCell or SCell) of the cell group. The second channel measurement signal information may include normal channel measurement configuration information such as the transmission resource or cycle or time interval or number of channel measurement signals, or the transmission resource or cycle or time interval for channel measurement reporting.

In the disclosure, the UE's first channel measurement configuration information or second channel measurement configuration information may be applied according to the following conditions so as to measure channels, and the measurement result may be reported to the base station.
1> If the UE received a message (for example, PDCCH indicator or MAC control element or RRC message) instructing the UE to activate (or resume) the cell (PCell or PSCell or SCell) or cell group,
2> If the UE has first channel measurement configuration information configured therefor,
3> according to the first channel measurement configuration information of the UE, it may be identified that the base station will transmit many channel measurement signals frequently, and many or frequent channel measurement signals may be measured according to the first channel measurement configuration information temporarily (for example, until a time interval (for example, subframe or slot or symbol) configured in the channel measurement signal information, or during a time interval promised (or predetermined) in consideration of offset or during a time (for example, while a timer is driven)) or until a first condition is satisfied. In addition, the measured channel measurement result may be reported according to the cycle or transmission resource configured in the first channel measurement configuration information until the time interval (for example, subframe or slot or symbol) configured in the first channel measurement configuration information, or during a time interval promised (or predetermined) in consideration of offset or during a time (for example, while a timer is driven)) or until a first condition is satisfied. Therefore, as the UE becomes able to quickly measure frequent channel measurement signals and quickly report the measurement result, the cell (PCell or SCell or PSCell) or cell group can be quickly activated (or resumed), or scheduling information can be quickly indicated. If second channel measurement configuration information is configured for the UE after the time interval (for example, subframe or slot or symbol) configured in the first channel measurement configuration information, or after the promised (or predetermined) time interval, or after the time (for example, if the timer expires), or after the first condition is satisfied, application of the first channel measurement configuration information may be suspended or released, and channel measurement signals may be measured according to the second channel measurement configuration information. For example, a fallback from the first channel measurement configuration information to the second channel measurement configuration information may occur, or second channel information may be applied instead of the first channel measurement configuration information. In addition, measured channel measurement results may be reported according to the cycle or transmission resource configured in the second channel measurement configuration information. If the second channel measurement configuration information has not been configured, no channel measurement may be performed.
2> Otherwise (if the UE has no first channel measurement configuration information configured therefor),
3> If the UE has second channel measurement configuration information configured therefor, channel measurement signals may be measured according to the second channel measurement configuration information. In addition, measured channel measurement results may be reported according to the cycle or transmission resource configured in the second channel measurement configuration information. If the second channel measurement configuration information has not been configured, no channel measurement may be performed.

The first condition of the disclosure may be one of the following conditions. The disclosure proposes, as the first condition, following efficient conditions configured such that the base station does not need to transmit unnecessarily many transmission resources or frequent transmission resources when the first condition is used to activate a cell or activate a cell group or resume the same or when an RRC inactive mode UE resumes connection in an RRC connection resumption procedure. For example, until one of the following conditions is satisfied, first channel measurement configuration information may be applied, and a channel measurement procedure or a channel measurement reporting procedure may be performed.
It may be determined that the first condition is satisfied when the UE has successfully completed a random access procedure (four-step random access procedure or two-step random access procedure) in the cell (for example, PCell or SCell or PSCell) or in a cell (for example, PSCell or SCell) of a cell group, or when the first uplink transmission resource is allocated after successfully completing the random access procedure, or when an uplink transmission resource is initially indicated to the UE.
For example, more specifically, if the UE performs a contention-free random access (CFRA) procedure (for example, if a predesignated preamble or UE cell identifier (for example, C-RNTI) has been allocated),
It may be determined that the first condition is satisfied because the random access procedure may be deemed to be successfully completed when the UE transmits a predesignated preamble to the cell and then receives a random access response (RAR) message, or when a PDCCH indication is received in response to the RAR. As another method, it may be determined that the first condition is satisfied when an uplink transmission resource is initially received after the RAR is received.
If the UE performs a contention-based random access (CBRA) procedure (for example, if no predesignated preamble or UE cell identifier (for example, C-RNTI) has been allocated),
It may be determined that the first condition is satisfied because the UE may be deemed to have successfully completed the procedure of random access to a target base station if the UE transmits a preamble (for example, an arbitrary preamble) to the cell and then receives a random access response (RAR) message, if message 3 (for example, handover completion message) is transmitted by using an uplink transmission resource allocated or included or indicated in the RAR message, and if a MAC contention resolution (CE) is received from the target base station through message 4 to indicate that contention has been resolved, or if an uplink transmission resource is received through a PDCCH corresponding to the UE's C-RNTI. As another method, if the uplink transmission resource allocated in the RAR message has a sufficient size such that, after transmitting message 3, the UE can additionally transmit uplink data, it may be determined that an uplink transmission resource has been initially received, and it may be determined that the first condition is satisfied. That is, it may be determined that an uplink transmission resource is initially received when the RAR is received, and it may be determined that the first condition is satisfied.
1> If the UE performs a two-step random access procedure configured or indicated therefor,
1> Or if no two-step random access procedure is configured or indicated in the message, but if the UE supports the two-step random access procedure by UE capability, and if the cell's system information supports the two-step random access procedure, and if the system information broadcasts information for the two-step random access procedure (for example, random resources, or threshold for determining whether or not to perform the two-step random access, or the like), or if the UE receives the system information and performs the two-step random access procedure with regard to the cell because the signal strength is better or larger than the threshold broadcast in the system information,
2> The UE may determine that the first condition is satisfied when the two-step random access procedure is successfully completed.
2> The two-step random access procedure may be specifically performed by one of a contention-based random access (CBRA) method or contention-free random access (CFRA) method.
3> If the UE performed the CBRA-based two-step random access procedure,
4> The UE may transmit a preamble in a transmission resource for two-step random access (for example, a transmission resource configured by a PRACH occasion or base station through an RRC message or a transmission resource broadcast in system information), and may transmit data (for example, MsgA MAC PDU) in a transmission resource (for example, PUSCH occasion) for data transmission. The data may include a MAC control element (C-RNTI MAC CE) including a UE identifier (C-RNTI) or an RRC message (RRCReconfigurationComplete or handover completion message).
4> The UE may monitor a PDCCH scrambled by a UE identifier (C-RNTI) or a first identifier (MsgB-RNTI) derived by the time or frequency at which the preamble is transmitted.
4> If the UE receives the PDCCH scrambled by the UE identifier or if a downlink transmission resourced is allocated in the PDCCH or if a MAC control element (timing advance command MAC CE) for timing adjustment is received in the downlink transmission resource,
5> The UE may determine that the two-step random access procedure is successfully completed, and may determine that the first condition is satisfied.
4> If the UE receives a PDCCH scrambled by the first identifier (MsgB-RNTI), or if the PDCCH allocates a downlink transmission resource, or if a fallback random access response regarding a preamble transmitted by the UE in the downlink transmission resource is received (that is, if the base station received the preamble but received no MsgA, the fallback RAR instructs the MsgA to be transmitted through another transmission resource),
5> The UE may transmit data (MsgA MAC PDU) by using the transmission resource indicated in the fallback RAR.
5> The UE may monitor the PDCCH scrambled by the UE identifier (C-RNTI).
5> If the UE receives the PDCCH scrambled by the UE identifier, or if a downlink transmission resourced is allocated in the PDCCH, the UE may determine that the two-step random access procedure is successfully completed, and may determine that the first condition is satisfied.
3> If the UE performed the CFRA-based two-step random access procedure,
4> The UE may transmit a preamble in a transmission resource for two-step random access (for example, a transmission resource configured by a PRACH occasion or base station through an RRC message), and may transmit data (for example, MsgA MAC PDU) in a transmission resource (for example, PUSCH occasion) for data transmission. The data may include a MAC control element (C-RNTI MAC CE) including a UE identifier or (C-RNTI) an RRC message (RRCReconfigurationComplete or handover completion message).
4> The UE may monitor a PDCCH scrambled by a UE identifier (C-RNTI) or a first identifier (MsgB-RNTI) derived by the time or frequency at which the preamble is transmitted.
4> If the UE receives the PDCCH scrambled by the UE identifier or if a downlink transmission resourced is allocated in the PDCCH or if a MAC control element (timing advance command MAC CE) for timing adjustment is received in the downlink transmission resource,
5> The UE may determine that the two-step random access procedure is successfully completed, and may determine that the first condition is satisfied.
4> If the UE receives a PDCCH scrambled by the first identifier (MsgB-RNTI), or if a downlink transmission resourced is allocated in the PDCCH, or if a fallback random access response regarding a preamble transmitted by the UE in the downlink transmission resource is received (that is, if the base station received the preamble but received no MsgA, the fallback RAR instructs the MsgA to be transmitted through another transmission resource),
5> The UE may determine that the two-step random access procedure is successfully completed, and may determine that the first condition is satisfied.
5> The UE may transmit data (MsgA MAC PDU) by using the transmission resource indicated in the fallback RAR.
1> It may be determined that the first condition is satisfied when the random access procedure is started, or when a preamble for the random access procedure is transmitted.
1> As another method, if the message configures or instructs a two-step random access procedure for the UE, the UE may determine that the first condition is satisfied. For example, in the above case, the UE may determine that the first condition is satisfied before the two-step random access procedure is started.
1> As another method, if the message configures or instructs a two-step random access procedure for the UE, and if the transmission resource (PUSCH) configured for data transmission in the two-step random access procedure is larger than a first threshold, or if the RRC message includes a configuration value (timing advance value) for timing adjustment, the UE may determine that the first condition is satisfied. The first threshold may be configured by the base station through an RRC message (for example, RRCReconfiguration), or may be broadcast in system information, or may be configured by the size of data held by the UE to be transmitted. For example, the UE may determine that the first condition is satisfied before the two-step random access procedure is started. As another method, if the RRC message includes a configuration value (timing advance value) for timing adjustment, or if a two-step random access procedure is configured therein, the UE may instantly transmit data in a configured transmission resource (for example, a transmission resource configured by the RRC message or a transmission resource indicated by the PDCCH of the target base station after the PDCCH is monitored by the UE) without transmitting a preamble. Therefore, in the above case, the UE may determine that the first condition is satisfied before the two-step random access procedure is started or when or before the data is transmitted. As another method, if the RRC message includes a configuration value (timing advance value) for timing adjustment, or if a two-step random access procedure is configured therein, the UE may instantly transmit data in a configured transmission resource (PUSCH) (for example, a transmission resource configured by the RRC message or a transmission resource indicated by the PDCCH of the target base station after the PDCCH is monitored by the UE) without transmitting a preamble. In the above case, if a configured transmission resource (PUSCH) (for example, a transmission resource configured by the RRC message or a transmission resource indicated by the PDCCH of the target base station after the PDCCH is monitored by the UE) is larger than a first threshold, or if the RRC message includes a configuration value (timing advance value) for timing adjustment, the UE may determine that the first condition is satisfied before the two-step random access procedure is started or when or before the data is transmitted.
1> It may be considered that the first condition is satisfied if an RRC inactive mode UE transmits an RRCResumeRequest and then receives an RRCResume message (or RRCSetup message) in response thereto.
1> In the case of expiration of a timer which indicates a period of time for channel measurement when a UE performs channel measurement, based on first channel measurement configuration information configured in the RRC message,
1> In the case of elapse (or expiration) of a time interval which indicates a period of time for channel measurement when a UE performs channel measurement, based on first channel measurement configuration information configured in the RRC message, or if the time interval is all used (or applied),
1> If signals for channel measurement when a UE performs channel measurement, based on first channel measurement configuration information configured in the RRC message, are all measured (or completed) a configured number of times, or if signals are received the configured number of times,
1> It may be considered that the first condition is satisfied, when the UE performs channel measurement based on first channel measurement configuration information configured in the RRC message, if channel measurement is completed based on the configuration information (if channel measurement expires), or if channel measurement reporting is completed (or if channel measurement reporting expires).

If the first condition is satisfied, the upper layer device (for example, RRC layer device) may indicate to the lower layer device (for example, PDCP layer device or RLC layer device or MAC layer device or PHY layer device) through an indicator, or the lower layer device (for example, PDCP layer device or RLC layer device or MAC layer device or PHY layer device) may indicate to the upper layer device (for example, RRC layer device).

The methods for configuring or applying first channel measurement configuration information proposed in the disclosure may be expanded and configured and used when a cell group (for example, PSCell) is activated or resumed, or when SCell is activated, or when RRC connection is resumed in an RRC inactive mode (for example, when RRCResume message is used), or when a handover procedure is performed (for example, when RRCReconfiguration message is used).

In the disclosure, the term “BWP” may be used without distinguishing an uplink and a downlink, and may refer to an uplink BWP and a downlink BWP, depending on the context, respectively.

In the disclosure, the term “link” may be used without distinguishing the uplink and the downlink, and may refer to an uplink and a downlink, depending on the context, respectively.

In the disclosure, a cell may refer to a PCell or a SCell (for example, a SCell configured in a master cell group (MCG)) or a PSCell (for example, a PCell of a secondary cell group (SCG)) or a SCell (for example, a SCell configured in a secondary cell group (SCG)). In the disclosure, a dormant BWP is configured or introduced with regard to the Scell or PSCell of a UE which performs carrier aggregation or dual connectivity, the PDCCH is not monitored in the dormant BWP, thereby reducing the UE's battery consumption, and channel measurement is performed in the dormant BWP and is reported (for example, channel state information (CSI) or channel quality information (CQI) measurement or reporting), or beam measurement or beam tracking or beam operation is performed such that, if data transmission is necessary, a normal BWP is switched to or activated such that data transmission can quickly start in the normal BWP. The dormant BWP may not be configured or applied with regard to a SpCell (PCell of MCG or PCell (or PSCell) of SCG) which requires that signals be monitored continuously, or feedback be sent or received, or synchronization be identified and maintained, or a SCell having a PUCCH configured therefor.

If the UE is instructed to switch to or activate the dormant BWP with regard to the SCell of the MCG through the PCell, the UE may perform a channel measurement procedure with regard to the dormant BWP of the SCell and may report the measured channel measurement result in a transmission resource of the PCell of the MCG (for example, through the physical uplink control channel (PUCCH) transmission resource of the PCell) or in a transmission resource of the SCell (for example, through the physical uplink control channel (PUCCH) transmission resource) for which the PUCCH of the MCG is configured. An RRC message may be used to configure, for the UE, a channel measurement result regarding what cell or what cell's BWP is to be reported by what transmission resource (for example, PUCCH or PUSCH) of what cell, with regard to each cell or each BWP.

If the UE is instructed to switch to or activate the dormant BWP with regard to the SCell of the SCG through the PSCell, the UE may perform a channel measurement procedure with regard to the dormant BWP of the SCell and may report the measured channel measurement result in a transmission resource of the PSCell of the SCG (for example, through the physical uplink control channel (PUCCH) transmission resource of the PSCell) or in a transmission resource of the SCell (for example, through the physical uplink control channel (PUCCH) transmission resource) for which the PUCCH of the SCG is configured. An RRC message may be used to configure, for the UE, a channel measurement result regarding what cell or what cell's BWP is to be reported by what transmission resource (for example, PUCCH or PUSCH) of what cell, with regard to each cell or each BWP.

If the UE is instructed to switch to or activate the dormant BWP with regard to the PSCell or SCell of the SCG through the PCell, or if the UE receives a SCG suspension or cell group suspension instruction with regard to the SCG (or PSCell), the UE may perform a channel measurement procedure with regard to the BWP of the PSCell or SCell (the BWP configured by the RRC message or the BWP activated last) or with regard to the dormant BWP, and may report the measured channel measurement result in a transmission resource of the PCell of the MCG (for example, through the physical uplink control channel (PUCCH) transmission resource of the PCell), or in a transmission resource of the SCell (for example, through the physical uplink control channel (PUCCH) transmission resource) for which the PUCCH of the MCG is configured, or in a transmission resource of the PSCell of the SCG (for example, through the physical uplink control channel (PUCCH) transmission resource of the PSCell). An RRC message may be used to configure, for the UE, a channel measurement result regarding what cell or what cell's BWP is to be reported by what transmission resource (for example, PUCCH or PUSCH) of what cell, with regard to each cell or each BWP.

The disclosure proposes multiple embodiments operating based on DCI of a PACCH, or based on a MAC CE, or based on an RRC message, in order to operate the dormant BWP or cell group suspension state proposed above, with regard to the UE's SCell (the SCell of the MCG when carrier aggregation is configured, or the SCell of the SCG when dual connectivity is configured) or PSCell (PCell of the SCG when dual connectivity is configured).

The network or base station may configure an SPcell (PCell and PScell) and multiple SCells for the UE. The Spcell may indicate the Pcell when the UE communicates with one base station, and may indicate the master base station's Pcell or the secondary base station's PScell when the UE communicates with two base stations (master and secondary base stations). The Pcell or Pscell refers to the major cell used in each MAC layer device when the UE and the base station communicate, and denotes a cell which performs random access at the correct timing such that synchronization is performed, which sends HARQ ACK/NACK feedback by a PUCCH transmission resource, and which exchanges most control signals. The technology in which the base station operates multiple Scells together with the Spcell so as to increase transmission resources and to raise uplink or downlink data transmission resources is referred to as carrier aggregation or dual connectivity.

In the disclosure, a PCell may refer to a master cell group (MCG), and a PSCell may refer to a secondary cell group (SCG). In addition, the MCG as used herein may include the PCell and SCells configured for the MCG, and the SCG as used herein may include the PSCell and SCells configured for the SCG. In addition, a cell may refer to a cell group, or a cell group may refer to a cell.

If an Spcell and multiple SCells are configured for a UE through an RRC message, the state or mode regarding each cell (PCell or PSCell or SCell) or each Scell or each SCell's BWP, or regarding a cell group, may be configured through the RRC message or MAC CE or PDCCH's DCI. The cell's state or mode may be configured as an active mode or an activated state, and as a deactivated mode or a deactivated state. The description that the cell is in the active mode or activated state may mean that, in the active mode or activated cell, the UE may exchange uplink or downlink data with the base station in the activated BWP of the cell, or in an activated normal BWP, or in a BWP other than the activated dormant BWP, the UE may monitor the PDCCH to identify the base station's instruction, may perform channel measurement regarding the downlink of the cell of the active mode or activated state (or the activated BWP of the cell, or an activated normal BWP, or a BWP other than the activated dormant BWP), the UE may periodically report measurement information to the base station, and the UE may periodically transmit a pilot signal (for example, SRS) to the base station such that the base station can perform channel measurement. Alternatively, the UE may activate or switch the BWP to a dormant BWP with regard to the activated cell according to the base station's instruction (for example, PDCCH or MAC CE or RRC message) and, if the dormant BWP has been activated in the activated cell, the UE may not perform PDCCH monitoring in the cell, and may perform a procedure of performing channel measurement reporting and reporting the channel measurement result.

As another method, if the cell having an activated the dormant BWP is a SCell, the UE may not monitor the PDCCH or may not receive downlink data or may perform channel measurement or measurement result reporting or may suspend a configured periodic transmission resource (for example, configured uplink grant type 1) or may clear or reset a configured periodic transmission resource (for example, configured uplink grant type 2) or may transmit no SRS or may transmit no uplink data or may transmit no PUCCH (for example, preamble for random access or SR). However, if the cell, the dormant BWP of which is activated, or for which cell group suspension is indicated, is a PSCell, the UE may not monitor the PDCCH or may perform PDCCH monitoring at a substantially long cycle or may receive no downlink data or may perform channel measurement or measurement result reporting or may suspend a configured periodic transmission resource (for example, configured uplink grant type 1) or may clear or reset a configured periodic transmission resource (for example, configured uplink grant type 2) or may transmit a sounding reference signal (SRS) or may transmit no uplink data or may transmit a PUCCH (for example, preamble for random access or SR) or may perform a random access procedure.

If the cell having an activated BWP which is not a dormant BWP is a SCell, the UE may monitor the PDCCH or may receive downlink data or may perform channel measurement or measurement result reporting or may resume a configured periodic transmission resource (for example, configured uplink grant type 1) or may configure or activate a configured periodic transmission resource (for example, configured uplink grant type 2) or may transmit an SRS or may transmit uplink data or may transmit a PUCCH (for example, preamble for random access or SR) or may perform a random access procedure.

If the cell which has an activated BWP other than the dormant BWP, or for which SCG resumption is indicated, is a PSCell, the UE may monitor the PDCCH or may receive downlink data or may perform channel measurement or measurement result reporting or may resume a configured periodic transmission resource (for example, configured uplink grant type 1) or may configured or activate a configured periodic transmission resource (for example, configured uplink grant type 2) or may transmit an SRS or may transmit uplink data or may transmit a PUCCH (for example, preamble for random access or SR) or may perform a random access procedure.

However, the description that the cell is in a deactivated mode or deactivated state may mean that BWPs configured in the cell are deactivated, or configured BWPs are not activated, or there is no activated BWP among the configured BWPs, and the UE thus cannot exchange data with the base station, the UE does not monitor the PUCCH for identifying the base station's instruction, the UE performs no channel measurement, the UE performs no measurement reporting, and the UE transmits no pilot signal.

Therefore, in order to activate cells in the deactivated mode, the base station first configures frequency measurement configuration information for the UE through an RRC message, and the UE performs cell or frequency measurement, based on the frequency measurement configuration information. The base station may activate the deactivated cells, based on frequency/channel measurement information, after receiving the UE's cell or frequency measurement report. This causes a high degree of delay until the base station causes the UE to activate carrier aggregation or dual connectivity and then starts data transmission or reception.

The disclosure proposes a dormant BWP or a dormant state with regard to the BWP of each activated cell (for example, activated Scell or activated PSCell) such that, the UE's battery can be saved, and data transmission or reception can be quickly started, or proposes that a dormant bandwidth part (BWP) be configured or introduced with regard to each activated cell. Alternatively, the disclosure proposes that, when dual connectivity is configured for the UE, an activated state or a dormant state or a suspended state or deactivated state or a resumed state is configured or introduced with regard to the state of each cell group, and proposes a method for indicating cell group suspension or SCG suspension or cell group resumption or SCG resumption such that the cell group state transition is indicated, and UE operations according thereto.

The UE cannot exchange data with the base station in the dormant-mode BWP or dormant BWP in activated SCell, or when the dormant BWP is activated, or the UE does not monitor the PDCCH for identifying the base station's instruction, or the UE transmits no pilot signal but performs channel measurement, and the UE report the measurement result regarding the measured frequency/cell/channel periodically or when an event occurs, according to the base station configuration. Therefore, the UE does not monitor the PDCCH in the dormant BWP of the activated cell and transmits no pilot signal, and thus can save the battery compared with the normal BWP (or a BWP other than the dormant BWP) of the activated cell, or compared with the case in which the normal BWP (or a BWP other than the dormant BWP) of the activated cell is activated. The UE performs channel measurement reporting, unlike the time when the cell is deactivated, and the base station thus quickly activates the normal BWP of the activated cell, based on the measurement report, or based on the report of measurement of the dormant BWP of the activated cell, such that carrier aggregation can be quickly used, thereby reducing transmission delay.

Therefore, in the disclosure, the description that a cell is in an active mode or activated state may mean that the UE may exchange uplink or downlink data with the base station in the activated BWP of the cell in the active mode or activated cell, or in an activated normal BWP, or in a BWP other than the activated dormant BWP, the UE may monitor the PDCCH to identify the base station's instruction, the UE may perform channel measurement regarding the downlink of the cell in the active mode or activated state (or the activated BWP of the cell or an activated normal BWP or a BWP other than the activated dormant BWP) and may periodically report measurement to the base station, and the UE may periodically transmit a pilot signal (SRS) to the base station such that the base station can perform uplink channel measurement. In addition, in the disclosure, the description that a cell is in an active mode or activated state may mean that the UE cannot exchange uplink or downlink data with the base station in the activated dormant BWP of the cell in the active mode or activated cell, or that the UE may does not monitor the PDCCH to identify the base station's instruction, but may perform channel measurement regarding the downlink of the activated dormant BWP of the cell in the active mode or activated state, and may periodically report measurement to the base station.

If the cell which has an activated dormant BWP, or for which cell group suspension is indicated, is a PSCell, the UE may not monitor the PDCCH or may perform PDCCH monitoring at a substantially long cycle or may not receive downlink data or may perform channel measurement or measurement result reporting or may suspend a configured periodic transmission resource (for example, configured uplink grant type 1) or may clear or reset a configured periodic transmission resource (for example, configured uplink grant type 2) or may transmit an SRS or may transmit no uplink data or may transmit no PUCCH (for example, preamble for random access or SR) or may perform a random access procedure.

As another method, if the cell for which cell group deactivation (or suspension) is indicated is a PSCell (or SCG), the UE may not monitor the PDCCH or may perform PDCCH monitoring at a substantially long cycle or may not receive downlink data or may not perform channel measurement or measurement result reporting or may suspend a configured periodic transmission resource (for example, configured uplink grant type 1) or may clear or reset a configured periodic transmission resource (for example, configured uplink grant type 2) or may transmit no SRS or may transmit no uplink data or may transmit no PUCCH (for example, preamble for random access or SR). However, a frequency measurement procedure (radio resource management) may be performed with frequency measurement configuration information configured by the base station through an RRC message which instructs cell group deactivation (or resumption) when the cell group deactivation (or resumption) is instructed, or if radio link monitoring (RLM) configuration information is configured, a timer (T310) is driven upon receiving indication that signals are not synchronized from an RLM procedure (lower layer device (PHY layer device)), based on the timer (T310), and a radio link failure is announced if the timer (T310) expires. If an indication that signals are not synchronized is received, the currently driven timer (T310) may be suspended. In addition, if beam-related configuration information is configured so as to perform a beam failure detection procedure through an RRC message indicating cell group deactivation (or suspension) when the cell group deactivation (or suspension) is indicated, the UE may perform the beam failure detection procedure.

In addition, in the disclosure, a dormant BWP may indicate the state of the BWP, or the dormant BWP may be used, in a logical concept, to refer to a specific BWP. Therefore, the dormant BWP may be activated or deactivated or switched. For example, an instruction to switch a second BWP activated in a first cell to a dormant BWP or an instruction to transition the first cell to a hibernation or dormant mode or an instruction to activate the dormant BWP of the first cell may all be interpreted in the same sense.

In addition, in the disclosure, a normal BWP may refer to BWPs other than a dormant BWP, among BWPs configured for each cell of a UE through an RRC message. In the normal BWP, the UE may exchange uplink or downlink data with the base station, may monitor the PDCCH to identify the base station's instruction, may perform channel measurement regarding the downlink channel and periodically report measurement information to the base station, and may periodically transmit a pilot signal (SRS) to the base station such that the base station can perform uplink channel measurement. In addition, the normal BWP may refer to an initially activated BWP or a default BWP or an initially activated BWP activated from hibernation or an initial BWP.

In addition, only one dormant BWP may be configured among BWPs configured for each cell of the UE, and may be configured with regard to the downlink. As another method, one dormant BWP may be configured, among BWPs configured for each cell of the UE, with regard to the uplink or downlink.

In addition, in the disclosure, the state of a cell group may be configured as an activated state or a suspended state or a deactivated state. The state of a cell group may be indicated by an indicator or a bitmap of DCI of a PDCCH or by a MAC control element or by an indicator of an RRC message. If state of a cell group is configured as an activated state, configuration information of the cell group configured or indicated by an RRC message (for example, RRCReconfiguration message or RRCSetup message or RRCResume message) may be stored and may be applied in the UE or may be restored or may be resumed. According to the configuration of the RRC message configured in the cell group's PCell or PSCell or configured SCell, the PDCCH may be monitored, or downlink data may be received, or channel measurement or measurement result reporting may be performed, or a configured periodic transmission resource (for example, configured uplink grant type 1) may be resumed, or a configured periodic transmission resource (for example, configured uplink grant type 2) may be configured or activated, or a sounding reference signal (SRS) may be transmitted, or uplink data may be transmitted, or a PUCCH (for example, preamble for random access or scheduling request (SR)) may be transmitted, or a random access procedure may be performed.

In addition, if the state of the cell group is indicated as a suspended state or deactivated state, configuration information of a cell group configured or indicated by an RRC message (for example, RRCReconfiguration message or RRCSetup message or RRCResume message) may be stored in the UE, or application thereof may be suspended without discarding the same. According to the configuration of the RRC message configured in the cell group's PCell or PSCell or configured SCell, the PDCCH may not be monitored, or PDCCH monitoring may be performed at a substantially long cycle, or no downlink data may be received, or channel measurement or measurement result reporting may be performed, or a configured periodic transmission resource (for example, configured uplink grant type 1) may be suspended, or a configured periodic transmission resource (for example, configured uplink grant type 2) may be cleared or reset, a SRS may be transmitted, or no uplink data may be transmitted, or a PUCCH (for example, preamble for random access or scheduling request (SR)) may be transmitted, or a random access procedure may be performed.

In addition, if the state of the cell group is indicated as a deactivated state, or if cell group configuration information release is indicated, configuration information of a cell group configured or indicated by an RRC message (for example, RRCReconfiguration message or RRCSetup message or RRCResume message) may be released or discarded in the UE.

FIG. 1EA and FIG. 1EB illustrate a procedure for providing a service to a UE by efficiently using a substantially large frequency bandwidth in a next-generation mobile communication system according to an embodiment of the disclosure.

With reference to FIG. 1EA and FIG. 1EB, it will be described how to efficiently use a substantially large frequency bandwidth in a next-generation mobile communication system such that a service is provided to UEs having different capabilities or categories, and the battery can be saved.

One cell in which a base station provides a service may service a substantially wide frequency band like 1e-05. However, in order to provide a service to UEs having different capabilities, the wide frequency band may be divided into multiple BWPs and managed as one cell.

If initially powered on, the UE may search for the entire frequency band provided by the business operator (PLMN) at a predetermined resource block level (for example, with regard to each 12 resource blocks (RB)). That is, the UE may start to search for a primary synchronization sequence (PSS)/secondary synchronization sequence (SSS) in the entire system bandwidth at the RB level (1e-10). If the signals are detected while searching for the PSS/SSS at the RB level 1e-01 or 1e-02, the signals may be read and interpreted (decoded), thereby identifying the boundary between subframes and radio transmission resource frames. Therefore, subframes can be distinguished at 1js level, and the UE synchronizes downlink signals with the base station. As used herein, a resource block (RB) may be defined as a two-dimensional unit indicating the size of a predetermined frequency resource and a predetermined time resource. For example, the time resource may be defined at 1js level, and 12 subcarriers (one carrier×15 kHz=180 kHz) may be defined as the frequency resource. Upon completing synchronization, the UE may identify a master system information block (MIB) or minimum system information (MSI) so as to identify information of a control resource set (CORESET) and identify information of an initial access bandwidth part (BWP) (1e-15, 1e-20). As used herein, CORESET information refers to the location of a time/frequency transmission resource through which a control signal is transmitted from the base station, and, for example, refers to a resource location at which a PDCCH channel is transmitted (1e-15). That is, the CORESET information indicated where first system information (system information block 1 (SIB1)) is transmitted, and indicated in what frequency/time resource the PDCCH is transmitted. Upon reading the first system information, the UE may identify information regarding the initial BWP (1e-20). If the UE becomes able to receive a control signal after completing synchronization of downlink signals with the base station as described above, the UE may perform a random access procedure in the initial BWP 1e-15 of the cell on which the UE camped, may request RRC connection configuration, and may receive an RRC message, thereby performing RRC connection configuration.

In the RRC connection configuration, multiple BWPs may be configured for one cell (Pcell or Pscell or Spcell) (1e-20, 1e-25, 1e-30). Multiple BWPs may be configured for the downlink in one cell, and multiple BWPs may be separately configured for the uplink.

The multiple BWPs may be indicated and configured by a BWP identifier such that they can be used as an initial BWP or a default BWP or a first active BWP or a dormant BWP or a first active BWP activated from dormant.

The initial BWP 1e-20 may be used as a BWP determined cell-specifically, which exists one for each cell, and may be used by a UE which initially accesses the cell so as to configure connection to the cell through a random access procedure, or may be used by the UE to perform synchronization after configuring the connection. In addition, the base station may configure an initial downlink BWP to be used in the downlink and an initial uplink BWP to be used in the uplink, with regard to each cell. In addition, configuration information regarding the initial BWP may be broadcast in system information 1 (SIB1) indicated by the CORESET 1e-15, and may be reconfigured by the base station for the UE that accessed connection through an RRC message. In addition, the initial BWP 1e-20 may be used in the uplink and downlink by designating BWP identifier no. 0, respectively. That is, all UEs that accessed the same cell may use the same initial BWP by designating the same BWP identifier no. 0. This is because, when performing a random access procedure, the base station may transmit a RAR message in the initial BWP that all UEs can read, thereby having an advantage in that the contention-based random access procedure is facilitated.

The first active BWP may be configured different in a UE specific manner, and may be indicated by designating a BWP identifier among multiple BWPs. The first active BWP may be configured for each of the downlink and the uplink, and may be configured as a first active downlink BWP and a first active uplink BWP by respective BWP identifiers. The first active BWP may be used to indicate which BWP, among multiple BWPs configured for one cell, is to be first activated and used. For example, if a Pcell or Pscell and multiple Scell are configured for a UE, if multiple BWPs are configured for the Pcell or Pscell or Scell, respectively, and if the Pcell or Pscell or Scell is activated, the UE may activate and use the first active BWP among the multiple BWPs configured for the Pcell or Pscell or Scell. That is, the first active downlink BWP may be activated and used for the downlink, and the first active uplink BWP may be activated and used for the uplink.

The operation in which the UE switches the current or activated downlink BWP with regard to the cell, thereby activating the same as a first active downlink BWP (or a BWP configured or indicated by an RRC message), or switches the current or activated uplink BWP with regard to the cell, thereby activating the same as a first active uplink BWP (or a BWP configured or indicated by an RRC message), may be performed when the UE receives an instruction to activate the cell or BWP that has been inactive, through an RRC message or MCE control information or DCI. In addition, the UE may perform the operation upon receiving an instruction to transition the cell or BWP to a dormant state or an instruction to activate the same as a dormant BWP through an RRC message or MCE control information or DCI. This is because, when the cell or BWP is activated, the current or activated downlink BWP inevitably switched and activated as a first active downlink BWP (or a BWP configured or indicated by an RRC), or the uplink BWP is inevitably switched and activated as a first active uplink BWP (or a BWP configured or indicated by an RRC), and the base station can effectively use carrier aggregation only if the frequency/channel is measured and reported with regard to the first active downlink/uplink BWP even when performing channel measurement reporting in the dormant state. The default BWP may be configured differently in a UE specific manner, and may be indicated by designating a BWP identifier among multiple BWPs. The default BWP may be characteristically be configured with regard to the downlink only. The default BWP may be used as a BWP to which an activated BWP is to fall back, among multiple downlink BWPs, after a predetermined time. For example, a BWP inactivity timer may be configured through an RRC message for each cell or each BWP, and the timer may be started or restarted when data transmission/reception occurs in an activated BWP other than the default BWP, or may be started or restarted when an activated BWP is switched to another BWP. If the timer expires, the UE may fall back or switch the downlink BWP activated for the cell to the default BWP. As used herein, switching may refer to a procedure of deactivating the currently activated BWP and activating the BWP regarding which switching is indicated, and the switching may be triggered by an RRC message or a MAC control element or DCI of L1 signaling (PDCCH). The switching may be triggered by indicating the BWP to be switched or activated, and the BWP may be indicated by a BWP identifier (for example, 0 or 1 or 2 or 3 or 4) (1e-35, 1e-40, 1e-45, 1e-5).

The reason the default BWP is applied and used with regard to the downlink only is because the base station can cause the UE to fall back to the default BWP over a predetermined time with regard to each cell and to receive the base station's instruction (for example, DCI of PDCCH), thereby facilitating base station scheduling. For example, if the default BWP of UEs that accessed one cell is configured by the base station to be an initial BWP, the base station may perform a scheduling instruction with regard to the initial BWP only after a predetermined time. If the default BWP is not configured in the RRC message, the initial BWP may be considered as the default BWP so as to fall back to the initial BWP when the BWP inactivity timer expires.

As another method, the default BWP may be defined and configured with regard to the uplink as well, in order to increase the degree of freedom regarding the implementation of the base station, and then used like the default BWP of the downlink.

The dormant BWP refers to a BWP in a dormant mode of an activated cell or a dormant BWP in activated SCell, or when the dormant BWP is activated, the UE cannot exchange data with the base station, or does not monitor the PDCCH for identifying the base station's instruction, or transmits no pilot signal but performs channel measurement, and reports the measurement result regarding the measured frequency/cell/channel periodically or when an event occurs, according to the base station configuration. Therefore, the UE does not monitor the PDCCH in the dormant BWP of the activated cell and does not transmit pilot signals such that, compared with the normal BWP (or a BWP other than the dormant BWP) of the activated cell, or compared with the time when the normal BWP (or a BWP other than the dormant BWP) of the activated cell is activated, the battery can be saved. In addition, channel measurement reporting is performed, unlike the time when the cell is deactivated, such that the base station can quickly activate the normal BWP of the activated cell, based on the measurement report, or based on the report of measurement of the dormant BWP of the activated cell, and thus can quickly use carrier aggregation, thereby reducing transmission delay.

The first active BWP switched from a dormant state or from a dormant BWP and activated (or a first active non-dormant BWP or a BWP configured or indicated by an RRC message) may be a BWP which the UE needs to activate by switching the current or activated BWP of an activated cell according to a corresponding instruction, or a BWP which is to be activated from a dormant state configured in the RRC message, if the UE is instructed by the base station through DCI of PDCCH or MAC CE or RRC message to switch the BWP of the activated cell from the dormant BWP to a normal BWP (or a BWP other than the dormant BWP), or if the UE is instructed to switch or transition the activated BWP from the dormant BWP to the normal BWP, or if the UE is instructed to switch or transition or activate the active BWP from the dormant BWP to the normal BWP (for example, the first active BWP activated from dormancy), when the UE is operating the BWP of one activated cell as a dormant BWP, or when the activated BWP in the activated cell is a dormant BWP, or when the UE switched to the dormant BWP in the cell.

FIG. 1F illustrates a procedure in which a UE switches from an RRC idle mode to an RRC connected mode in a next-generation mobile communication system according to an embodiment of the disclosure, and illustrates a procedure in which bearer configuration information for connection or cell group or cell configuration information or channel measurement configuration information is configured for a UE.

Referring to FIG. 1F, one cell in which a base station provides a service may service a substantially wide frequency band. The UE may initially search for the entire frequency band provided by the business operator (PLMN) at a predetermined resource block level (for example, with regard to each 12 RBs). That is, the UE may start to search for a primary synchronization sequence (PSS)/secondary synchronization sequence (SSS) in the entire system bandwidth at the RB level. If the UE detects the signals while searching for the PSS/SSS at the RB level, the signals may be read and interpreted (decoded), thereby identifying the boundary between subframes and radio transmission resource frames. Upon completing synchronization, the UE may read system information of the cell on which the UE currently camps. That is, the UE may identify a master system information block (MIB) or minimum system information (MSI) so as to identify information of a control resource set (CORESET), and may read system information so as to identify initial bandwidth part (BWP) information (1f-01, 1f-05). As used herein, CORESET information refers to the location of a time/frequency transmission resource through which a control signal is transmitted from the base station, and, for example, refers to a resource location at which a PDCCH channel is transmitted.

If the UE becomes able to receive a control signal after completing synchronization of downlink signals with the base station as described above, the UE may perform a random access procedure in the initial BWP, may receive a random access response, may request RRC connection configuration, and may receive an RRC message, thereby performing RRC connection configuration (1f-10, 1f-15, 1f-20, 1f-25, 1f-30).

After the default RRC connection configuration is completed, the base station may send an RRC message to the UE to inquire about the UE's capability in order to identify the UE capability (UECapabilityEnquiry, 1f-35). As another method, the base station may inquire the MME or AMF about the UE's capability in order to identify the UE capability. This is because, if the UE previously accessed, the MMF or AMF might have stored UE capability information. If there is no UE capability information that the base station wants, the base station may request the UE to provide UE capability. When reporting the UE capability, the UE may report whether the UE supports a dormant BWP with regard to each cell group (master cell group or secondary group), or whether the UE supports the first embodiment or second embodiment or third embodiment or fourth embodiment of the disclosure, or whether the UE supports a dormant BWP with regard to the PSCell of each cell group, or whether the UE supports a cell group suspension or resumption procedure with regard to the PSCell of each cell group, or the number of supported cell groups, or the like to the base station as UE capability. In addition, in the RRC connection resumption procedure, the UE may use an RRCResume message to report whether configuration information of the SCell or the master cell group or the SCell of the secondary cell group or the PSCell of the secondary cell group can be stored and restored, or whether the same can be discarded, or whether the same can be partially reconfigured, or whether the same can be activated, to the base station as UE capability.

The reason the base station sends an RRC message to the UE to identify UE capability is to identify UE capability and to recognize what degree of frequency band the UE can read, for example, or the domain of frequency bands that can be read. In addition, the base station may configure an appropriate BWP for the UE after identifying the UE capability. Upon receiving the RRC message that inquires about the UE capability, the UE may indicate, in response thereto, the range of bandwidths supported by the UE to the base station, or may indicate what range of bandwidths is supported in the current system bandwidth, or the like, by an offset from the reference center frequency, or may directly indicate the starting point and last point of the supported frequency bandwidth, or may indicate the center frequency and bandwidth (1f-40).

The BWP may be configured by an RRCSetup message of RRC connection configuration or RRCResume message 1f-25 or RRCReconfiguration message (1f-45, 1f-70). The RRC message may include configuration information regarding a PCell or Pscell or multiple cells, and multiple BWPs may be configured with regard to each cell (PCell or Pscell or Scell). When multiple BWPs are configured with regard to each cell, multiple BWPs to be used in the downlink of each cell may be configured. In the case of an FDD system, multiple BWPs to be used in the uplink of each cell may be configured separately from the downlink BWPs. In the case of a TDD system, multiple BWPs to be commonly used in the downlink and uplink of each cell may be configured.

Cell configuration information of each cell (PCell or Pscell or Scell) or configuration for BWP configuration may include some of the following pieces of information:
Cell identifier (SCell index)
Cell configuration information
Cell-specific or BWP-specific first channel measurement configuration information
Cell-specific or BWP-specific second channel measurement configuration information
The cell's downlink BWP configuration information
Initial downlink BWP configuration information
Multi-BWP configuration information and BWP ID corresponding to each BWP
The cell or downlink BWP's initial state configuration information (for
example, active state or dormant state or deactivated state)
BWP ID indicating a first active downlink BWP
BWP ID indicating a default BWP
Configuration information for PDCCH monitoring regarding each BWP, for example, CORESET information of search space resource information, or PDCCH transmission resource, cycle, subframe number information or the like
BWP ID indicating a dormant BWP
BWP ID indicating a first active BWP activated from dormancy
BWP inactivity timer configuration and timer value
Cell-specific or BWP-specific first channel measurement configuration information
Cell-specific or BWP-specific second channel measurement configuration information
The cell's uplink BWP configuration information
Initial uplink BWP configuration information
Multi-BWP configuration information and BWP ID corresponding to each BWP
The cell or downlink BWP's initial state configuration information (for example, active state or dormant state or deactivated state)
BWP ID indicating a first active uplink BWP
Configuration information regarding a transmission resource to perform channel measurement in a dormant BWP or in a BWP other than the dormant BWP and to report the measurement result (for example, PCell or PUCCH SCell or PSCell's PUCCH transmission resource information)

The first channel measurement configuration information that may be included in the RRC message (RRCReconfiguration or RRCResume) and configured may include, in order to quickly activate the cell group, configuration information, such as the cycle regarding a frequent channel measurement signal (for example, radios resource or temporary reference signal (TRS) or synchronization signal block (SSB) or channel state information reference signal (CSI-RS) or reference signal (RS)) such that the base station can temporarily transmit a channel measurement signal a lot or often such that channel measurement can be quickly performed in the cell in configuration information of a cell (for example, Pcell or PSCell or SCell) of the cell group, or transmitted transmission resource information (frequency or time transmission resource used to transmit the frequent channel measurement signal) or an interval or the number of times (the number of times the frequent channel measurement signal is transmitted) or a timer value (the time during which the frequent channel measurement signal is transmitted) or a time interval (interval in which the frequent channel measurement signal is transmitted (for example, offset of time unit (slot or subframe or symbol or the like) or a transmission resource or cycle or interval or timing or offset by which the UE needs to report the measurement report. The first channel measurement configuration information may be characterized by configuring a short reporting cycle (or transmission resource) at which the UE can report the channel measurement result, or configuring a transmission resource for channel measurement such that the base station can transmit many channel measurement signals (or transmission resources (for example, radio resources or temporary reference signals (TRS)) a lot or frequently in order for the base station to support the UE's quick channel measurement or many signal measurements. The first channel measurement configuration information may include configuration information regarding a channel measurement signal for a specific UE (or UEs) in the cell or BWP used by the base station. For example, the first channel measurement configuration information may include the cycle of the channel measurement signal or the number of transmitted signals or an offset regarding the period of time during which signals are transmitted or the time at which signals are transmitted or the time length between transmitted signals or a list of multiple transmittable channel measurement signals or time transmission resources (or frequency transmission resources) indicating the location of transmitted signals or transmission resources (time transmission resources or frequency transmission resources) to be used to report measurement results or the measurement result reporting cycle or the like. In addition, the first channel measurement configuration information may be configured differently with regard to multiple cells or BWPs configured in the RRC message or for each cell or each BWP, and beam-related configuration information (transmission configuration indication (TCI) state or quasi co-location (QCL)) such as the beam direction or beam number or beam location may be configured together such that the UE can easily measure transmission resources for channel measurement. In addition, the first channel measurement configuration information may be used to configure a timing advance (TA) value (or offset value) for synchronizing the base station's downlink signal or the base station's uplink signal, or a time alignment timer (TAT) indicating the validity of the TA value, or a TAT value such that correct channel measurement or channel measurement reporting can be performed. In addition, the first channel measurement configuration information configured by an RRC message may include multiple pieces of channel measurement signal information, and the RRC message or MAC CE or DCI may be used to indicate a specific piece of channel measurement signal information among the configured multiple pieces of channel measurement signal information, or beam configuration information such that the UE can perform channel measurement or perform channel measurement reporting by applying or using the indicated channel measurement signal information or beam configuration information. According to the method of indication, mapping between a bitmap or an index or an identifier and each piece of channel measurement signal information configured above may be defined, and an indication is made based thereon. As another method, the RRC message or MAC CE may be used to configure or indicate channel measurement signal information such that the UE can perform channel measurement or perform channel measurement reporting by applying or using the configured (or indicated) channel measurement signal information.

The first channel measurement configuration information proposed in the disclosure may be characterized in that the same is initially deactivated when configured by an RRC message or after a handover, and may be activated by a MAC control element proposed in the disclosure later, or DCI information of the PDCCH, or the RRC message. When configured by the RRC message as described above, the initial state needs to be deactivated such that the base station can easily manage the UE's cell state or the channel measurement performing procedure, and the UE can be accurately timed regarding when and how channel measurement is to be performed, without the processing delay problem of the RRC message.

In addition, second channel measurement configuration information may be included or configured in the RRC message (RRCReconfiguration or RRCResume). The second channel measurement configuration information may include general channel measurement configuration information such as a channel measurement signal's transmission resource or cycle or time interval or number of times, or a transmission resource or cycle or time interval for channel measurement reporting.

The configured initial BWP or default BWP or first active BWP may be used for the following purposes, and may operate as follows according to the purposes.

The initial BWP may be used as a BWP determined cell-specifically, which exists one for each cell, and may be used by a UE which initially accesses the cell so as to configure connection to the cell through a random access procedure, or may be used by the UE to perform synchronization after configuring the connection. In addition, the base station may configure an initial downlink BWP to be used in the downlink and an initial uplink BWP to be used in the uplink, with regard to each cell. In addition, configuration information regarding the initial BWP may be broadcast in system information 1 (SIB1) indicated by a CORESET, and may be reconfigured by the base station for the UE that accessed connection through an RRC message. In addition, the initial BWP may be used in the uplink and downlink by designating BWP identifier no. 0, respectively. That is, all UEs that accessed the same cell may use the same initial BWP by designating the same BWP identifier no. 0. This is because, when performing a random access procedure, the base station may transmit a RAR message in the initial BWP that all UEs can read, thereby having an advantage in that the contention-based random access procedure is facilitated.

The first active BWP may be configured different in a UE specific manner, and may be indicated by designating a BWP identifier among multiple BWPs. The first active BWP may be configured for each of the downlink and the uplink, and may be configured as a first active downlink BWP and a first active uplink BWP by respective BWP identifiers. The first active BWP may be used to indicate which BWP, among multiple BWPs configured for one cell, is to be first activated and used. For example, if a Pcell or Pscell and multiple Scell are configured for a UE, if multiple BWPs are configured for the Pcell or Pscell or Scell, respectively, and if the Pcell or Pscell or Scell is activated, the UE may activate and use the first active BWP among the multiple BWPs configured for the Pcell or Pscell or Scell. That is, the first active downlink BWP may be activated and used for the downlink, and the first active uplink BWP may be activated and used for the uplink.

The operation in which the UE switches the current or activated downlink BWP with regard to the cell, thereby activating the same as a first active downlink BWP (or a BWP configured or indicated by an RRC message), or switches the current or activated uplink BWP with regard to the cell, thereby activating the same as a first active uplink BWP (or a BWP configured or indicated by an RRC message), may be performed when the UE receives an instruction to activate a cell or the BWP of an activated cell, which has been inactive or dormant, or an instruction to switch or activate from the inactive or dormant BWP to a normal BWP, through an RRC message or MCE control information or DCI of a PDCCH. In addition, the UE may switch or activate the BWP to a dormant BWP, or hibernate the BWP, when the UE is instructed to transition an activated cell or BWP to a dormant state or to switch the same to a dormant BWP or to activate the same, through an RRC message or MCE control information or DCI of a PDCCH.

The switching to hibernation or a dormant BWP or activation of the dormant BWP may mean performing of an operation proposed in the disclosure in a dormant state. That is, the UE may not perform PDCCH monitoring and may perform an operation of measuring the channel with regard to the downlink BWP (or dormant BWP) and reporting the same to the base station. As another method, when the activated cell or BWP is activated or switched to a normal BWP, the downlink BWP will be inevitably switched and activated as a first active downlink BWP, and the uplink BWP will be inevitably switched and activated as a first active uplink BWP, and the dormant BWP may thus be configured as the first active downlink or uplink BWP or as a default BWP. The default BWP may be configured differently in a UE specific manner, and may be indicated by designating a BWP identifier among multiple BWPs. The default BWP may be characteristically be configured with regard to the downlink only. The default BWP may be used as a BWP to which an activated BWP is to fall back, among multiple downlink BWPs, after a predetermined time. For example, a BWP inactivity timer may be configured through an RRC message for each cell or each BWP, and the timer may be started or restarted when data transmission/reception occurs in an activated BWP other than the default BWP, or may be started or restarted when an activated BWP is switched to another BWP. If the timer expires, the UE may fall back or switch the downlink BWP activated for the cell to the default BWP. As used herein, switching may refer to a procedure of deactivating the currently activated BWP and activating the BWP regarding which switching is indicated, and the switching may be triggered by an RRC message or a MAC control element or DCI of L1 signaling (PDCCH). The switching may be triggered by indicating the BWP to be switched or activated, and the BWP may be indicated by a BWP identifier (for example, 0 or 1 or 2 or 3 or 4).

The reason the default BWP is applied and used with regard to the downlink only is because the base station can cause the UE to fall back to the default BWP over a predetermined time with regard to each cell and to receive the base station's instruction (for example, DCI of PDCCH), thereby facilitating base station scheduling. For example, if the default BWP of UEs that accessed one cell is configured by the base station to be an initial BWP, the base station may continuously perform a scheduling instruction with regard to the initial BWP only after a predetermined time. If the default BWP is not configured in the RRC message, the initial BWP may be considered as the default BWP so as to fall back to the initial BWP when the BWP inactivity timer expires.

As another method, the default BWP may be defined and configured with regard to the uplink as well, in order to increase the degree of freedom regarding the implementation of the base station, and then used like the default BWP of the downlink.

The dormant BWP refers to a BWP in a dormant mode of an activated cell or a dormant BWP in activated SCell, or when the dormant BWP is activated, the UE cannot exchange data with the base station, or does not monitor the PDCCH for identifying the base station's instruction, or transmits no pilot signal but performs channel measurement, and reports the measurement result regarding the measured frequency/cell/channel periodically or when an event occurs, according to the base station configuration. Therefore, the UE does not monitor the PDCCH in the dormant BWP of the activated cell and does not transmit pilot signals such that, compared with the normal BWP (or a BWP other than the dormant BWP) of the activated cell, or compared with the time when the normal BWP (or a BWP other than the dormant BWP) of the activated cell is activated, the battery can be saved. In addition, channel measurement reporting is performed, unlike the time when the cell is deactivated, such that the base station can quickly activate the normal BWP of the activated cell, based on the measurement report, or based on the report of measurement of the dormant BWP of the activated cell, and thus can quickly use carrier aggregation, thereby reducing transmission delay.

The first active BWP (or first active non-dormant BWP) activated from dormancy may be the BWP of an activated cell, which the UE needs to switch or activate according to the instruction, and which is activated from dormancy as configured in an RRC message, if the UE is instructed by the base station through DCI of PDCCH or MAC CE or RRC message to switch the BWP of the activated cell from the dormant BWP to a normal BWP (or a BWP other than the dormant BWP), or if the UE is instructed to switch or transition the activated BWP from the dormant BWP to the normal BWP, or if the UE is instructed to switch or transition or activate the active BWP from the dormant BWP to the normal BWP (for example, the first active BWP activated from dormancy), when the UE is operating the BWP of one activated cell as a dormant BWP, or when the activated BWP in the activated cell is a dormant BWP, or when the UE switched to the dormant BWP in the cell.

As used herein, the description that a first BWP is switched to a second BWP may mean that the second BWP is activated, or that the first BWP that has been active is deactivated, and the second BWP is then activated.

In addition, in the RRCSetup message of RRC connection configuration or in the RRCResume message (1f-25), or in the RRCReconfiguration message (1f-45), a state transition timer may be configured such that the UE can autonomously perform a state transition even without being instructed by the base station through an RRC message or a MAC control element or DCI of PDCCH. For example, a cell deactivation timer (for example, ScellDeactivationTimer) may be configured for each cell and, if the cell deactivation timer expires, the cell may be transitioned to a deactivated state.

In addition, in the RRCSetup message of RRC connection configuration or in the RRCResume message (1f-25), or in the RRCReconfiguration message (1f-45), frequency measurement configuration information and frequency measurement gap configuration information and the like may be configured, and the message may include frequency measurement object information. In addition, in the RRCSetup message of RRC connection configuration or in the RRCResume message (1f-25), or in the RRCReconfiguration message (1f-45), a function for reducing the UE's power consumption (power saving mode) may be configured, and together with the function for reducing power consumption, configuration information, such as a discontinuous reception (DRX) cycle or offset or on-duration interval (in which the UE needs to monitor the PDCCH) or time information, or time information regarding when the PDCCH is to be monitored or detected from the base station prior to the on-duration interval, or short time cycle information or the like may be configured. If the function for reducing the UE's power consumption has been configured, the UE may configure a DRX cycle and may detect a wakeup signal (WUS) in the interval configured such that the PDCCH of the base station is to be monitored prior to the on-duration interval, and the base station may instruct the UE, through the DCI of the PDCCH of the WUS signal, whether to skip (or not perform) PDCCH monitoring in the immediately following on-duration interval or to perform the same. The UE always has to monitor the PUCCH in the on-duration interval, and the base station may instruct the UE not to monitor the PDCCH in the on-duration interval through the WUS signal, thereby reducing the UE's battery consumption.

After the RRC connection configuration is completed, the UE may configure multiple BWPs according to the instruction configured by the RRC message. In addition, in order to save the battery, one of the multiple configured BWPs, or a small number of BWPs among the same, may be activated. For example, one BWP to be activated may be indicated. In addition, the base station may indicate activation of a BWP through an RRC message or a MAC CE or L1 signaling (PHY layer control signal such as DCI of PDCCH), thereby instructing to switch from the initial access BWP to a new BWP. As another method, new bit map information may be defined in the DCI of the PDCCH, thereby indicating whether or not to active a normal BWP (or a BWP other than the dormant BWP) or activate the dormant BWP or deactivate the BWP. As another method, the bitmap may be used to indicate whether or not to activate a normal BWP (for example, first active BWP to be activated from hibernation) or activate the dormant BWP or switch to the dormant BWP or perform BWP switching. The initial access BWP may have many other newly accessing users, and it may thus be substantially advantageous, in terms of scheduling, to allocate a new BWP and to separate manage the connected users. This is because the initial access BWP is not configured for each UE, but may be shared and used commonly by all UEs. In addition, in order to reduce signaling overhead, the MAC control element or L1 signaling or system information may be used to dynamically indicate the default BWP.

In addition, the RRC message (RRCSetup message or RRCResume message 1f-25 or RRCReconfiguration message 1f-70) may include configuration information for a cell group. The configuration information for a cell group may include some or multiple pieces of information among the following pieces of information, or may indicate the state or procedure regarding each cell group or application or release of configuration information or the like.
Cell group identifier (for example, cell group identifier or index) indicating a cell group
An indicator indicating the state of a cell group (for example, active state or suspended state or deactivated state)
An indicator indicating the state of a cell group (for example, an indicator indicating that the cell group is to be suspended or deactivated (for example, Cellgroup (SCG) suspension indicator) or an indicator indicating that the cell group is to be resumed (or activated) (for example, Cellgroup (SCG (resumption indicator))
An indicator that triggers a procedure of a corresponding protocol layer device (for example, SDAP layer device of PDCP layer device or RLC layer device or MAC layer device) according to the indicator indicating the state of a cell group (for example, a PDCP reestablishment indicator or a PDCP data restoration indicator or an indicator that triggers a new procedure or an RLC reestablishment indicator or a MAC layer reset indicator or a MAC layer device partial reset indicator)

If an indicator indicating that a cell group is to be suspended (or deactivated), second DRX configuration information (for example, monitoring interval or on-duration length or cycle or offset or the like) may be configured such that the PSCell of the cell group can perform PDCCH monitoring with a substantially long cycle. For example, upon receiving the indicator indicating that the cell group is to be suspended, the UE may apply the second DRX configuration information and thus perform PDCCH monitoring based on a substantially long cycle, thereby saving UE power. As another method, upon receiving the indicator indicating that the cell group is to be suspended, the UE may apply BWP configuration information regarding the PSCell of the cell group so as to activate or switch the downlink BWP of the PSCell of the cell group to a dormant BWP, and may perform the UE operation in a cell having an activated dormant BWP proposed in the disclosure. In addition, upon receiving the indicator indicating that the cell group is to be suspended, the UE may deactivate all SCells configured in the cell group. As another method, upon receiving the indicator indicating that the cell group is to be suspended, the UE may activate or switch the downlink BWP to a dormant BWP with regard to a SCell having a configured dormant BWP, among the SCells configure in the cell group, and may perform the UE operation in a cell having an activated dormant BWP proposed in the disclosure, or may deactivate SCells having no configured dormant BWP. As another method, upon receiving an indicator indicating that a cell group is to be suspended through the RRC message, the UE may activate or deactivate or hibernate each SCell, or may activate the dormant BWP, according to configuration information or indicator regarding each SCell of the cell group included in the RRC message. Alternatively, before or after receiving the indicator indicating that a cell group is to be suspended, the UE may activate or deactivate or hibernate each SCell of the cell group, or may activate the dormant BWP, according to an indicator (for example, bitmap) of the PDCCH or MAC control element or RRC message.
Configuration information regarding a transmission resource to perform channel measurement and to report the measurement result in a dormant BWP or in a BWP other than the dormant BWP (for example, PUCCH transmission resource information of the PCell or PUCCH SCell or PSCell)
If an indicator indicating that the state of a cell group is to be resumed (or activated) is included, first DRX configuration (for example, monitoring interval or on-duration length or cycle or offset or the like) may be configured such that the PScell of the cell group can perform PDCCH monitoring again. Alternatively, first DRX configuration information stored with regard to the cell group may be restored and applied. For example, upon receiving the indicator indicating that a cell group is to be resumed, the UE may apply the first DRX configuration information stored therein or received from the RRC message and may perform PDCCH monitoring, thereby resuming data transmission or reception. As another method, upon receiving the indicator indicating that a cell group is to be resumed, the UE may apply BWP configuration information regarding the PSCell of the cell group so as to activate or switch the downlink BWP of the PSCell of the cell group to a BWP other than the dormant BWP (for example, a BWP configured by the RRC message), and may perform the UE operation in a cell having an activated normal BWP (a BWP other than the dormant BWP) proposed in the disclosure. Alternatively, upon receiving the indicator indicating that a cell group is to be resumed, the UE may apply random access configuration information (random access transmission resource information (time or frequency transmission resource) for preamble transmission or designated preamble information or the like) so as to trigger a random access procedure in the PSCell of the cell group. As another method, when the indicator indicating that a cell group is to be resumed is received, and if the RRC message includes random access configuration information (random access transmission resource information (time or frequency transmission resource) for preamble transmission or designated preamble information or the like), the UE may apply the random access configuration information so as to trigger a random access procedure (for example, contention-free random access) in the PSCell of the cell group. If the RRC message that indicates resumption or activation of a cell group includes no random access configuration information (random access transmission resource information (time or frequency transmission resource) for preamble transmission or designated preamble information or the like), a random access procedure (for example, contention-free random access) may be triggered in the PSCell of the cell group, or a random access procedure (contention-based random access or 2-step random access) may be triggered based on system information. If there is random access configuration information (random access transmission resource information (time or frequency transmission resource) for preamble transmission or designated preamble information or the like) stored in the UE before receiving the indicator indicating that a cell group is to be resumed, the information may be released or discarded. As another method, the UE may perform PDCCH monitoring in the indicated or configured cell group or cell and may trigger and perform a random access procedure as indicated in the PDCCH.

If the indicator indicating that the state of a cell group is to be resumed (or activated) is included, or upon receiving the indicating that a cell group is to be resumed, the UE may activate all SCells configured in the cell group. As another method, upon receiving the indicating that a cell group is to be resumed, the UE may activate or switch the downlink BWP to a BWP other than the dormant BWP (for example, a BWP configured in an RRC message or a first active BWP) with regard to an SCell having a configured dormant BWP among the SCells configured in the cell group, and may perform the UE operation in a cell having an activated BWP other than the dormant BWP proposed in the disclosure, or may activate with regard to an SCell having no configured dormant BWP. As another method, upon receiving the indicating that a cell group is to be resumed in the RRC message, the UE may activate or deactivate or hibernate each SCell, or may activate the dormant BWP, according to configuration information or indicator regarding each SCell of the cell group included in the RRC message. Alternatively, before or after receiving the indicator indicating that a cell group is to be suspended, the UE may activate or deactivate or hibernate each SCell of the cell group, or may activate the dormant BWP, according to an indicator (for example, bitmap) of the PDCCH or MAC control element or RRC message.
An indicator which adds cell group configuration
An indicator which releases cell group configuration
Security configuration information (security key information or security key information for a cell group or additional information (for example, sk-counter))
An indicator which indicates handover or cell group addition or cell group change (for example, ReconfigurationWithSync indicator or mobilitycontrolInfo)
First channel measurement configuration information for each cell or each BWP
Second channel measurement configuration information for each cell or each BWP
An indicator (ReconfigurationWithSync) (or a newly defined indicator) which indicates cell group configuration or cell group change or an indicator (ReconfigurationWithSync) which indicates a random access procedure
An indicator (ReconfigurationWithSync) (or a newly defined indicator) which indicates whether to activate a cell group by performing a random access procedure when activating the cell group or to activate the cell group without the random access procedure
Radio resource management (RRM) configuration information or frequency measurement configuration information or separate radio resource management (RRM) configuration information or frequency measurement configuration information (for example, frequency measurement configuration information simplified for battery saving (reduced or relaxed RRM configuration information) which is to be applied or performed when a cell group is deactivated
Configuration information for radio link monitoring (RLM) or configuration information for RLM to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the RLM procedure is to be performed. As another method, when the cell group state is a deactivated state, the UE may perform the RLM procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the RLM procedure in the BWP activated last (or previously) before the cell group state is deactivated, thereby maintaining the state of connection to the cell group (for example, if there is no BWP configuration information configured to indicate in what BWP the RLM procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the RLM procedure is to be performed when the cell group is activated, the RLM procedure may be performed in the BWP activated last (or previously). In addition, the configuration information may include beam-related configuration information (which, for example, may be indicated by a BWP identifier or TCI state or QCL configuration information) which indicates in what beam the RLM procedure is to be performed. As another method, when the cell group state is a deactivated state, the UE may perform the RLM procedure in a beam (for example, TCI state or QCL configuration information) configured in the RRC message, or may activate the beam and perform the RLM procedure, and may early monitor the beam to be activated when the cell group is activated, thereby minimizing cell group activation delay. As another method, when the cell group state is configured as a deactivated (or activated) state, the UE may perform the RLM procedure in the beam activated last (or previously) before the cell group state is deactivated, thereby maintaining the state of connection to the cell group (for example, if there is no beam-related configuration information configured to indicate in what beam the RLM procedure is to be performed), or the UE may perform an activation procedure in the beam configured in the RRC message, when the cell group is activated. If there is no beam-related configuration information configured to indicate in what beam the RLM procedure is to be performed when the cell group is activated, the RLM procedure may be performed in the beam activated last (or previously).
Configuration information for a beam failure detection (BFD) procedure or configuration information for a BFD to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the BFD procedure is to be performed. As another method, when the cell group state is a deactivated state, the UE may perform the BFD procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the BFD procedure in the BWP activated last (or previously) before the cell group state is deactivated, thereby maintaining the state of connection to the cell group (for example, if there is no BWP configuration information configured to indicate in what BWP the BFD procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the BFD procedure is to be performed when the cell group is activated, the BFD procedure may be performed in the BWP activated last (or previously). In addition, the configuration information may include beam-related configuration information (which, for example, may be indicated by a BWP identifier or TCI state or QCL configuration information) which indicates in what beam the BFD procedure is to be performed. As another method, when the cell group state is a deactivated state, the UE may perform the BFD procedure in a beam (for example, TCI state or QCL configuration information) configured in the RRC message, and may thus early monitor the beam to be activated when the cell group is activated, thereby minimizing cell group activation delay. As another method, when the cell group state is configured as a deactivated (or activated) state, the UE may perform the BFD procedure in the beam activated last (or previously) before the cell group state is deactivated, thereby maintaining the state of connection to the cell group (for example, if there is no beam-related configuration information configured to indicate in what beam the BFD procedure is to be performed), or the UE may perform an activation procedure in the beam configured in the RRC message, when the cell group is activated. If there is no beam-related configuration information configured to indicate in what beam the BFD procedure is to be performed when the cell group is activated, the BFD procedure may be performed in the beam activated last (or previously).
In the message, a first timer (for example, T304) or a second timer (for example, T310) or a third timer (for example, T312) or a fourth timer (for example, a timer for fallback) may be introduced to efficiently perform a dual connectivity configuration procedure (or SCG configuration procedure) or a handover procedure, and may be configured in the message. It is proposed that the timers be driven and applied in the dual connectivity configuration procedure or handover procedure. The first timer (for example, T304) is a timer for determining whether the dual connectivity configuration procedure or handover procedure has been successfully performed, the second timer (for example, T310) is a timer for determining whether the radio link is valid, and the third timer (for example, T312) is an auxiliary timer for determining whether the radio link is valid, triggering a frequency measurement procedure, and reporting the frequency measurement result. The fourth timer (for example, a timer for fallback) is a timer for attempting to activate a cell group by performing a procedure of fallback to a random access procedure (normal random access procedure (four-step random access procedure or two-step random access procedure) in the case of a failure to activate a cell group (SCG or PSCell) (that is, if the timer expires) without the random access procedure proposed in the disclosure. The fourth timer may be the first timer, and the first timer may be used as the timer for fallback.
In addition, the message may include configuration information (for example, a timer value regarding the fifth timer) regarding the fifth timer (T316) for the following procedure: if a UE having dual connectivity configured thereof detected a radio link failure regarding the MCG, but if the radio link regarding the SCG is valid (or if no radio link failure has been detected), the radio link failure regarding the MCG is reported to the SCG by a split SRB (for example, split SRB1) or SRB3, or the SCG informs the MCG of the radio link failure regarding the MCG of the UE such that the radio link regarding the MCG can be quickly restored. The description that the fifth timer (T316) is configured may indicate that the MCG failure recovery function is configured for the UE having dual connectivity configured therefor.

It is proposed that, if the RRC message (for example, RRCReconfiguration message) includes an indicator for suspending (or deactivating) a cell group, an indicator (for example, ReconfigurationWithSync indicator or mobilitycontrolInfo indicator) which indicates a handover or cell group addition or cell group change will not be included, and if the RRC message includes an indicator for resuming the cell group or configuration information for configuring the same, an indicator (for example, ReconfigurationWithSync indicator or mobilitycontrolInfo indicator) which indicates a handover or cell group addition or cell group change will be included. This is because, when a cell group is resumed, connection to the cell group need to be performed again, and a random access procedure thus needs to be performed for synchronization or to receive system information or if necessary. For example, when the base station configures the UE's cell group in a deactivated state through an RRC message, restrictions may be imposed such that the cell group addition indicator or cell group change indicator or an indicator indicating a random access procedure or an ReconfigurationWithSync indicator cannot be configured together such that the UE does not perform an unnecessary synchronization procedure or connection procedure or random access procedure.

In addition, the RRC message (RRCSetup message or RRCResume message 1f-25 or RRCReconfiguration message 1f-70) may include configuration information for a cell group. The configuration information for a cell group may include some or multiple pieces among the following pieces of information, or may include information for adding or changing or releasing each cell group. For example, the message may include configuration information for a handover or PCell change or conditional handover or conditional PCell change or SCG change (or addition or release) or PSCell change (or addition or release) or conditional PSCell change (or addition or release).
The message may include configuration information for a new target cell or cell group for a handover, and an indicator (for example, reconfigurationWithSync) may be configured to indicate a handover or cell change (or cell group change).
If the message indicated conditional reconfiguration (for example, conditional handover or conditional PCell change or conditional PSCell change (or additional or release) or conditional SCG change (or additional or release)), the message may include configuration information (conditionalReconfiguration) for conditional reconfiguration.
   The conditional reconfiguration information (conditionalReconfiguration) may include an indicator (attemptCondReconfig) indicating whether the conditional reconfiguration procedure will be allowed to be performed again, if conditional reconfiguration (conditional handover or conditional PCell change or conditional PSCell change (or additional or release) or conditional SCG change (or additional or release)) has failed, and if the cell found first through a cell selection or reselection procedure is one or target candidate cells included in the conditional reconfiguration information.
   The conditional reconfiguration information (conditionalReconfiguration) may include list information (condReconfigToRelease) which releases multiple pieces of conditional reconfiguration information.
   The conditional reconfiguration information (conditionalReconfiguration) may include conditional reconfiguration list information (condReconfigToAddModList), and multiple pieces of conditional reconfiguration information may be added or changed or released.
For example, with regard to each piece of conditional reconfiguration information included in the configuration information, an identifier (condReconfigID) for conditional reconfiguration or conditional execution conditions (condExecutionCond) or reconfiguration information (RRCReconfiguration) for conditional reconfiguration may be included. The identifier (condReconfigID) for conditional reconfiguration is an identifier for distinguishing multiple pieces of conditional reconfiguration information included in the conditional reconfiguration information. In addition, the conditional execution conditions (condExecutionCond) may indicate (or include) information regarding the measurement object or target cell (or frequency) to be measured by the UE, or may indicate (or include) conditions for measuring the measurement object or target cell (or frequency) and selecting (or executing) a cell (or frequency) as the target cell (or frequency), or the conditions may indicate (or include) selection conditions such as whether the strength of a measured signal is higher or lower than a specific value (value configured by the RRC message), or signal strength volatility, or the time during which the signal strength is maintained, or the difference in signal strength from the serving cell. In addition, the reconfiguration information (RRCReconfiguration) for conditional reconfiguration may include cell group (or cell) configuration information which is to be applied to a determined target cell (or frequency) if one target cell (or frequency) is determined from the multiple pieces of conditional configuration information, or bearer configuration information (for example, PHY layer device or MAC layer device or RLC layer device or PDCP layer device or SDAP layer device related configuration information), or security configuration information.

Next, the disclosure newly proposes a dormant BWP in a next-generation mobile communication system, and specifically proposes UE operations in each BWP when each BWP is transitioned or switched.

FIG. 1G illustrates a bandwidth part-specific state transition or bandwidth part switching procedure according to an embodiment of the disclosure.

As in FIG. 1G, the BWP of each cell (for example, SCell or PSCell) of each cell group of a UE may be activated to be a normal BWP (1g-01), or activated as a dormant BWP (1g-02), or deactivated (1g-03). In addition, the normal BWP or dormant BWP may be activated or deactivated as indicated by RRC message configuration information or MAC control element or DCI of PDCCH.

The operation of transitioning the state (activation or deactivation or hibernation) for each BWP of a cell proposed in the disclosure, or the operation of activating a normal BWP or activating a dormant BWP or activating a first active BWP activated from dormancy or deactivating the normal or dormant BWP may be performed by indicating or configurating one of the following cases:
If a cell's BWP state is configured by an RRC message, or if each cell's BWP is configured by the RRC message, and if a dormant BWP is configured for the cell, or if the first active BWP is configured as a dormant BWP, the cell may be started by switching or activating the dormant BWP, and operations in the dormant BWP may be performed.
If cell activation or deactivation or dormant MAC CE is received.
If MAC CE instructing the first active BWP or dormant BWP to be activated or deactivated from the normal BWP or dormancy is received.
If DCI of PDCCH instructing the first active BWP or dormant BWP to be activated or deactivated from the normal BWP or dormancy is received.
If no cell hibernation timer is configured for an active cell, and if the configured cell deactivation timer has expired.
If no BWP hibernation timer is configured for an active cell, and if the configured BWP inactivity timer (for example, bwpInactivityTimer) has expired.

In addition, the state transition operation or dormant BWP operating method proposed in the disclosure may have the following characteristics:
No BWP can be configured in the Spcell (Pcell or Pscell) (or the cell's downlink BWP or uplink BWP), and only a normal BWP is configured and is always activated. In the Spcell, major control signals are transmitted/received with synchronization, and if the BWP of the Spcell is hibernated or deactivated, or operated as a dormant BWP, connection to the base station is broken, and the same thus needs to remain activated always.
If a PUCCH is configured even in the case of a BWP of the Scell or SCell, no dormant state or dormant BWP can be configured. There may be other cells which need to send feedback such as HARQ ACK/NACK through the PUCCH, and the activated state, or a normal BWP needs to be activated and used.
Due to the above-mentioned characteristics, the cell inactivity timer (ScellDeactivationTimer) or BWP hibernation timer is not applied to the Spcell or the BWP of the Spcell and the SCell having a configured PUCCH or the BWP of the SCell, and may be driven with regard to other Scells only.
The cell or BWP hibernation timer (ScellHibernationTimer) is prioritized over the cell or BWP state deactivation timer (ScellDeactivationTimer). In addition, if one timer value is configured by the RRC message, the same value may be applied to all cells. As another method, Scell-specific or BWP-specific characteristics may be considered to use different timer values for respective Scells or BWPs.
A cell or BWP initially operates in a deactivated state, by default, unless activation or hibernation is indicated in an RRC message.

In the disclosure, the uplink may indicate an uplink BWP, and the downlink may indicate a downlink BWP. This is because only one activated or hibernated BWP can be operated with regard to each uplink or downlink.

The disclosure is characterized in that an activated state or a deactivated state or a dormant state is operated and, when a cell or BWP performs transition or switching, the same is performed at the BWP level, and is characterized in that, when state transition or switching occurs at the BWP level, the BWP (downlink BWP or uplink BWP) to which state transition or switching is indicated performs state transition or switching according to the state transition or switching indication. For example, if a BWP (downlink BWP or uplink BWP) transitions from an activated state to a dormant state or switches (or is activated) to a dormant BWP, the BWP may be transitioned to a dormant state or switched (or activated) to a dormant BWP.

As used herein, BWP switching means that, when BWP switching is indicated by DCI of the PDCCH, and if the switching is indicated by a BWP identifier while allocating a downlink assignment, the downlink BWP is switched to the BWP indicated by the BWP identifier, and when BWP switching is indicated by DCI of the PDCCH, and if the switching is indicated by a BWP identifier while allocating a UL grant, the uplink BWP is switched to the BWP indicated by the BWP identifier. In addition, the PDCCH's DCI format is different between the format (format1) for the downlink assignment and the format (format0) for the UL grant, and UE operations may thus operate according to the DCI format, even if the uplink and downlink are separately described.

The method for operating state transition at the bandwidth part level proposed in the disclosure, and operations of bandwidth parts according to respective states, may be expanded and applied in various embodiments. Specific embodiments in which the proposal of the disclosure is expanded and applied will hereinafter be described.

FIG. 1H illustrates a DRX configurating or DRX operating method which can save a UE's battery according to an embodiment of the disclosure.

In FIG. 1H, the base station may configure a DRX function, such as a DRX cycle or starting point or offset or on-duration (active time), for a PCell or SCell or PSCell through an RRC message as in FIG. 1F. It is considered in the disclosure that the DRX function is configured for the PCell or SCell or PSCell.

After the DRX function is configured for the PCell (or SpCell or PSCell) as described above, the UE may apply the DRX function in consideration of the DRX cycle 1h-03 and the DRX starting time or offset. When the DRX function is applied, the UE may monitor a PDCCH which can be received from the base station in the PCell only during the on-duration (or active time) 1h-01 of the DRX, or the DCI of the PDCCH. In addition, the UE may not monitor the PDCCH or the DCI of the PDCCH outside the active time 1h-02 of the DRX function, thereby reducing the UE's battery consumption.

In FIG. 1F, the base station may configure a power saving function for the UE through an RRC message in order to further improve the UE's battery consumption reduction. If the power saving function is configured together with the DRX function, the UE monitors the PDCCH outside the active time during a short time interval 1h-04 configured by the RRC before the active time 1h-01 during which the UE needs to monitor the PDCCH according to the DRX function, and monitors and receives a wakeup signal (WUS) outside the active time. The bit of DCI of the PDCCH of the WUS signal may be used by the base station to indicate whether the UE has to perform PDCCH monitoring at the next active time 1h-05, 1h-07 or does not have to perform PDCCH monitoring.

That is, the UE for which the power saving function or DRX function is configured monitors the WUS signal during a short time interval 1h-04, 1h-06 configured by the RRC message before each active time 1h-05, 1h-07. If the value of bit of DCI of the PDCCH regarding the next active time 1h-05, 1h-07 in the received WUS signal has 0 (or 1) (1h-06), the UE may be instructed not to monitor the PDCCH during the next active time 1h-07, or a timer corresponding to the next active time may not be driven by the MAC layer device, thereby instructing the UE not to monitor the PDCCH. If the value of bit of DCI of the PDCCH regarding the next active time 1h-05, 1h-07 in the received WUS signal has 1 (or 0) (1h-04), the UE may be instructed to monitor the PDCCH during the next active time 1h-05, or a timer corresponding to the next active time may be driven by the MAC layer device, thereby instructing the UE to monitor the PDCCH.

In addition, the UE may not monitor WUS signals or the PDCCH for detecting WUS signals during the active time.

In addition, the UE for which the power saving function or DRX function is configured may detect signals by identifying the PDCCH with a first RNTI identifier (for example, PS-RNTI) when monitoring WUS signals during the short time interval 1h-04 configured in the RRC message before each active time 1h-05. The first RNTI identifier (for example, PS-RNTI) may be configured for multiple UEs, and the base station may use the first RNTI identifier (for example, PS-RNTI) to unilaterally instruct the multiple UEs whether or not to monitor the PDCCH during the next active time.

In addition, the UE for which the power saving function or DRX function is configured may detect signals, based on a second RNTI (for example, C-RNTI) or a third RNTI (for example, MCS-C-RNTI) or a fourth RNTI (for example, (SPS-C-RNTI or CS-RNTI) when monitoring and detecting the PDCCH during the active time 1h-05. The second RNTI (for example, C-RNTI) may be used to indicate a normal UE's scheduling, the third RNTI (for example, MCS-C-RNTI) may be used to indicate the UE's modulation and coding scheme, and the fourth RNTI (for example, (SPS-C-RNTI or CS-RNTI) may be used to indicate the UE's periodic transmission resource.

Based on the method proposed in FIG. 1H, the base station may indicate, through the DCI of the PDCCH, that the UE's cell or cell group's state is to be activated or deactivated or hibernated during the active time 1h-05 or the short time interval 1h-04 configured in the RRC message. In addition, the UE may perform a PDCCH monitoring procedure to receive an indication regarding the cell or cell group's state during the active time 1h-05 or the short time interval 1h-04 configured in the RRC message. If the dual connectivity is configured for the UE, the UE may monitor the PDCCH during the active time 1h-05 or the short time interval 1h-04 configured in the RRC message, in the PCell of the MCG, the DCI of the PDCCH may receive an indication regarding activation or deactivation or hibernation with regard to the cell (SCell) of the MCG or the PSCell (or SCell) of the SCG, and the UE may perform a corresponding cell (or BWP) activation procedure or deactivation procedure or hibernation procedure or BWP switching procedure. That is, the base station may indicate, through the DCI of the PDCCH, an activate or deactivated or hibernated state to the UE with regard to the cell (SCell) of the MCG or the PSCell (or SCell) of the SCG during the active time 1h-05 or the short time interval 1h-04 configured in the RRC message, in the PCell of the MCG.

FIG. 1I illustrates the concept of a method for operating a dormant BWP in an activated SCell or PSCell according to an embodiment of the disclosure.

As in FIG. 1F, the base station may configure multiple SCells for the UE through an RRC message for the sake of carrier aggregation, may allocate each SCell identifier, may configure a dormant BWP with regard to each SCell. Alternatively, the base station may configure multiple cell groups for the sake of dual connectivity, may allocate cell group identifiers, may configure or indicate a cell group suspension indicator with regard to each cell group or the PSCell of each cell group, or may configure a dormant BWP. In addition, the multiple SCells may be configured to be included in each SCell group, and one SCell group may include multiple SCells. An SCell group identifier may be allocated to each SCell group, and multiple SCell identifiers may be configured to be included in or mapped to each SCell group identifier. The Scell identifier value or SCell group identifier value may have a predetermined bit value allocated thereto, and may have an integer value (or natural number value). In addition, the PSCell of each cell group may be indicated by a cell group identifier.

In FIG. 1I, the base station may define a new bitmap for the DCI of the PDCCH transmitted in the PCell, may map each bit value of the bitmap so as to indicate each SCell identifier value or each SCell group identifier value or a cell group (or secondary cell group) identifier or the PSCell (or SCell) of the cell group (or secondary cell group), and may define each bit value so as to indicate whether to switch to a dormant BWP or to activate the dormant BWP or to suspend the cell group or to resume the cell group with regard to the SCell corresponding to the bit or SCells belonging to the SCell group or the cell group (or secondary cell group) or the PSCell (or SCell) of the cell group (or secondary cell group). In addition, it may be indicated whether to switch from a dormant BWP to a normal BWP (for example, a first active BWP activated from dormancy) or to activate the normal BWP (for example, a first active BWP activated from dormancy) with regard to the SCell corresponding to the bit or SCells belonging to the SCell group or the cell group (or secondary cell group) or the PSCell (or SCell) of the cell group (or secondary cell group).

In FIG. 1I, the UE may receive DCI of the PDCH (1i-05) in the PCell 1i-01, may read the DCI to identify whether the same has a bitmap including an indication regarding the BWP of the SCell or SCell groups (for example, switch to or activate a dormant BWP or switch to or activate a normal BWP) or an instruction to suspend or resume a cell group (or secondary cell group) or the PSCell (or SCell) of the cell group (or secondary cell group). If the bitmap exists, the BWP may be switched or activated, or the cell group may be suspended or resumed, according to the bit value, with regard to the SCell indicated by each bit of the bitmap, or SCells 1i-02, 1i-03 belonging to the SCell group, or the cell group (or secondary cell group), or the PSCell (or SCell) of the cell group (or secondary cell group). For example, if the bit of the bitmap indicates a first SCell (or first SCell identifier) 1i-02 or a cell group (or secondary cell group) or the PSCell (or SCell) of the cell group (or secondary cell group), or indicates an SCell group (or SCell group identifier) including the first SCell, and if the bit value is 0 (or 1), the UE may then activate the BWP 1i-21 into a dormant BWP 1i-22 with regard to the first SCell 1i-02 or the cell group (or secondary cell group) or the PSCell (or SCell) of the cell group (or secondary cell group), or may switch the current BWP 1i-21 to a dormant BWP 1i-22. Alternatively, if the current BWP is not a dormant BWP, the UE may switch or activate the current activated BWP 1i-21 to a dormant BWP 1i-22 (1i-25), or may suspend or deactivate the cell group. As another method, the BWP of the cell group (or secondary cell group) or the PSCell (or SCell) of the cell group (or secondary cell group) may be maintained unchanged, and the second DRX configuration information or second SRS configuration information proposed in the disclosure may be applied, and PDCCH monitoring or SRS transmission may be performed at a long cycle, thereby reducing the UE's power consumption.

In FIG. 1I, the UE may receive DCI of the PDCH in the PCell 1i-01, may read the DCI to identify whether the same has a bitmap including an indication regarding the BWP of the SCell or SCell groups (for example, switch to or activate a dormant BWP or switch to or activate a normal BWP) or an instruction to suspend or resume a cell group (or secondary cell group) or the PSCell (or SCell) of the cell group (or secondary cell group). If the bitmap exists, the BWP may be switched or activated, or the cell group may be suspended or resumed, according to the bit value, with regard to the SCell indicated by each bit of the bitmap, or SCells 1i-02, 1i-03 belonging to the SCell group, or the cell group (or secondary cell group), or the PSCell (or SCell) of the cell group (or secondary cell group). For example, if the bit of the bitmap indicates a second SCell (or second SCell identifier) 1i-03 or indicates an SCell group (or SCell group identifier) including the second SCell or a cell group (or secondary cell group) or the PSCell (or SCell) of the cell group (or secondary cell group), and if the bit value is 1 (or 0), the UE may then switch or activate (1i-35) the BWP of the second SCell 1i-03 to a BWP configured by the RRC message (for example, a first active BWP 1i-33 activated from dormancy) or may resume or active the cell group, if the current activated BWP is a dormant BWP 1i-32 with regard to the second SCell 1i-03, or if the current activated BWP is not a normal BWP, or if the current BWP (or cell) is activated, and if the current BWP is activated as a dormant BWP 1i-32 (or activated as a BWP which is not a normal BWP). If the bit value is 1 (or 0) such that the SCell indicated by the bit or SCells belonging to the SCell group or the cell group (or secondary cell group) or the PSCell (or SCell) of the cell group (or secondary cell group) needs to be switched or activated to a BWP which is not a dormant BWP, or the cell group needs to be resumed, the bit value may not be applied or may be ignored or may not be read in the case of the SCell or respective SCells belonging to the SCell group, if the state of the SCell is a deactivated state, or if the state of the SCell is an activated state, and if the activated BWP is not a dormant BWP (or if the same is a normal BWP). Alternatively, if the cell group (or secondary cell group) or the PSCell (or SCell) of the cell group (or secondary cell group) is already in an activated state or resumed state, the bit value may not be applied, or may be ignored, or may not be read. In addition, if the bit value is 0 (or 1) such that the SCell indicated by the bit or SCells belonging to the SCell group or the cell group (or secondary cell group) or the PSCell (or SCell) of the cell group (or secondary cell group) needs to be switched or activated to a dormant BWP, or the cell group needs to be suspended, the bit value may not be applied or may be ignored or may not be read in the case of the SCell or respective SCells belonging to the Scell group, if the state of the SCell is an activated state, and if the activated BWP is a dormant BWP. Alternatively, if the cell group (or secondary cell group) or the PSCell (or SCell) of the cell group (or secondary cell group) is already in suspended state or deactivated state, the bit value may not be applied, or may be ignored, or may not be read.

Next, the disclosure proposes methods in which, when a cell (SCell or PSCell or SCell) is activated, the cell can be quickly activated.

Specifically, the base station may use an RRC message (RRCReconfiguration or RRCResume) to configure first channel measurement configuration information such that, when the UE activates a cell, the channel can be quickly measured and reported. The first channel measurement configuration information may include, in order to quickly activate the cell or cell group, configuration information, such as the cycle regarding a frequent channel measurement signal (for example, radios resource or temporary reference signal (TRS) or synchronization signal block (SSB) or channel state information reference signal (CSI-RS) or reference signal (RS)) such that the base station can temporarily transmit a channel measurement signal a lot or often such that channel measurement can be quickly performed in the cell in configuration information of a cell (for example, Pcell or PSCell or SCell) of the cell group, or transmitted transmission resource information (frequency or time transmission resource used to transmit the frequent channel measurement signal) or an interval or the number of times (the number of times the frequent channel measurement signal is transmitted) or a timer value (the time during which the frequent channel measurement signal is transmitted) or a time interval (interval in which the frequent channel measurement signal is transmitted (for example, offset of time unit (slot or subframe or symbol or the like) or a transmission resource or cycle or interval or timing or offset by which the UE needs to report the measurement report. The first channel measurement configuration information may be characterized by configuring a short reporting cycle (or transmission resource) at which the UE can report the channel measurement result, or configuring a transmission resource for channel measurement such that the base station can transmit many channel measurement signals (or transmission resources (for example, radio resources or temporary reference signals (TRS)) a lot or frequently in order for the base station to support the UE's quick channel measurement or many signal measurements. The first channel measurement configuration information may include configuration information regarding a channel measurement signal for a specific UE (or UEs) in the cell or BWP used by the base station. In addition, the first channel measurement configuration information may be configured differently with regard to multiple cells or BWPs configured in the RRC message or for each cell or each BWP, and beam-related configuration information (transmission configuration indication (TCI) state or quasi co-location (QCL)) such as the beam direction or beam number or beam location may be configured together such that the UE can easily measure transmission resources for channel measurement. In addition, the first channel measurement configuration information may be used to configure a timing advance (TA) value (or offset value) for synchronizing the base station's downlink signal or the base station's uplink signal, or a time alignment timer (TAT) indicating the validity of the TA value, or a TAT value such that correct channel measurement or channel measurement reporting can be performed. For example, the first channel measurement configuration information may include the cycle of the channel measurement signal or the number of transmitted signals or an offset regarding the period of time during which signals are transmitted or the time at which signals are transmitted or the time length between transmitted signals or a list of multiple transmittable channel measurement signals or time transmission resources (or frequency transmission resources) indicating the location of transmitted signals or transmission resources (time transmission resources or frequency transmission resources) to be used to report measurement results or the measurement result reporting cycle or configuration information (transmission configuration indication (TCI) state or quasi co-location (QCL)) regarding beams for measuring the channel measurement signals. In addition, the first channel measurement configuration information configured by an RRC message may include multiple pieces of channel measurement signal information, and the RRC message or MAC CE or DCI may be used to indicate a specific piece of channel measurement signal information among the configured multiple pieces of channel measurement signal information, or beam configuration information such that the UE can perform channel measurement or perform channel measurement reporting by applying or using the indicated channel measurement signal information or beam configuration information. According to the method of indication, mapping between a bitmap or an index or an identifier and each piece of channel measurement signal information configured above may be defined, and an indication is made based thereon. As another method, the RRC message or MAC CE may be used to configure or indicate channel measurement signal information such that the UE can perform channel measurement or perform channel measurement reporting by applying or using the configured (or indicated) channel measurement signal information.

As another method, when the RRC message includes first channel measurement configuration information, which is configured for the UE, and if the cell state is configured as an activated state in the RRC message such that cell activation is indicated by the RRC message, the first channel measurement configuration information may be applied or used to quickly measure or report the channel, thereby quickly activating the cell. For example, first channel measurement configuration information or channel measurement signal information or beam-related configuration information, which may be applied when the cell state is configured as an activated state in the RRC message such that cell activation is indicated by the RRC message, may be configured as separate configuration information in the RRC message (default configuration or channel measurement signal information (or beam-related configuration information) corresponding to identifier 0 or one piece of channel measurement signal information (or beam-related configuration information) is solely configured, that channel measurement signal information (or beam-related configuration information) is applied).

The first channel measurement configuration information proposed in the disclosure may be characterized in that the same can be configured with regard to only downlink BWP configuration information of each cell. That is, the first channel measurement configuration information proposed in the disclosure may not be configured with regard to uplink BWP configuration information of each cell. This is because the UE needs to measure the downlink channel first such that the UE then can report the measurement result regarding the channel or cell, correctly receive the PDCCH, and follow the base station's instruction.

The first channel measurement configuration information proposed in the disclosure may be characterized in that the same is initially deactivated when configured by an RRC message or after a handover, and may be activated by a MAC control element proposed in the disclosure later, or DCI information of the PDCCH, or the RRC message. When configured by the RRC message as described above, the initial state needs to be deactivated such that the base station can easily manage the UE's cell state or the channel measurement performing procedure, and the UE can be accurately timed regarding when and how channel measurement is to be performed, without the processing delay problem of the RRC message.

In addition, second channel measurement signal information may be included or configured in the RRC message (RRCReconfiguration or RRCResume). The second channel measurement signal information may include normal channel measurement configuration information such as the transmission resource or cycle or time interval or number of channel measurement signals, or the transmission resource or cycle or time interval for channel measurement reporting.

Next, the disclosure proposes the structure of a MAC control element and a method for indicating the same, wherein, when first or second channel measurement configuration information is configured for the UE through an RRC message as proposed above, the channel can be quickly measured based on the first channel measurement configuration information while activating the cell, or the measurement result can be reported, and the cell can be quickly measured. For example, the MAC control element (or RRC message) proposed in the disclosure may indicate which cell among multiple cells (SCells) configured by the RRC is to be activated or deactivated. Alternatively, if a cell is to be activated as indicated, the MAC control element (or RRC message) may indicate which measurement signal information among the first channel measurement configuration information configured by the RRC message is to be applied, how signals are to be measured (for example, how many times signal transmission resources are to be measured, or how many signals will be transmitted, or in what signal interval measurement is to be made, or based on what offset the measurement time interval is to be determined, or at what cycle signals will be measured, or in what transmission resource signals will be measured, or the like may be indicated), how a report will be made (for example, how many times the measurement result will be reported, or in what time interval the measurement result will be reported, or based on what offset the measurement result report transmission resource will be determined, or at what cycle the measurement result will be reported, or in what transmission resource the measurement result will be reported, or the like may be indicated), thereby quickly activating the cell, based on the first channel measurement configuration information configured by the RRC message.

FIG. 1J illustrates an embodiment in which embodiments proposed in the disclosure are expanded and applied to an RRC deactivated mode UE.

In the disclosure, a cell group or a cell may refer to the PCell of a master cell group (MCG) or the SCell of the MCG or the PSCell of a secondary cell group (SCG) or the SCell of the SCG.

It is proposed that SCell configuration information (for example, the configuration information described or proposed with reference to FIG. 1F) configured or stored for the embodiments proposed above as in FIG. 1F in an RRC connected mode in the above embodiment, or PSCell (or SCell) configuration information of the cell group (for example, secondary cell group) will not be released or discarded, but will be continuously stored, even if the UE transitions to an RRC deactivated mode. In addition, it is proposed that the RRC deactivated mode UE will determine whether to discard or release the stored SCell configuration information (for example, the configuration information described or proposed with reference to FIG. 1F) or PSCell (or SCell) configuration information of the cell group (for example, secondary cell group), or to maintain and apply the same, or to perform reconfiguration, through the RRCResume message transmitted by the base station when an RRC connection resumption procedure is performed, or through the indicator of the RRCReconfiguration message, or through a reconfiguration procedure. In addition, when the UE transmits an RRCRelease message including a configuration or an indicator for transitioning the UE to an RRC deactivated mode to the UE, an indicator or configuration information may be included in the RRCRelease message and transmitted to the UE so as to indicate whether to discard or release the stored SCell configuration information (for example, the configuration information described or proposed with reference to FIG. 1F) or PSCell (or SCell) configuration information of the cell group (for example, secondary cell group), or to maintain and apply the same, or to perform reconfiguration. In addition, when the UE moves in the RRC deactivated mode and performs a RAN notification area (RNA) update, the UE may receive and apply the indicator or configuration information which is in the RRCRelease message transmitted to the UE by the base station, and which indicates whether to discard or release the stored SCell configuration information (for example, the configuration information described or proposed with reference to FIG. 1F) or PSCell (or SCell) configuration information of the cell group (for example, secondary cell group), or to maintain and apply the same, or to perform reconfiguration.

In the embodiment proposed by the disclosure, the base station may allow the first active BWP of BWP configuration information of the downlink or uplink of each cell to be configured as a dormant BWP, in the SCell configuration information (for example, the configuration information described or proposed with reference to FIG. 1F) or the RRC message, or the PSCell (or SCell) configuration information of the cell group (for example, secondary cell group) such that, when the UE activates each SCell or each cell group or each cell group's PSCell, the downlink BWP or uplink BWP of each SCell or each cell group or each cell group's PSCell can be instantly operated as a dormant BWP, or the cell group can be suspended or resumed, thereby reducing the UE's battery consumption.

As another method, in the embodiment proposed by the disclosure, the base station may not configure the first active BWP of BWP configuration information of the downlink or uplink of each cell as a dormant BWP in the SCell configuration information (for example, the configuration information described or proposed with reference to FIG. 1F) of the RRC message, or the PSCell (or SCell) configuration information of the cell group (for example, secondary cell group), and when the UE activates or resumes each SCell or each cell group or each cell group's PSCell, the downlink BWP or uplink BWP of each SCell or each cell group or each cell group's PSCell is always activated as a first active BWP, and can be switched or activated to a dormant BWP in the embodiments proposed by the disclosure, or the cell group can be suspended or resumed, thereby reducing the UE's battery consumption.

In addition, in the embodiment proposed by the disclosure, dual connectivity may be expanded and applied to each SCell configuration information or PSCell configuration information of the master cell group (MCG) or secondary cell group (SCG) of the UE for which the same has been configured. That is, the SCG's SCell configuration information or PSCell configuration information may also be stored when the UE transitions to the RRC deactivated mode, and when the RRC connection resumption procedure is performed as above, or when the UE is transitioned to the RRC deactivated mode, an indicator or configuration information may be included in an RRC message (for example, RRCResume or RRCReconfiguration or RRCRelease) and transmitted to the UE so as to indicate whether to discard or release the stored SCell configuration information (for example, the configuration information described or proposed with reference to FIG. 1F) of the MCG or SCG or the PSCell configuration information, or to maintain and apply the same, or to perform reconfiguration.

In FIG. 1J, the UE 1j-01 may establish network connection to the base station 1j-02 and may transmit/receive data (1j-05). If the base station 1j-02 needs to transition the UE 1j-01 to an RRC deactivated mode for a specific reason, the base station 1j-02 may send an RRCRelease message 1j-20 to the UE 1j-01 such that the UE 1j-01 transitions to the RRC deactivated mode. An indicator or configuration information may be included in the RRC message (for example, RRCRelease) and transmitted to the UE 1j-01 so as to indicate whether to discard or release the stored SCell configuration information (for example, the configuration information described or proposed with reference to FIG. 1F) of the MCG or SCG or the PSCell (or SCEll) configuration information of the cell group (for example, secondary cell group), or to maintain and apply the same, or to perform reconfiguration. In the case of a UE 1j-01 to which dual connectivity is applied, in order to determine whether to suspend and resume master cell group bearer configuration or RRC configuration information or MCG or SCG's SCell configuration information, and to determine whether to suspend and resume secondary cell group bearer configuration and RRC configuration information, the base station 1j-02 may inquire the secondary cell base station (not illustrated) whether to suspend or resume the same, and may receive a response and make a determination (1j-15). In addition, the base station 1j-02 may configure the list of frequencies to be measured by the UE 1j-01 in an RRC idle mode or RRC deactivated mode, or frequency measurement configuration information, or the period of time during which frequencies are to be measured, or the like in the RRCRelease message.

The RRC deactivated mode UE 1j-01 may perform an RRC connection resumption procedure upon receiving a paging message 1j-25 while moving, if there is a need to transmit uplink data, or if there is a need to update the RAN notification area.

The UE 1j-01 performs random access procedure if there is a need to configure connection, and transmits an RRCResumeRequest message to the base station 1j-02, and proposed UE operations related to transmission of the message are as follows (1j-30):
1. The UE 1j-01 identifies system information and, if the system information instructs transmission of a complete UE connection resumption identifier (I-RNTI or full resume ID), the UE 1j-01 prepares to include a stored complete UE connection resumption identifier (I-RNTI) in the message and to transmit the same. If the system information instructs transmission of a truncated UE connection resumption identifier (truncated I-RNTI or truncated resume ID), the UE 1j-01 configures a truncated UE connection resumption identifier (truncated resume ID) by truncating the stored complete UE connection resumption identifier (I-RNTI) in a predetermined method, and prepares to include the same in the message and to transmit the same.
2. The UE 1j-01 restores RRC connection configuration information and security context information from stored UE context.
3. In addition, the UE 1j-01 receives a new KgNB security key corresponding to the master cell group, as well as the current KgNB security key and NH (NextHop) value, from the RRCRelease message, and updates the same, based on the stored NCC value.
4. In addition, if the UE 1j-01 received an SCG-counter value (or sk-counter) in the RRCRelease message, the UE 1j-01 updates a new KgNB security key corresponding to the secondary cell group, based on the KgNB security key and the SCG-counter value (or sk-counter).
5. In addition, the UE 1j-01 uses the newly updated KgNB security key to induce new security keys (K_RRCenc, K_RRC_int, K_UPint, K_UPenc) to be used in integrity protection and verification procedures and encryption and decryption procedures.
6. In addition, if the UE 1j-01 received an SCG-counter value (or sk-counter) in the RRCRelease message, the UE 1j-01 uses the newly updated SKgNB security key corresponding to the secondary cell group to induce new security keys (SK_RRCenc, SK_RRC_int, SK_UPint, SK_UPenc) to be used in integrity protection and verification procedures and encryption and decryption procedures.
7. In addition, the UE 1j-01 calculates MAC-I and prepares to include the same in the message and to transmit the same.
8. In addition, the UE 1j-01 resumes SRB1 (an RRCResume message will be received through SRB1 in response to the RRCResumeRequset message to perform transmission, and the same thus needs to be resumed in advance).
9. The UE 1j-01 composes the RRCResumeRequset message and transfers the same to a lower layer device.
10. The UE 1j-01 applies the updated security keys and a previously configured algorithm to all bearers (MCG terminated RBs), excluding the SRB0 belonging to the master cell group, thereby resuming integrity protection and verification procedures, and applies integrity protection and verification to data transmitted and received later. (in order to improve the reliability and security of data transmitted/received from the SRB1 or DRBs later)
11. The UE 1j-01 applies the updated security keys and a previously configured algorithm to all bearers (MCG terminated RBs), excluding the SRB0 belonging to the master cell group, thereby resuming encryption and decryption procedures, and applies encryption and decryption to data transmitted and received later. (in order to improve the reliability and security of data transmitted/received from the SRB1 or DRBs later)
12. if the UE 1j-01 received an SCG-counter value (or sk-counter) in the RRCRelease message, the UE 1j-01 applies the updated security keys and a previously configured algorithm to all bearers (SCG terminated RBs) corresponding to the secondary group, thereby resuming integrity protection and verification procedures, and applies integrity protection and verification to data transmitted and received later. (in order to improve the reliability and security of data transmitted/received from DRBs later)
13. if the UE 1j-01 received an SCG-counter value (or sk-counter) in the RRCRelease message, the UE 1j-01 applies the updated security keys and a previously configured algorithm to all bearers (SCG terminated RBs) corresponding to the secondary group, thereby resuming encryption and decryption procedures, and applies encryption and decryption to data transmitted and received later. (in order to improve the reliability and security of data transmitted/received from DRBs later)

UE operations proposed when the UE 1j-01 performed a random access procedure because a need to configure connection occurred, transmitted an RRCResumeRequest message to the base station, and received an RRCResume message in response thereto, are as follows (1j-35). If the RRCResume message includes an indicator which instructs the UE 1j-01 to make a report if there is a valid frequency measurement result measured in the RRC deactivated mode, the UE 1j-01 may compose the frequency measurement result in the RRCResumeComplete message and report the same (1j-40). In addition, the base station 1j-02 may include an indicator or configuration information in the RRC message (for example, RRCResume) and transmit the same to the UE 1j-01 so as to indicate whether to discard or release the SCell configuration information (for example, the configuration information described or proposed with reference to FIG. 1F) of the MCG or SCG stored by the UE 1j-01, or to maintain and apply the same, or to perform reconfiguration.
1. Upon receiving the message, the UE 1j-01 restores a PDCP state corresponding to the master cell group, resets the COUNT value, and reestablishes PDCP layer devices of all DRBs (MCG terminated RBs) and SRB2 corresponding to the master cell group.
2. If the UE 1j-01 received an SCG-counter value (or sk-counter) in the message, the UE 1j-01 updates a new SKgNB security key corresponding to the secondary cell group, based on the KgNB security key and the SCG-counter value (or sk-counter). In addition, the UE 1j-01 uses the newly updated SKgNB security key corresponding to the secondary cell group to induce new security keys (SK_RRCenc, SK_RRC_int, SK_UPint, SK_UPenc) to be used in integrity protection and verification procedures and encryption and decryption procedures.
3. If the message includes master cell group (masterCellgroup) configuration information
A. The UE 1j-01 performs and applies the master cell group configuration information included in the message. The master cell group configuration information may include configuration information regarding RLC layer devices belonging to the master cell group, logical channel identifiers, bearer identifies, and the like.
4. If the message includes bearer configuration information (radioBearerConfig)
A. The UE 1j-01 performs and applies the bearer configuration information (radioBearerConfig) included in the message. The bearer configuration information (radioBearerConfig) may include configuration information regarding PDCP layer devices regarding respective bearers, configuration information regarding SDAP layer devices, logical channel identifiers, bearer identifies, and the like.
5. If the message includes secondary cell group (masterCellgroup) configuration information
A. The UE 1j-01 performs and applies the secondary cell group configuration information included in the message. The secondary cell group configuration information may include configuration information regarding RLC layer devices belonging to the secondary cell group, logical channel identifiers, bearer identifies, and the like.
6. If the message includes secondary bearer configuration information (radioBearerConfig)
A. The UE 1j-01 performs and applies the secondary bearer configuration information (radioBearerConfig) included in the message. The secondary bearer configuration information (radioBearerConfig) may include configuration information regarding PDCP layer devices regarding respective secondary bearers, configuration information regarding SDAP layer devices, logical channel identifiers, bearer identifies, and the like.
7. The UE 1j-01 resumes all DRBs (MCG terminated RBs) and SRB2 corresponding to the master cell group.
8. If the message includes frequency measurement configuration information (measConfig)
A. The UE 1j-01 performs and applies the frequency measurement configuration information included in the message. That if, frequency measurement may be performed according to the configuration.
9. The UE transitions to an RRC connected mode.
10. The UE 1j-01 informs the upper layer device that suspended RRC connection is resumed.
11. In addition, the UE 1j-01 composes and transfers an RRCResumeComplete message for transmission to the lower layer (1j-40).

If the UE 1j-01 has suspended secondary cell group-related bearer configuration information and UE context information, the UE 1j-01 may perform frequency measurement based on frequency measurement configuration information configured in system information or RRCRelease message or RRCResume message and, if there is a valid result, may include an indicator in the RRCResumeComplete message and transmit the same in order to indicate the existence of the result (1j-40). Upon receiving the indicator, the base station 1j-02 may instruct the UE 1j-01 to report the frequency measurement result (1j-45) if carrier aggregation or dual connectivity needs to be resumed, may receive a report of the frequency measurement result from the UE 1j-01, or may receive a report of the frequency measurement result in the RRCResumeComplete message (1j-50). Upon receiving the frequency measurement result, the base station 1j-02 may inquire the secondary cell base station whether or not to resume suspended secondary cell group-related bearer configuration information, and may make a determination based on a response therefrom. The base station 1j-02 may send an RRCReconfiguration message to the UE 1j-01 to indicate whether secondary cell group-related bearers are to be resumed or released (1j-60). In addition, the base station 1j-02 may include an indicator or configuration information in the RRC message (for example, RRCReconfiguration) and transmit the same to the UE so as to indicate whether to discard or release the SCell configuration information (for example, the configuration information described or proposed with reference to FIG. 1F) of the MCG or SCG stored by the UE 1j-01, or to maintain and apply the same, or to perform reconfiguration.

In the embodiment proposed in FIG. 1J by the disclosure, the base station 1j-02 may allow the first active BWP of BWP configuration information of the downlink or uplink of each cell to be configured as a dormant BWP, in the SCell configuration information (for example, the configuration information described or proposed with reference to FIG. 1F) or the RRC message (for example, RRCRelease or RRCResume or RRCReconfiguartion), or the PSCell (or SCell) configuration information of the cell group (for example, secondary cell group) such that, when the UE 1j-01 activates each SCell or the PSCell of the cell group (for example, secondary cell group), the downlink BWP or uplink BWP of each SCell or the PSCell can be instantly operated as a dormant BWP, or the cell group can be suspended or resumed, thereby reducing the UE's battery consumption. For example, in the case of each SCell or the PSCell, if the SCell state is configured as an activated state in the SCell configuration information or cell group configuration information of the RRC message (for example, RRCRelease or RRCResume or RRCReconfiguartion), or if the cell group state is configured as an activated state or a suspended state or a deactivated state, or if an indication is configured to suspend or resume the cell group, or if an instruction to activate the SCell is received from a MAC control element proposed in the disclosure, the UE 1j-01 may activate or resume or suspend the SCell or PSCell, and may operate a method in which, when the SCell or PSCell is activated, the downlink BWP or uplink BWP of the SCell or PSCell is instantly activated as a dormant BWP, thereby saving the battery of the UE 1j-01.

In addition, when the RRC deactivated mode UE transitioned to an RRC connected mode and restored or applied or reconfigured the SCell configuration information or cell group's (for example, secondary cell group's) PSCell (or SCell) configuration information proposed in the disclosure, switching or activation between BWPs may be performed with regard to each activated SCell or cell group's PSCell (or SCell) according to embodiments proposed in the disclosure, or the dormant BWP may be activated or applied. In addition, the embodiments of the disclosure may be expanded and applied to a case in which a handover is performed as well.

If the UE 1j-01 receives an indicator indicating suspension or resumption or activation or deactivation regarding a cell or a cell group or the cell group's PSCell according to embodiments of the disclosure, the PHY layer device or MAC layer device that received the indication may transfer the indication to the upper layer device (for example, MAC layer device or RLC layer device or PDCP layer device or RRC layer device). Upon receiving the indication (for example, cell group suspension or resumption or activation or deactivation) from the lower layer device, the upper layer device may perform a procedure of a protocol layer device regarding cell group suspension or resumption or activation or deactivation corresponding thereto. Alternatively, if the UE 1j-01 receives an indicator indicating suspension or resumption or activation or deactivation regarding a cell group or the cell group's PSCell through an RRC message as in embodiments of the disclosure, the RRC layer device that received the indication may transfer the indication to the lower layer device (for example, PHY layer device or MAC layer device or RLC layer device or PDCP layer device). Upon receiving the indication (for example, cell group suspension or resumption or activation or deactivation) from the upper layer device (for example, RRC layer device), the lower layer device may perform a procedure of a protocol layer device regarding cell group suspension or resumption or activation or deactivation corresponding thereto.

The embodiments proposed in the disclosure may be combined or expanded to configure and operate various embodiments.

FIG. 1K illustrates a signaling procedure in which dual connectivity is configured or released in a next-generation mobile communication system according to an embodiment of the disclosure, or in which a secondary cell group configured by the dual connectivity is activated or resumed or suspended or deactivated.

A first signaling procedure in which dual connectivity is configured or released, or a secondary cell group configured by the dual connectivity is configured or released or activated or resumed or suspended or deactivated in FIG. 1K is as follows:

In FIG. 1K, the UE may configure RRC connection to a network or a base station as in FIG. 1F of the disclosure, and may transmit or receive data with the base station (for example, master cell group, maser node (MN) or master cell group (MCG) or master cell group's cells (PCell or SCell)).

The base station may configure dual connectivity for the UE for a specific reason (for example, if a high data transmission rate is necessary, or at the UE's request (1k-05), or if a high level of QoS requirement is to be satisfied, or the like). For example, the UE may send a request to the base station to configure or release or release or activate or deactivate or resume or suspend the dual connectivity or a cell group (for example, secondary cell group) or a cell, and the request message may include a frequency (or channel) measurement result report or a cell group identifier or cell identifiers or measurement results (1k-05). As another method, the base station may determine whether to configure or release or add or deactivate or activate or resume or change or reconfigure or suspend the dual connectivity or a cell group (for example, secondary cell group) or a cell in consideration of the amount of downlink (or uplink) data.

The master base station (master node (MN) or master cell group (MCG)) may receive a frequency-specific or channel-related frequency or channel measurement report from the UE, and may configure a secondary base station (secondary node (SN) or secondary cell group (SCG)) for which dual connectivity is to be configured, based on the measurement report. Alternatively, the (master) base station may determine whether to configure or release or add or deactivate or activate or resume or change or reconfigure or suspend the dual connectivity or a cell group (for example, secondary cell group) or a cell in consideration of the amount of downlink (or uplink) data or the amount of buffer. The master base station may transmit a message to the secondary base station through an Xn interface (for example, inter-base station interface) or Sn interface (interface between a base station and an AMF or a UMF or between base stations) so as to request whether the determined secondary base station can be configured or added as the UE's secondary cell group in order to configure or release or add or deactivate or activate or resume or change or reconfigure or suspend the dual connectivity or a cell group (for example, secondary cell group) or a cell (1k-10). In the request message, each separate new request message may be defined and used to configure or release or add or deactivate or activate or resume or change or reconfigure or suspend the dual connectivity or a cell group (for example, secondary cell group) or a cell, with regard to the secondary base station. As another method, in an existing message (for example, SN addition request message or SN modification request message or SN release request message or the like), a new indicator may be defined to instruct (or request) to configure or release or add or deactivate or activate or resume or change or reconfigure or suspend a cell group (for example, secondary cell group) or a cell. The request message may include information such as cell group configuration information (for example, master cell group configuration information) currently configured for the UE or bearer configuration information or UE capability information or the UE's frequency (or channel) measurement result information or the like such that, when the secondary base station configures a secondary cell group for the UE with reference to the above information, secondary cell group configuration information or bearer configuration information can be configured in conformity with UE capability or so as not to exceed UE capability or in conformity with the master cell group's bearer configuration information.

Upon receiving the request message 1k-10, the secondary base station (SCG) may compose a rejection message, if the request message is to be rejected, and may transmit the same to the master base station through an Xn interface (for example, inter-base station interface) or Sn interface (interface between a base station and an AMF or a UMF or between base stations) (1k-15). If the request message is to be accepted, the secondary base station may transmit a request acceptance message to the master base station through the Xn interface (for example, inter-base station interface) or Sn interface (interface between a base station and an AMF or a UMF or between base stations), the request acceptance message including configuration information or indicator to configure or release or add or deactivate or activate or resume or change or reconfigure or suspend the dual connectivity or a cell group (for example, secondary cell group) or a cell (1k-15). The request acceptance message may include some of the following pieces of information:
The same identifier as the message identifier included in the request message, or an indicator indicating that the request in the request message will be accepted
Configuration information or indicator (for example, configuration information or indicator for the master cell group) to configure or release or add or deactivate or activate or resume or change or reconfigure or suspend the dual connectivity or a cell group (for example, secondary cell group) or a cell
First RRC message (for example, RRCReconfiguration message) including configuration information or indicator (for example, configuration information or indicator for the master cell group) to configure or release or add or deactivate or activate or resume or change or reconfigure or suspend the dual connectivity or a cell group (for example, secondary cell group) or a cell
The first RRC message may include some of the following pieces of information:
A first RRC message identifier (for example, rrc-Transaction identifier) for distinguishing the first RRC message. The UE and the base station (for example, secondary base station) transmit or receive multiple RRC messages with each other, and the RRC message may thus include an identifier for distinguishing each RRC message. For example, an RRC message (for example, RRCReconfiguration) transmitted by the transmitting end or an RRC message (for example, RRCReconfigurationComplete) corresponding to the RRC message (for example, RRCReconfiguration) transmitted by the receiving end or an RRC message corresponding to the RRC message transmitted by the transmitting end may include the same first RRC message identifier
Configuration information or indicator (for example, configuration information or indicator for the UE) to configure or release or add or deactivate or activate or resume or change or reconfigure or suspend the dual connectivity or a cell group (for example, secondary cell group) or a cell
An indicator indicating the state of a cell group (for example, activated or deactivated or suspended or resumed)
A cell group identifier for distinguishing cell groups. The cell group identifier may be allocated by the master base station, or one of pre-promised identifiers may be allocated by the secondary base station.)
Cell group or cell configuration information
Bearer configuration information. For example, indicator information indicating operations of a protocol layer device (for example, SDAP layer device or PDCP layer device or RLC layer device or MAC layer device) of each bearer (for example, a PDCP suspension indicator or a PDCP reestablishment indicator or a PDCP data restoration indictor or an RLC reestablishment indicator or a MAC partial reset indicator or a MAC reset indicator or an indicator triggering a new operation)
If configuration information or indicator for configuring or adding or activating or resuming or changing or reconfiguring the dual connectivity or a cell group (for example, secondary cell group) or a cell is included, a first indicator (for example, mobilityControlInfor or ReconfigurationWithSync) may be included together. However, if configuration information or indicator for releasing or deactivating or reconfiguring or suspending the dual connectivity or a cell group (for example, secondary cell group) or a cell is included, the first indicator (for example, mobilityControlInfor or ReconfigurationWithSync) may not be included. The first indicator may be an indicator for triggering a random access procedure by the cell group or cell, or an indicator for synchronizing signals with a new cell, or an indicator indicating the UE's frequency shift, or an indicator indicating the cell group's (or cell's) change.
If configuration information or indicator for configuring or adding or activating or resuming or changing or reconfiguring the dual connectivity or a cell group (for example, secondary cell group) or a cell is included, random access configuration information may be included together. However, if configuration information or indicator for releasing or deactivating or reconfiguring or suspending the dual connectivity or a cell group (for example, secondary cell group) or a cell is included, the random access configuration information may not be included. The random access configuration information may include random access transmission resource information (time or frequency transmission resource) for preamble transmission regarding the cell group or cell, or designated preamble information or the like.
Time information indicating when the dual connectivity or a cell group (for example, secondary cell group) or a cell (PSCell or SCG SCell) is to be activated or resumed or deactivated or suspended (for example, information (for example, X) indicating timing, time unit, subframe or time slot or symbol unit), for example, if the message was received at the n^{th} time unit, time information indicating whether the cell is to be activated or resumed or deactivated or suspended at the (n+X)^{th})
Cell-specific or BWP-specific first channel measurement configuration information
Cell-specific or BWP-specific second channel measurement configuration information
An indicator for adding cell group configuration or an indicator (ReconfigurationWithSync) indicating a cell group change or an indicator (ReconfigurationWithSync or a newly defined indicator) indicating a random access procedure
An indicator (ReconfigurationWithSync or a newly defined indicator) indicating whether to activate a cell group by performing a random access procedure when activating the cell group or to activate the cell group without the random access procedure
Radio resource management (RRM) configuration information or frequency measurement configuration information or separate radio resource management (RRM) configuration information to be applied or performed when a cell group is deactivated, or frequency measurement configuration information (for example, simplified frequency measurement configuration information (for example, reduced or relaxed RRM configuration information) for battery saving)
Configuration information for radio link monitoring (RLM) or configuration information for RLM to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the RLM procedure is to be performed. As another method, when the cell group state is a deactivated state, the UE may perform the RLM procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the RLM procedure in the BWP activated last (or previously) before the cell group state is deactivated, thereby maintaining the state of connection to the cell group (for example, if there is no BWP configuration information configured to indicate in what BWP the RLM procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the RLM procedure is to be performed when the cell group is activated, the RLM procedure may be performed in the BWP activated last (or previously). In addition, the configuration information may include beam-related configuration information (which, for example, may be indicated by a BWP identifier or TCI state or QCL configuration information) which indicates in what beam the RLM procedure is to be performed. As another method, when the cell group state is a deactivated state, the UE may perform the RLM procedure in a beam (for example, TCI state or QCL configuration information) configured in the RRC message, or may activate the beam and perform the RLM procedure, and may early monitor the beam to be activated when the cell group is activated, thereby minimizing cell group activation delay. As another method, when the cell group state is configured as a deactivated (or activated) state, the UE may perform the RLM procedure in the beam activated last (or previously) before the cell group state is deactivated, thereby maintaining the state of connection to the cell group (for example, if there is no beam-related configuration information configured to indicate in what beam the RLM procedure is to be performed), or the UE may perform an activation procedure in the beam configured in the RRC message, when the cell group is activated. If there is no beam-related configuration information configured to indicate in what beam the RLM procedure is to be performed when the cell group is activated, the RLM procedure may be performed in the beam activated last (or previously).
Configuration information for a beam failure detection (BFD) procedure or configuration information for a BFD to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the BFD procedure is to be performed. As another method, when the cell group state is a deactivated state, the UE may perform the BFD procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the BFD procedure in the BWP activated last (or previously) before the cell group state is deactivated, thereby maintaining the state of connection to the cell group (for example, if there is no BWP configuration information configured to indicate in what BWP the BFD procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the BFD procedure is to be performed when the cell group is activated, the BFD procedure may be performed in the BWP activated last (or previously). In addition, the configuration information may include beam-related configuration information (which, for example, may be indicated by a BWP identifier or TCI state or QCL configuration information) which indicates in what beam the BFD procedure is to be performed. As another method, when the cell group state is a deactivated state, the UE may perform the BFD procedure in a beam (for example, TCI state or QCL configuration information) configured in the RRC message, and may thus early monitor the beam to be activated when the cell group is activated, thereby minimizing cell group activation delay. As another method, when the cell group state is configured as a deactivated (or activated) state, the UE may perform the BFD procedure in the beam activated last (or previously) before the cell group state is deactivated, thereby maintaining the state of connection to the cell group (for example, if there is no beam-related configuration information configured to indicate in what beam the BFD procedure is to be performed), or the UE may perform an activation procedure in the beam configured in the RRC message, when the cell group is activated. If there is no beam-related configuration information configured to indicate in what beam the BFD procedure is to be performed when the cell group is activated, the BFD procedure may be performed in the beam activated last (or previously).

Upon receiving a request acceptance message 1k-15 from the secondary base station (SCG, SN), the master base station (MCG, MN) may identify the request acceptance message and may transmit a second RRC message (for example, RRCReconfiguration) including information included in the request acceptance message (for example, first RRC message included in the request acceptance message 1k-15) to the UE (1k-20). The second RRC message may include some of the following pieces of information:
A second RRC message identifier (for example, rrc-Transaction identifier) for distinguishing the second RRC message. The UE and the base station (for example, master base station) transmit or receive multiple RRC messages with each other, and the RRC message may thus include an identifier for distinguishing each RRC message. For example, an RRC message (for example, RRCReconfiguration) transmitted by the transmitting end or an RRC message (for example, RRCReconfigurationComplete) corresponding to the RRC message (for example, RRCReconfiguration) transmitted by the receiving end or an RRC message corresponding to the RRC message transmitted by the transmitting end may include the same second RRC message identifier.
A first RRC message included in the request acceptance message 1k-15
Configuration information or indicator (for example, configuration information or indicator for the UE) to configure or release or add or deactivate or activate or resume or change or reconfigure or suspend the dual connectivity or a cell group (for example, secondary cell group) or a cell
An indicator indicating the state of a cell group (for example, activated or deactivated or suspended or resumed)
A cell group identifier for distinguishing cell groups. The cell group identifier may be allocated by the master base station, or one of pre-promised identifiers may be allocated by the secondary base station.)
Cell group or cell configuration information
Bearer configuration information. For example, indicator information indicating operations of a protocol layer device (for example, SDAP layer device or PDCP layer device or RLC layer device or MAC layer device) of each bearer (for example, a PDCP suspension indicator or a PDCP reestablishment indicator or a PDCP data restoration indictor or an RLC reestablishment indicator or a MAC partial reset indicator or a MAC reset indicator or an indicator triggering a new operation)
If configuration information or indicator for configuring or adding or activating or resuming or changing or reconfiguring the dual connectivity or a cell group (for example, secondary cell group) or a cell is included, a first indicator (for example, mobilityControlInfor or ReconfigurationWithSync) may be included together. However, if configuration information or indicator for releasing or deactivating or reconfiguring or suspending the dual connectivity or a cell group (for example, secondary cell group) or a cell is included, the first indicator (for example, mobilityControlInfor or ReconfigurationWithSync) may not be included. The first indicator may be an indicator for triggering a random access procedure by the cell group or cell, or an indicator for synchronizing signals with a new cell, or an indicator indicating the UE's frequency shift, or an indicator indicating the cell group's (or cell's) change. As another method, the UE may perform PDCCH monitoring in the designated or configured cell group or cell, and may trigger and perform a random access procedure as indicated in the PDCCH. For example, the upper layer device (for example, RRC layer device) may send an indicator for triggering the random access procedure to the lower layer device (for example, MAC layer device).
If configuration information or indicator for configuring or adding or activating or resuming or changing or reconfiguring the dual connectivity or a cell group (for example, secondary cell group) or a cell is included, random access configuration information may be included together. However, if configuration information or indicator for releasing or deactivating or reconfiguring or suspending the dual connectivity or a cell group (for example, secondary cell group) or a cell is included, the random access configuration information may not be included. The random access configuration information may include random access transmission resource information (time or frequency transmission resource) for preamble transmission regarding the cell group or cell, or designated preamble information or the like.
Time information indicating when the dual connectivity or a cell group (for example, secondary cell group) or a cell (PSCell or SCG SCell) is to be activated or resumed or deactivated or suspended (for example, information (for example, X) indicating timing, time unit, subframe or time slot or symbol unit), for example, if the message was received at the n^{th} time unit, time information indicating whether the cell is to be activated or resumed or deactivated or suspended at the (n+X)^{th})
Cell-specific or BWP-specific first channel measurement configuration information
Cell-specific or BWP-specific second channel measurement configuration information
An indicator for adding cell group configuration or an indicator (ReconfigurationWithSync) indicating a cell group change or an indicator (ReconfigurationWithSync or a newly defined indicator) indicating a random access procedure
An indicator (ReconfigurationWithSync or a newly defined indicator) indicating whether to activate a cell group by performing a random access procedure when activating the cell group or to activate the cell group without the random access procedure
Radio resource management (RRM) configuration information or frequency measurement configuration information or separate radio resource management (RRM) configuration information to be applied or performed when a cell group is deactivated, or frequency measurement configuration information (for example, simplified frequency measurement configuration information (for example, reduced or relaxed RRM configuration information) for battery saving)
Configuration information for radio link monitoring (RLM) or configuration information for RLM to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the RLM procedure is to be performed. As another method, when the cell group state is a deactivated state, the UE may perform the RLM procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the RLM procedure in the BWP activated last (or previously) before the cell group state is deactivated, thereby maintaining the state of connection to the cell group (for example, if there is no BWP configuration information configured to indicate in what BWP the RLM procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the RLM procedure is to be performed when the cell group is activated, the RLM procedure may be performed in the BWP activated last (or previously). In addition, the configuration information may include beam-related configuration information (which, for example, may be indicated by a BWP identifier or TCI state or QCL configuration information) which indicates in what beam the RLM procedure is to be performed. As another method, when the cell group state is a deactivated state, the UE may perform the RLM procedure in a beam (for example, TCI state or QCL configuration information) configured in the RRC message, or may activate the beam and perform the RLM procedure, and may early monitor the beam to be activated when the cell group is activated, thereby minimizing cell group activation delay. As another method, when the cell group state is configured as a deactivated (or activated) state, the UE may perform the RLM procedure in the beam activated last (or previously) before the cell group state is deactivated, thereby maintaining the state of connection to the cell group (for example, if there is no beam-related configuration information configured to indicate in what beam the RLM procedure is to be performed), or the UE may perform an activation procedure in the beam configured in the RRC message, when the cell group is activated. If there is no beam-related configuration information configured to indicate in what beam the RLM procedure is to be performed when the cell group is activated, the RLM procedure may be performed in the beam activated last (or previously).
Configuration information for a beam failure detection (BFD) procedure or configuration information for a BFD to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the BFD procedure is to be performed. As another method, when the cell group state is a deactivated state, the UE may perform the BFD procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the BFD procedure in the BWP activated last (or previously) before the cell group state is deactivated, thereby maintaining the state of connection to the cell group (for example, if there is no BWP configuration information configured to indicate in what BWP the BFD procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the BFD procedure is to be performed when the cell group is activated, the BFD procedure may be performed in the BWP activated last (or previously). In addition, the configuration information may include beam-related configuration information (which, for example, may be indicated by a BWP identifier or TCI state or QCL configuration information) which indicates in what beam the BFD procedure is to be performed. As another method, when the cell group state is a deactivated state, the UE may perform the BFD procedure in a beam (for example, TCI state or QCL configuration information) configured in the RRC message, and may thus early monitor the beam to be activated when the cell group is activated, thereby minimizing cell group activation delay. As another method, when the cell group state is configured as a deactivated (or activated) state, the UE may perform the BFD procedure in the beam activated last (or previously) before the cell group state is deactivated, thereby maintaining the state of connection to the cell group (for example, if there is no beam-related configuration information configured to indicate in what beam the BFD procedure is to be performed), or the UE may perform an activation procedure in the beam configured in the RRC message, when the cell group is activated. If there is no beam-related configuration information configured to indicate in what beam the BFD procedure is to be performed when the cell group is activated, the BFD procedure may be performed in the beam activated last (or previously).

Upon receiving the second RRC message 1k-20 from the master base station (MCG, MN), the UE may read and identify the second RRC message, or may read information (for example, first RRC message included in the second RRC message message) included in the second RRC message, and the UE may configure or add or change or resume or suspend or deactivate the dual connectivity or a cell group (for example, secondary cell group). In addition, if the second RRC message or first RRC message includes a first indicator for triggering a random access procedure, the UE may trigger a random access procedure with regard to the configured or indicated cell group or cell. When the UE performs the random access procedure, if there is random access information in the RRC message, or if there is random access information that has been stored, a random access procedure (for example, contention-free random access procedure (for example, four-step random access or two-step random access)) may be performed based on random access information which has been stored, or which is received in the RRC message, or based on system information. If there is no random access information in the RRC message, the UE may perform a random access procedure (for example, contention-based random access procedure (for example, four-step random access or two-step random access)). As another method, the UE may perform PDCCH monitoring in the designated or configured cell group or cell and may trigger and perform a random access procedure as indicated in the PDCCH. For example, the upper layer device (for example, RRC layer device) may send an indicator for triggering the random access procedure to the lower layer device (for example, MAC layer device).

Next, the disclosure proposes a first embodiment of UE operations in consideration of dual connectivity configuration information when the UE received the RRC message (for example, RRCReconfiguration message). The embodiment proposes a procedure in which, when the UE activates or adds or changes a cell group, the cell group can be activated without a random access procedure (RACH less activation).
If the UE received the RRCReconfiguration message, the UE may perform the following procedure:
1> If the UE has an MCG (or master node (MN)) configured for LTE (E-UTRA) and has an SCG (or secondary node (SN)) configured for NR (that is, if E-UTRA nr-SecondaryCellGroupConfig is configured), or if the UE is configured for (NG) EN-DC (Next Generation E-UTRA NR-Dual connectivity connected to 5GC),
2> If the RRCReconfiguration message was received through an E-UTRA RRC message inside a MobilityFromNRCommand message (a message indicating a handover from NR to (NG) EN-DC),
3> In the message, if reconfigurationWithSync configuration information is included in spCellConfig of the SCG, or if the cell group state of the SCG is not configured as a deactivated state,
4> The UE may perform (or trigger or start) a random access procedure with regard to the SpCell (or SCG or PSCell).
3> Else if the cell group state of the SCG is not configured as a deactivated state, or if a new indicator (for example, RACH-less indication) is included in the message so as to indicate that no random access procedure is to be performed, or if reconfigurationWithSync configuration information is not included in spCellConfig of the SCG in the message,
4> The UE may not perform (or trigger or start) a random access procedure with regard to the SpCell (or SCG or PSCell).
4> The UE may activate the SpCell without a random access procedure. Alternatively, the UE may start PDCCH monitoring with regard to the SpCell, or may start PDSCH reception.
3> Else,
4> The UE's performing procedure is ended.
1> If the UE has an MCG (or master node (MN)) configured for NR and has an SCG (or secondary node (SN)) configured for NR (that is, if E-UTRA nr-Secondary CellGroupConfig is configured), or if the UE is configured for NR-DC (NR-Dual connectivity connected to 5GC), or if an RRCReconfiguration message was received in nr-SCG of mrdc-SecondaryCellGroup configuration information through SRB1, or if the mrdc-SecondaryCellGroup configuration information was received in the RRCReconfiguration or RRCResume message through SRB1,
2> In the message, if reconfigurationWithSync configuration information is included in spCellConfig of nr-SCG, or if the cell group state of the SCG is not configured as a deactivated state,
3> The UE may perform (or trigger or start) a random access procedure with regard to the SpCell (or SCG or PSCell).
2> Else if the cell group state of the SCG is not configured as a deactivated state, or if a new indicator (for example, RACH-less indication) is included in the message so as to indicate that no random access procedure is to be performed, or if reconfigurationWithSync configuration information is not included in spCellConfig of the SCG in the message,
3> The UE may not perform (or trigger or start) a random access procedure with regard to the SpCell (or SCG or PSCell).
3> The UE may activate the SpCell without a random access procedure. Alternatively, the UE may start PDCCH monitoring with regard to the SpCell, or may start PDSCH reception.
2> Else,
3> UE's performing procedure is ended.
1> In the message, if reconfigurationWithSync configuration information is included in spCellConfig of the MCG or SCG, and if the MAC layer device of the NR cell group successfully completed the triggered random access procedure,
2> The first time (T304) regarding the cell group may be suspended (or if the timer is being driven).
2> The second timer (T310) regarding the cell group or source SpCell may be suspended (or if the timer is being driven).
When the message includes reconfigurationWithSync, and when the UE performs a procedure of reconfiguration for synchronization (reconfiguration with Sync), the following procedure may be performed:
1> If no dual active protocol stack (DAPS) bearer is configured, or if the state of the cell group (or SCG) is not configured as a deactivated state, or if there is no RLM-related configuration or beam failure detection-related configuration information configured for a deactivated cell group (if the state of the cell group is configured as a deactivated state, the second timer is continuously driven, and an RLM procedure is performed, thereby supporting quick cell group activation), or if this procedure is not performed with regard to an deactivated cell group (or SCG),
2> The second timer (T310) regarding the cell group or source SpCell may be suspended (or if the timer is being driven).
1> The third timer (T312) regarding the cell group or source SpCell may be suspended (or if the timer is being driven).
1> If the state of the cell group (or SCG) is not configured as a deactivated state, or if this procedure is not performed with regard to the cell group (or SCG),
2> The first timer (T304) regarding the SpCell (the PCell of the MCG or the PSCell of the SCG) may be started by configuring the first timer (T304) value included in reconfigurationWithSync configuration information of the message.
As proposed above in the disclosure, if there is RLM-related configuration information or beam failure detection-related configuration information configured with regard to a deactivated cell group (or SCG) in the RRC message (for example, RRCReconfiguration message), the UE may perform a radio link failure detection procedure as follows:
1> If the cell group state is configured as a deactivated state (or if there is a beam failure detection procedure or RLM procedure configured with regard to a deactivated cell group), or if an indication of a synchronization failure regarding the SpCell is received from the lower layer device a predetermined number of times (for example, N310 value),
The second timer (T310) regarding the SpCell may be started. (The second timer may be suspended if the second timer is being driven when the cell group state is activated (or configured as activated or not configured as deactivated, or when a random access procedure is started or performed with regard to the SpCell. In addition, if the second timer expires, the occurrence of a radio link failure regarding the cell group may be announced)
1> If there is a DAPS bearer configured, or if an indication of a synchronization failure regarding the source SpCell is received from the lower layer device a predetermined number of times (for example, N310 value), or if the first timer is being driven,
The second timer (T310) regarding the source SpCell may be started.
1> If an indication of a synchronization failure regarding the SpCell is received from the lower layer device a predetermined number of times (for example, N310 value), or if the first timer (T304) or the fourth timer is not being driven,
The second timer (T310) regarding the source SpCell may be started.

Next, the disclosure proposes a second embodiment of UE operations in consideration of dual connectivity configuration information when the RRC message (for example, RRCReconfiguration message) is received. The embodiment proposes a procedure in which, when the UE activates or adds or changes a cell group, the cell group can be activated without a random access procedure (RACH less activation).
If the UE received the RRCReconfiguration message, the UE may perform the following procedure:
1> If the UE has an MCG (or master node (MN)) configured for LTE (E-UTRA) and has an SCG (or secondary node (SN)) configured for NR (that is, if E-UTRA nr-SecondaryCellGroupConfig is configured), or if the UE is configured for (NG) EN-DC (Next Generation E-UTRA NR-Dual connectivity connected to 5GC),
2> If the RRCReconfiguration message was received through an E-UTRA RRC message inside a MobilityFromNRCommand message (a message indicating a handover from NR to (NG) EN-DC),
3> In the message, if reconfigurationWithSync configuration information is included in spCellConfig of the SCG, or if the cell group state of the SCG is not configured as a deactivated state, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device) or if an indication of beam failure detection was received from the lower layer device (or if a beam failure occurred, or if there is no beam failure detection procedure or RLM procedure configured with regard to a deactivated cell group, or if a radio link failure procedure was detected in the RLM procedure (or if the second timer (T310) expired, or if the radio link with the SCG is invalid),
4> The UE may perform (or trigger or start) a random access procedure with regard to the SpCell (or SCG or PSCell).
3> Else if the cell group state of the SCG is not configured as a deactivated state, or if a new indicator (for example, RACH-less indication) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is being driven (or if the timer has not expired, or if no indication of expiration was received from the lower layer device), or if no indication of beam failure detection was received from the lower layer device (or if no beam failure occurred), or if there is a beam failure detection procedure or RLM procedure configured with regard to a deactivated cell group, or if no radio link failure procedure was detected in the RLM procedure (or if the second timer (T310) has not expired, or if the radio link with the SCG is valid), or if reconfigurationWithSync configuration information is not included in spCellConfig of the SCG in the message,
4> The UE may not perform (or trigger or start) a random access procedure with regard to the SpCell (or SCG or PSCell).
4> The UE may activate the SpCell without a random access procedure. Alternatively, the UE may start PDCCH monitoring with regard to the SpCell, or may start PDSCH reception.
3> Else if the cell group state of the SCG is not configured as a deactivated state, or if a new indicator (for example, RACH-less indication) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device) or if an indication of beam failure detection was received from the lower layer device (or if a beam failure occurred, or if there is no beam failure detection procedure or RLM procedure configured with regard to a deactivated cell group, or if a radio link failure procedure was detected in the RLM procedure (or if the second timer (T310) expired, or if the radio link with the SCG is invalid, or if reconfigurationWithSync configuration information is not included in spCellConfig of the SCG in the message,
4> The UE may perform (or trigger or start) a random access procedure with regard to the SpCell (or SCG or PSCell).
3> Else,
4> The UE's performing procedure is ended.
1> If the UE has an MCG (or master node (MN)) configured for NR and has an SCG (or secondary node (SN)) configured for NR (that is, if E-UTRA nr-Secondary CellGroupConfig is configured), or if the UE is configured for NR-DC (NR-Dual connectivity connected to 5GC), or if an RRCReconfiguration message was received in nr-SCG of mrdc-SecondaryCellGroup configuration information through SRB1, or if the mrdc-SecondaryCellGroup configuration information was received in the RRCReconfiguration or RRCResume message through SRB1,
2> In the message, if reconfigurationWithSync configuration information is included in spCellConfig of nr-SCG, or if the cell group state of the SCG is not configured as a deactivated state, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device), or if an indication of beam failure detection was received from the lower layer device (or if a beam failure occurred), or if there is no beam failure detection procedure or RLM procedure configured with regard to a deactivated cell group, or if a radio link failure procedure was detected in the RLM procedure (or if the second timer (T310) expired, or if the radio link with the SCG is invalid),
3> The UE may perform (or trigger or start) a random access procedure with regard to the SpCell (or SCG or PSCell).
2> Else if the cell group state of the SCG is not configured as a deactivated state, or if a new indicator (for example, RACH-less indication) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is being driven (or if the timer has not expired, or if no indication of expiration was received from the lower layer device), or if no indication of beam failure detection was received from the lower layer device (or if no beam failure occurred), or if there is a beam failure detection procedure or RLM procedure configured with regard to a deactivated cell group, or if reconfigurationWithSync configuration information is not included in spCellConfig of the SCG in the message, or if no radio link failure procedure was detected in the RLM procedure (or if the second timer (T310) has not expired, or if the radio link with the SCG is valid),
3> The UE may not perform (or trigger or start) a random access procedure with regard to the SpCell (or SCG or PSCell).
3> The UE may activate the SpCell without a random access procedure. Alternatively, the UE may start PDCCH monitoring with regard to the SpCell, or may start PDSCH reception.
2> Else if the cell group state of the SCG is not configured as a deactivated state, or if a new indicator (for example, RACH-less indication) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device), or if an indication of beam failure detection was received from the lower layer device (or if a beam failure occurred), or if there is no beam failure detection procedure or RLM procedure configured with regard to a deactivated cell group, or if a radio link failure procedure was detected in the RLM procedure (or if the second timer (T310) expired, or if the radio link with the SCG is invalid, or if reconfigurationWithSync configuration information is not included in spCellConfig of the SCG in the message,
3> The UE may perform (or trigger or start) a random access procedure with regard to the SpCell (or SCG or PSCell).
2> Else,
3> UE's performing procedure is ended.
1> In the message, if reconfigurationWithSync configuration information is included in spCellConfig of the MCG or SCG, and if the MAC layer device of the NR cell group successfully completed the triggered random access procedure, =2> The first time (T304) regarding the cell group may be suspended (or if the timer is being driven).
2> The second timer (T310) regarding the cell group or source SpCell may be suspended (or if the timer is being driven).
When the message includes reconfigurationWithSync, and when the UE performs a procedure of reconfiguration for synchronization (reconfiguration with Sync), the following procedure may be performed:
1> If no dual active protocol stack (DAPS) bearer is configured, or if the state of the cell group (or SCG) is not configured as a deactivated state, or if there is no RLM-related configuration or beam failure detection-related configuration information configured for a deactivated cell group (if the state of the cell group is configured as a deactivated state, the second timer is continuously driven, and an RLM procedure is performed, thereby supporting quick cell group activation), or if this procedure is not performed with regard to an deactivated cell group (or SCG),
2> The second timer (T310) regarding the cell group or source SpCell may be suspended (or if the timer is being driven).
1> The third timer (T312) regarding the cell group or source SpCell may be suspended (or if the timer is being driven).
1> If the state of the cell group (or SCG) is not configured as a deactivated state, or if this procedure is not performed with regard to the cell group (or SCG),
2> The first timer (T304) regarding the SpCell (the PCell of the MCG or the PSCell of the SCG) may be started by configuring the first timer (T304) value included in reconfigurationWithSync configuration information of the message.
As proposed above in the disclosure, if there is RLM-related configuration information or beam failure detection-related configuration information configured with regard to a deactivated cell group (or SCG) in the RRC message (for example, RRCReconfiguration message), the UE may perform a radio link failure detection procedure as follows:
1> If the cell group state is configured as a deactivated state (or if there is a beam failure detection procedure or RLM procedure configured with regard to a deactivated cell group), or if an indication of a synchronization failure regarding the SpCell is received from the lower layer device a predetermined number of times (for example, N310 value),
The second timer (T310) regarding the SpCell may be started. (The second timer may be suspended if the second timer is being driven when the cell group state is activated (or configured as activated or not configured as deactivated, or when a random access procedure is started or performed with regard to the SpCell, or when the random access procedure is successfully completed. In addition, if the second timer expires, the occurrence of a radio link failure regarding the cell group may be announced)
1> If there is a DAPS bearer configured, or if an indication of a synchronization failure regarding the source SpCell is received from the lower layer device a predetermined number of times (for example, N310 value), or if the first timer is being driven,
The second timer (T310) regarding the source SpCell may be started.
1> If an indication of a synchronization failure regarding the SpCell is received from the lower layer device a predetermined number of times (for example, N310 value), or if the first timer (T304) or the fourth timer is not being driven,
The second timer (T310) regarding the source SpCell may be started.

Next, the disclosure proposes a third embodiment of UE operations in consideration of dual connectivity configuration information when the RRC message (for example, RRCReconfiguration message) is received. The embodiment proposes a procedure in which, when the UE activates or adds or changes a cell group, the cell group can be activated without a random access procedure (RACH less activation).
If the UE received the RRCReconfiguration message, the UE may perform the following procedure:
1> If the UE has an MCG (or master node (MN)) configured for LTE (E-UTRA) and has an SCG (or secondary node (SN)) configured for NR (that is, if E-UTRA nr-SecondaryCellGroupConfig is configured), or if the UE is configured for (NG) EN-DC (Next Generation E-UTRA NR-Dual connectivity connected to 5GC),
2> If the RRCReconfiguration message was received through an E-UTRA RRC message inside a MobilityFromNRCommand message (a message indicating a handover from NR to (NG) EN-DC),
3> In the message, if reconfigurationWithSync configuration information is included in spCellConfig of the SCG, or if the cell group state of the SCG is not configured as a deactivated state, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device), or if an indication of beam failure detection was received from the lower layer device (or if a beam failure occurred, or if there is no beam failure detection procedure or RLM procedure configured with regard to a deactivated cell group, or if a radio link failure procedure was detected in the RLM procedure (or if the second timer (T310) expired, or if the radio link with the SCG is invalid),
4> The UE may perform (or trigger or start) a random access procedure with regard to the SpCell (or SCG or PSCell).
3> Else if the cell group state of the SCG is not configured as a deactivated state, or if a new indicator (for example, RACH-less indication or second reconfigurationWithcSync) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is being driven (or if the timer has not expired, or if no indication of expiration was received from the lower layer device), or if no indication of beam failure detection was received from the lower layer device (or if no beam failure occurred), or if there is a beam failure detection procedure or RLM procedure configured with regard to a deactivated cell group, or if no radio link failure procedure was detected in the RLM procedure (or if the second timer (T310) has not expired, or if the radio link with the SCG is valid), or if reconfigurationWithSync configuration information is not included in spCellConfig of the SCG in the message,
4> The UE may not perform (or trigger or start) a random access procedure with regard to the SpCell (or SCG or PSCell).
4> The UE may activate the SpCell without a random access procedure. Alternatively, the UE may start PDCCH monitoring with regard to the SpCell, or may start PDSCH reception.
4> The UE may introduce a new fourth timer in order to identify whether the SpCell was successfully activated without a random access procedure. For example, the fourth timer may be started if the condition is satisfied. The fourth timer may be suspended if a PDCCH or PDSCH is successfully received from the SpCell. If the fourth timer expires, the UE may trigger an SCG failure reporting procedure and may report this through the MCG. As another method, if the fourth timer expires, the UE may perform a random access procedure (contention-based random access (CBRA) or contention-free random access (CFRA)) or a two-step random access procedure (two-step RACH), based on configuration information (which, for example, may be configured by second reconfigurationWithSync, or preamble information or smtc information or a new UE identifier (RNTI value) may be configured, or a Need code may be configured as S and stored and used) for a separate random access procedure configured in the RRC message or broadcast in system information (that is, the UE may fall back to the random access procedure). As another method, if the procedure of activating a cell group without a random access procedure has failed (for example, if a PDCCH or PDSCH has not been received successfully for a predetermined period of time), the UE may perform a random access procedure (contention-based random access (CBRA) or contention-free random access (CFRA)) or a two-step random access procedure (two-step RACH), based on configuration information for a separate random access procedure configured in the RRC message or broadcast in system information (that is, the UE may fall back to the random access procedure). The configuration information for a separate random access procedure may be configured when a cell group deactivation instruction is transmitted to the UE through an RRC message, or may be configured when an instruction (or reconfigurationWithSync) to activate the cell group is transmitted to the UE through an RRC message.
3> Else if the cell group state of the SCG is not configured as a deactivated state, or if a new indicator (for example, RACH-less indication) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device), or if an indication of beam failure detection was received from the lower layer device (or if a beam failure occurred, or if there is no beam failure detection procedure or RLM procedure configured with regard to a deactivated cell group, or if a radio link failure procedure was detected in the RLM procedure (or if the second timer (T310) expired, or if the radio link with the SCG is invalid), or if reconfigurationWithSync configuration information is not included in spCellConfig of the SCG in the message,
4> The UE may perform (or trigger or start) a random access procedure with regard to the SpCell (or SCG or PSCell).
3> Else,
4> The UE's performing procedure is ended.
1> If the UE has an MCG (or master node (MN)) configured for NR and has an SCG (or secondary node (SN)) configured for NR (that is, if E-UTRA nr-Secondary CellGroupConfig is configured), or if the UE is configured for NR-DC (NR-Dual connectivity connected to 5GC), or if an RRCReconfiguration message was received in nr-SCG of mrdc-SecondaryCellGroup configuration information through SRB1, or if the mrdc-SecondaryCellGroup configuration information was received in the RRCReconfiguration or RRCResume message through SRB1,
2> In the message, if reconfigurationWithSync configuration information is included in spCellConfig of nr-SCG, or if the cell group state of the SCG is not configured as a deactivated state, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device), or if an indication of beam failure detection was received from the lower layer device (or if a beam failure occurred), or if there is no beam failure detection procedure or RLM procedure configured with regard to a deactivated cell group, or if a radio link failure procedure was detected in the RLM procedure (or if the second timer (T310) expired, or if the radio link with the SCG is invalid),
3> The UE may perform (or trigger or start) a random access procedure with regard to the SpCell (or SCG or PSCell).
2> Else if the cell group state of the SCG is not configured as a deactivated state, or if a new indicator (for example, RACH-less indication or second reconfigurationWithcSync) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is being driven (or if the timer has not expired, or if no indication of expiration was received from the lower layer device), or if no indication of beam failure detection was received from the lower layer device (or if no beam failure occurred), or if there is a beam failure detection procedure or RLM procedure configured with regard to a deactivated cell group, or if no radio link failure procedure was detected in the RLM procedure (or if the second timer (T310) has not expired, or if the radio link with the SCG is valid), or if reconfigurationWithSync configuration information is not included in spCellConfig of the SCG in the message,
3> The UE may not perform (or trigger or start) a random access procedure with regard to the SpCell (or SCG or PSCell).
3> The UE may activate the SpCell without a random access procedure. Alternatively, the UE may start PDCCH monitoring with regard to the SpCell, or may start PDSCH reception.
4> The UE may introduce a new fourth timer in order to identify whether the SpCell was successfully activated without a random access procedure. For example, the fourth timer may be started if the condition is satisfied. The fourth timer may be suspended if a PDCCH or PDSCH is successfully received from the SpCell. If the fourth timer expires, the UE may trigger an SCG failure reporting procedure and may report this through the MCG. As another method, if the fourth timer expires, the UE may perform a random access procedure (contention-based random access (CBRA) or contention-free random access (CFRA)) or a two-step random access procedure (two-step RACH), based on configuration information (which, for example, may be configured by second reconfigurationWithSync, or preamble information or smtc information or a new UE identifier (RNTI value) may be configured, or a Need code may be configured as S and stored and used) for a separate random access procedure configured in the RRC message or broadcast in system information (that is, the UE may fall back to the random access procedure). As another method, if the procedure of activating a cell group without a random access procedure has failed (for example, if a PDCCH or PDSCH has not been received successfully for a predetermined period of time), the UE may perform a random access procedure (contention-based random access (CBRA) or contention-free random access (CFRA)) or a two-step random access procedure (two-step RACH), based on configuration information for a separate random access procedure configured in the RRC message or broadcast in system information (that is, the UE may fall back to the random access procedure). The configuration information for a separate random access procedure may be configured when a cell group deactivation instruction is transmitted to the UE through an RRC message, or may be configured when an instruction (or reconfigurationWithSync) to activate the cell group is transmitted to the UE through an RRC message.
2> Else if the cell group state of the SCG is not configured as a deactivated state, or if a new indicator (for example, RACH-less indication) is included in the message so as to indicate that no random access procedure is to be performed, or if a TAT (TimeAlignmentTimer) timer (a timer for determining the validity of a timing advance (TA) value for synchronization between the UE and the base station) currently driven in the MAC layer device is not being driven (or if the timer expired, or if an indication of expiration was received from the lower layer device), or if an indication of beam failure detection was received from the lower layer device (or if a beam failure occurred), or if there is no beam failure detection procedure or RLM procedure configured with regard to a deactivated cell group, or if a radio link failure procedure was detected in the RLM procedure (or if the second timer (T310) expired, or if the radio link with the SCG is invalid), or if reconfigurationWithSync configuration information is not included in spCellConfig of the SCG in the message,
3> The UE may perform (or trigger or start) a random access procedure with regard to the SpCell (or SCG or PSCell).
2> Else,
3> UE's performing procedure is ended.
1> In the message, if reconfigurationWithSync configuration information is included in spCellConfig of the MCG or SCG, and if the MAC layer device of the NR cell group successfully completed the triggered random access procedure,
2> The first time (T304) regarding the cell group may be suspended (or if the timer is being driven).
2> The second timer (T310) regarding the cell group or source SpCell may be suspended (or if the timer is being driven).
When the message includes reconfigurationWithSync, and when the UE performs a procedure of reconfiguration for synchronization (reconfiguration with Sync), the following procedure may be performed:
1> If no dual active protocol stack (DAPS) bearer is configured, or if the state of the cell group (or SCG) is not configured as a deactivated state, or if there is no RLM-related configuration or beam failure detection-related configuration information configured for a deactivated cell group (if the state of the cell group is configured as a deactivated state, the second timer is continuously driven, and an RLM procedure is performed, thereby supporting quick cell group activation), or if this procedure is not performed with regard to an deactivated cell group (or SCG),
2> The second timer (T310) regarding the cell group or SpCell may be suspended (or if the timer is being driven).
1> The third timer (T312) regarding the cell group or SpCell may be suspended (or if the timer is being driven).
1> If the state of the cell group (or SCG) is not configured as a deactivated state, or if this procedure is not performed with regard to the cell group (or SCG),
2> The first timer (T304) regarding the SpCell (the PCell of the MCG or the PSCell of the SCG) may be started by configuring the first timer (T304) value included in reconfigurationWithSync configuration information of the message.
As proposed above in the disclosure, if there is RLM-related configuration information or beam failure detection-related configuration information configured with regard to a deactivated cell group (or SCG) in the RRC message (for example, RRCReconfiguration message), the UE may perform a radio link failure detection procedure as follows:
1> If the cell group state is configured as a deactivated state (or if there is a beam failure detection procedure or RLM procedure configured with regard to a deactivated cell group), or if an indication of a synchronization failure regarding the SpCell is received from the lower layer device a predetermined number of times (for example, N310 value),
The second timer (T310) regarding the SpCell may be started. (The second timer may be suspended if the second timer is being driven when the cell group state is activated (or configured as activated or not configured as deactivated, or when a random access procedure is started or performed with regard to the SpCell, or when the random access procedure is successfully completed. In addition, if the second timer expires, the occurrence of a radio link failure regarding the cell group may be announced)
1> If there is a DAPS bearer configured, or if an indication of a synchronization failure regarding the source SpCell is received from the lower layer device a predetermined number of times (for example, N310 value), or if the first timer is being driven,
The second timer (T310) regarding the source SpCell may be started.
1> If an indication of a synchronization failure regarding the SpCell is received from the lower layer device a predetermined number of times (for example, N310 value), or if the first timer (T304) or the fourth timer is not being driven,
The second timer (T310) regarding the source SpCell may be started.

Next, the disclosure proposes a method wherein, when the UE for which the dual connectivity is configured in the disclosure received the RRC message (RRCReconfiguration or RRCResume), the UE's beam failure detection procedure or RLM procedure or TA adjustment (or management) procedure or PDCCH monitoring procedure or random access procedure can be efficiently performed with regard to a case in which the state of a cell group or a cell is configured as an activated state (or not configured as a deactivated state) or configured as a deactivated state, or a method wherein a BWP is determined. Therefore, the base station may selectively configure the UE's procedure, may consider the UE's battery saving, and may prevent an unnecessary UE procedure. The RLM procedure refers to a procedure of detecting whether the UE's current radio link state is valid, based on a second timer (T310), or the beam failure detection procedure refers to a procedure of determining the beam's signal strength or beam alignment in the lower layer device (MAC layer device or PHY layer device).
1> If the UE is configured (or instructed) to deactivate a cell or a cell group through an RRC message (or MAC CE or DCI or PDCCH),
2> The UE may continuously maintain the TAT (TimingAlignmentTimer) timer regarding a primary timing advance group (PTAG) (or may not suspend the same. Alternatively, the timing advance (TA) value may be considered valid while the timer is driven (or before expiration)). Alternatively, it may be considered that the TAT timer regarding a secondary timing advance group (STAG) is suspended or expired. Alternatively, it may be considered that remaining TAT timers other than the TAT timer regarding the PTAG are suspended or expired. If the message includes a TA value for the cell group or cell, the TA value may be used to configure (or reset) the current TA value, or to start (or restart) the TAT timer. If the TAT timer regarding the PTAG expires, the UE may report the timer expiration to the base station (for example, by using an RRC message or a PUCCH transmission resource or a MAC control element or by performing a random access procedure). Alternatively, the UE may have the TA value reconfigured by the base station (for example, by using an RRC message or a PUCCH transmission resource or a MAC control element or a random access response (RAR)). Alternatively, the UE may start (or restart) the TAT timer if the TA value is reconfigured therefor. As another method, if the TAT timer regarding the PTAG expires, and if the UE later receives information indicating cell or cell group activation (or information not indicating deactivation) through the message, the UE may report the timer expiration to the base station (for example, by using an RRC message or a PUCCH transmission resource or a MAC control element or by performing a random access procedure). Alternatively, the UE may have the TA value reconfigured by the base station (for example, by using an RRC message or a PUCCH transmission resource or a MAC control element or a random access response (RAR)). Alternatively, the UE may start (or restart) the TAT timer if the TA value is reconfigured therefor. As another method, if the TAT timer regarding the PTAG expires, the UE may not perform a procedure for updating the TA value and may consider that the TV value is no longer valid.
2> If there is no BWP configured in the message with regard to the cell or cell group for which deactivation is indicated (or if the message has no BWP configuration information regarding the cell or cell group),
3> The UE may consider the current active BWP (or a BWP activated previously or a BWP activated last or a BWP activated before the message was received) as the BWP to perform a UE procedure proposed with regard to the cell or cell group for which deactivation is indicated (or the BWP to be monitored or activated, or the BWP regarding which a beam failure detection procedure or an RLM procedure is to be performed, or the BWP regarding which the TA value is to be maintained, or the BWP regarding which a random access procedure or PDCCH monitoring is to be performed).
2> If there is a BWP (for example, first active downlink (or uplink) BWP (firstActiveDownlinkBWP or firstActiveUplinkBWP or a newly defined BWP) configured in the message with regard to the cell or cell group for which deactivation is indicated (or if the message has BWP configuration information regarding the cell or cell group),
3> The UE may consider the BWP configured in the message as the BWP to perform a UE procedure proposed with regard to the cell or cell group for which deactivation is indicated (or the BWP to be monitored or activated, or the BWP regarding which a beam failure detection procedure or an RLM procedure is to be performed, or the BWP regarding which the TA value is to be maintained, or the BWP regarding which a random access procedure or PDCCH monitoring is to be performed). Alternatively, the UE may perform the UE procedure proposed with regard to the cell or cell group for which deactivation is indicated, by switching (or activating) to the BWP configured in the message. As another method, when configuring a BWP in the message, the base station may configure the BWP always to be the UE's current active BWP (or a BWP activated previously or a BWP activated last or a BWP activated before the message was received) such that the UE can perform the proposed UE procedure in the current active BWP (or a BWP activated previously or a BWP activated last or a BWP activated before the message was received).
2> If there is a beam failure detection (or beam failure recovery) procedure or radio link monitoring (RLM) procedure configured in the message with regard to the cell or cell group for which deactivation is indicated, or if related configuration information is included therein,
3> The UE performs a beam failure detection procedure or RLM procedure, based on configuration information regarding the beam failure detection (or beam failure recovery) procedure or RLM procedure, in the BWP determined in the procedure proposed with regard to the cell or cell group for which deactivation is indicated.
2> If there is no beam failure detection (or beam failure recovery) procedure or radio link monitoring (RLM) procedure configured in the message with regard to the cell or cell group for which deactivation is indicated, or if no related configuration information is included therein,
3> The UE does not perform the beam failure detection (or beam failure recovery) procedure or RLM procedure in the BWP determined in the procedure proposed with regard to the cell or cell group for which deactivation is indicated.
2> If the message includes bearer configuration information (configuration information regarding a PHY layer device or a MAC layer device or an RLC layer device or a PDCP layer device or an SDAP layer device) or security key-related configuration information or cell or cell group configuration information, the received configuration information may be applied (or configured or reconfigure) while maintaining the cell or cell group deactivated.
1> If the UE is configured (or instructed) to activate a cell or a cell group through an RRC message (or MAC CE or DCI of PDCCH), or if the UE is not configured (or instructed) to deactivate the same,
2> If there is no BWP configured in the message with regard to the cell or cell group for which activation is indicated (or if the message has no BWP configuration information regarding the cell or cell group),
3> The UE may consider the current active BWP (or a BWP activated previously or a BWP activated last or a BWP activated before the message was received) as the BWP to perform a UE procedure proposed with regard to the cell or cell group for which deactivation is indicated (or the BWP to be monitored or activated, or the BWP regarding which a beam failure detection procedure or an RLM procedure is to be performed, or the BWP regarding which the TA value is to be maintained, or the BWP regarding which a random access procedure or PDCCH monitoring is to be performed).
2> If there is a BWP (for example, first active downlink (or uplink) BWP (firstActiveDownlinkBWP or firstActiveUplinkBWP or a newly defined BWP) configured in the message with regard to the cell or cell group for which activation is indicated (or if the message has BWP configuration information regarding the cell or cell group),
3> The UE may consider the BWP configured in the message as the BWP to perform a UE procedure proposed with regard to the cell or cell group for which activation is indicated (or the BWP to be monitored or activated, or the BWP regarding which a beam failure detection procedure or an RLM procedure is to be performed, or the BWP regarding which the TA value is to be maintained, or the BWP regarding which a random access procedure or PDCCH monitoring is to be performed). Alternatively, the UE may perform the UE procedure proposed with regard to the cell or cell group for which deactivation is indicated, by switching (or activating) to the BWP configured in the message.
2> The UE may perform a first embodiment or second embodiment or third embodiment procedure of UE operations in consideration of the dual connectivity configuration information proposed in the disclosure in a BWP determined in the procedure proposed with regard to a cell or cell group for which activation is indicated, and may activate the cell or cell group, based on a random access procedure, or without a random access procedure, according to conditions proposed in the embodiments.
3> If the UE performed cell or cell group activation without a random access procedure because conditions proposed in the first embodiment or second embodiment or third embodiment procedure of UE operations in consideration of the dual connectivity configuration information proposed in the disclosure, and if the UE failed and thus falls back to the random access procedure, or if the random access procedure is performed through the fallback,
4> The UE may perform the random access procedure (normal random access procedure (four-step random access procedure) or two-step random access procedure (two-step RACH) in consideration of the message or system information) in the BWP determined in the proposed procedure when a random access procedure is performed in the fallback procedure, or in the current BWP (or previously activated BWP or lastly activated BWP), or in the first active downlink (or uplink) BWP (firstActiveDownlinkBWP or firstActiveUplinkBWP or a newly defined BWP) configured in the message, or in the initial BWP (or initial BWP broadcast (or configured) in the cell or cell group's system information).
2> If the message includes bearer configuration information (configuration information regarding a PHY layer device or a MAC layer device or an RLC layer device or a PDCP layer device or an SDAP layer device) or security key-related configuration information or cell or cell group configuration information, the received configuration information may be applied (or configured or reconfigured) while activating the cell or cell group.

The UE may receive a second RRC message 1k-20 from the master base station (MCG, MN) or may apply received configuration information, may generate a third RRC message 1k-25 or a fourth RRC message, and may transmit the same to the base station (1k-25). The third RRC message may include some of the following pieces of information:
A second RRC message identifier having the same value as the second RRC message identifier included in the second RRC message
An indicator or identifier indicating successful reception of the second RRC message
A fourth RRC message including a response indicating successful reception of a first RRC message generated and transmitted by the secondary base station. The fourth RRC message may include some of the following pieces of information:
A first RRC message identifier having the same value as the first RRC message identifier included in the first RRC message
An indicator or identifier indicating successful reception of the first RRC message
A response indicator indicating successful application of the first RRC message

Upon receiving the third RRC message, the base station (for example, master base station) may identify whether the same is a response message to the second RRC message, through the second identifier. The base station may identify the fourth RRC message included in the third RRC message, and may the fourth RRC message to the secondary base station while being included in a configuration completion message indicating completion of configuration to the secondary cell group base station through an Xn interface (for example, inter-base station interface) or Sn interface (interface between a base station and an AMF or a UMF or between base stations) (1k-30). The configuration completion message may include some of the following pieces of information:
A fourth RRC message included in the third RRC message
An indicator or identifier indicating completion of configuration (cell group addition or change or release) or first RRC message or instruction (cell group activation or deactivation or suspension or resumption) indicated in the request acceptance message

Upon receiving the configuration completion message, the base station (for example, secondary base station) may read or identify the fourth RRC message included in the configuration completion message, and may identify whether the same is a response message to the first RRC message, through the first identifier. In addition, the base station may identify whether the configuration or instruction indicated thereby is successfully completed. Upon receiving the configuration completion message or the fourth RRC message, the secondary base station may transmit, in response thereto, a response message to the master base station to indicate successful reception of configuration completion message or the fourth RRC message.

FIG. 1L illustrates a second signaling procedure in which dual connectivity according to an embodiment of the disclosure is configured or released, or in which a secondary cell group configured by the dual connectivity is configured or released or activated or resumed or suspended or deactivated.

In FIG. 1L, the UE may configure RRC connection to a network or a base station as in FIG. 1F of the disclosure, and may transmit or receive data with the base station (for example, master cell group, maser node (MN) or master cell group (MCG) or master cell group's cells (PCell or SCell)).

The base station may configure dual connectivity for the UE for a specific reason (for example, if a high data transmission rate is necessary, or at the UE's request (1l-05), or if a high level of QoS requirement is to be satisfied, or the like). For example, the UE may send a request to the base station to configure or release or release or activate or deactivate or resume or suspend the dual connectivity or a cell group (for example, secondary cell group) or a cell, and the request message may include a frequency (or channel) measurement result report or a cell group identifier or cell identifiers or measurement results (1l-05). As another method, the base station may determine whether to configure or release or add or deactivate or activate or resume or change or reconfigure or suspend the dual connectivity or a cell group (for example, secondary cell group) or a cell in consideration of the amount of downlink (or uplink) data or the amount of buffer.

The master base station (master node (MN) or master cell group (MCG)) may receive a frequency-specific or channel-related frequency or channel measurement report from the UE, and may configure a secondary base station (secondary node (SN) or secondary cell group (SCG)) for which dual connectivity is to be configured, based on the measurement report. Alternatively, the master base station may determine whether to configure or release or add or deactivate or activate or resume or change or reconfigure or suspend the dual connectivity or a cell group (for example, secondary cell group) or a cell in consideration of the amount of downlink (or uplink) data or the amount of buffer. The master base station may transmit a first RRC message to the UE in order to configure or release or add or deactivate or activate or resume or change or reconfigure or suspend the dual connectivity regarding the determined secondary base station or a cell group (for example, secondary cell group) or a cell (1l-10). In the first RRC message, each separate new request message may be defined and used to indicate to the UE whether to configure or release or add or deactivate or activate or resume or change or reconfigure or suspend the dual connectivity or a cell group (for example, secondary cell group) or a cell. As another method, in an existing message (for example, RRCReconfiguration or RRCResume message), a new indicator may be defined to instruct (or request) to configure or release or add or deactivate or activate or resume or change or reconfigure or suspend a cell group (for example, secondary cell group) or a cell. The first RRC message may include some of the following pieces of information:
A first RRC message identifier (for example, rrc-Transaction identifier) for distinguishing the first RRC message. Since the UE and the base station (for example, master base station) transmit or receive multiple RRC messages with each other, the RRC message may include identifiers for distinguishing respective RRC messages. For example, an RRC message (for example, RRCReconfiguration) transmitted by the transmitting end or an RRC message (for example, RRCReconfigurationComplete) corresponding to the RRC message (for example, RRCReconfiguration) transmitted by the receiving end or an RRC message corresponding to the RRC message transmitted by the transmitting end may include the same first RRC message identifier.
Configuration information or indicator (for example, configuration information or indicator for the UE) for configuring or releasing or adding or deactivating or activating or resuming or changing or reconfiguring or suspending the dual connectivity or a cell group (for example, secondary cell group) or a cell
An indicator indicating the state of a cell group (for example, activated or deactivated or suspended or resumed)
A cell group identifier for distinguishing cell groups. (The cell group identifier may be allocated by the master base station, or one of pre-promised identifiers may be allocated by the secondary base station.)
Cell group or cell configuration information
Bearer configuration information. For example, indicator information indicating operations of a protocol layer device (for example, SDAP layer device or PDCP layer device or RLC layer device or MAC layer device) of each bearer (for example, a PDCP suspension indicator or a PDCP reestablishment indicator or a PDCP data restoration indictor or an RLC reestablishment indicator or a MAC partial reset indicator or a MAC reset indicator or an indicator triggering a new operation)
If configuration information or indicator for configuring or adding or activating or resuming or changing or reconfiguring the dual connectivity or a cell group (for example, secondary cell group) or a cell is included, a first indicator (for example, mobilityControlInfor or ReconfigurationWithSync) may be included together. However, if configuration information or indicator for releasing or deactivating or reconfiguring or suspending the dual connectivity or a cell group (for example, secondary cell group) or a cell is included, the first indicator (for example, mobilityControlInfor or ReconfigurationWithSync) may not be included. The first indicator may be an indicator for triggering a random access procedure by the cell group or cell, or an indicator for synchronizing signals with a new cell, or an indicator indicating the UE's frequency shift, or an indicator indicating the cell group's (or cell's) change. As another method, the UE may perform PDCCH monitoring in the designated or configured cell group or cell, and may trigger and perform a random access procedure as indicated in the PDCCH. For example, the upper layer device (for example, RRC layer device) may send an indicator for triggering the random access procedure to the lower layer device (for example, MAC layer device).
If configuration information or indicator for configuring or adding or activating or resuming or changing or reconfiguring the dual connectivity or a cell group (for example, secondary cell group) or a cell is included, random access configuration information may be included together. However, if configuration information or indicator for releasing or deactivating or reconfiguring or suspending the dual connectivity or a cell group (for example, secondary cell group) or a cell is included, the random access configuration information may not be included. The random access configuration information may include random access transmission resource information (time or frequency transmission resource) for preamble transmission regarding the cell group or cell, or designated preamble information or the like.
Time information indicating when the dual connectivity or a cell group (for example, secondary cell group) or a cell (PSCell or SCG SCell) is to be activated or resumed or deactivated or suspended (for example, information (for example, X) indicating timing, time unit, subframe or time slot or symbol unit), for example, if the message was received at the n^{th} time unit, time information indicating whether the cell is to be activated or resumed or deactivated or suspended at the (n+X)^{th})
Cell-specific or BWP-specific first channel measurement configuration information
Cell-specific or BWP-specific second channel measurement configuration information
An indicator for adding cell group configuration or an indicator (ReconfigurationWithSync) indicating a cell group change or an indicator (ReconfigurationWithSync or a newly defined indicator) indicating a random access procedure
An indicator (ReconfigurationWithSync or a newly defined indicator) indicating whether to activate a cell group by performing a random access procedure when activating the cell group or to activate the cell group without the random access procedure
Radio resource management (RRM) configuration information or frequency measurement configuration information or separate radio resource management (RRM) configuration information to be applied or performed when a cell group is deactivated, or frequency measurement configuration information (for example, simplified frequency measurement configuration information (for example, reduced or relaxed RRM configuration information) for battery saving)
Configuration information for radio link monitoring (RLM) or configuration information for RLM to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the RLM procedure is to be performed. As another method, when the cell group state is a deactivated state, the UE may perform the RLM procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the RLM procedure in the BWP activated last (or previously) before the cell group state is deactivated, thereby maintaining the state of connection to the cell group (for example, if there is no BWP configuration information configured to indicate in what BWP the RLM procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the RLM procedure is to be performed when the cell group is activated, the RLM procedure may be performed in the BWP activated last (or previously). In addition, the configuration information may include beam-related configuration information (which, for example, may be indicated by a BWP identifier or TCI state or QCL configuration information) which indicates in what beam the RLM procedure is to be performed. As another method, when the cell group state is a deactivated state, the UE may perform the RLM procedure in a beam (for example, TCI state or QCL configuration information) configured in the RRC message, or may activate the beam and perform the RLM procedure, and may early monitor the beam to be activated when the cell group is activated, thereby minimizing cell group activation delay. As another method, when the cell group state is configured as a deactivated (or activated) state, the UE may perform the RLM procedure in the beam activated last (or previously) before the cell group state is deactivated, thereby maintaining the state of connection to the cell group (for example, if there is no beam-related configuration information configured to indicate in what beam the RLM procedure is to be performed), or the UE may perform an activation procedure in the beam configured in the RRC message, when the cell group is activated. If there is no beam-related configuration information configured to indicate in what beam the RLM procedure is to be performed when the cell group is activated, the RLM procedure may be performed in the beam activated last (or previously).
Configuration information for a beam failure detection (BFD) procedure or configuration information for a BFD to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the BFD procedure is to be performed. As another method, when the cell group state is a deactivated state, the UE may perform the BFD procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the BFD procedure in the BWP activated last (or previously) before the cell group state is deactivated, thereby maintaining the state of connection to the cell group (for example, if there is no BWP configuration information configured to indicate in what BWP the BFD procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the BFD procedure is to be performed when the cell group is activated, the BFD procedure may be performed in the BWP activated last (or previously). In addition, the configuration information may include beam-related configuration information (which, for example, may be indicated by a BWP identifier or TCI state or QCL configuration information) which indicates in what beam the BFD procedure is to be performed. As another method, when the cell group state is a deactivated state, the UE may perform the BFD procedure in a beam (for example, TCI state or QCL configuration information) configured in the RRC message, and may thus early monitor the beam to be activated when the cell group is activated, thereby minimizing cell group activation delay. As another method, when the cell group state is configured as a deactivated (or activated) state, the UE may perform the BFD procedure in the beam activated last (or previously) before the cell group state is deactivated, thereby maintaining the state of connection to the cell group (for example, if there is no beam-related configuration information configured to indicate in what beam the BFD procedure is to be performed), or the UE may perform an activation procedure in the beam configured in the RRC message, when the cell group is activated. If there is no beam-related configuration information configured to indicate in what beam the BFD procedure is to be performed when the cell group is activated, the BFD procedure may be performed in the beam activated last (or previously).

Upon receiving the first RRC message 1l-15 from the master base station (MCG, MN), the UE may read and identify the first RRC message, and the UE may configure or add or change or resume or suspend or deactivate the dual connectivity or a cell group (for example, secondary cell group). In addition, if the first RRC message includes a first indicator for triggering a random access procedure, the UE may trigger a random access procedure with regard to the configured or indicated cell group or cell. When the UE performs the random access procedure, if there is random access information in the RRC message, or if there is random access information that has been stored, a random access procedure (for example, contention-free random access procedure (for example, four-step random access or two-step random access)) may be performed based on random access information which has been stored, or which is received in the RRC message, or based on system information. If there is no random access information in the RRC message, the UE may perform a random access procedure (for example, contention-based random access procedure (for example, four-step random access or two-step random access)). As another method, the UE may perform PDCCH monitoring in the designated or configured cell group or cell and may trigger and perform a random access procedure as indicated in the PDCCH. For example, the upper layer device (for example, RRC layer device) may send an indicator for triggering the random access procedure to the lower layer device (for example, MAC layer device).

The UE may receive a first RRC message 1l-10 or may apply received configuration information, may generate a second RRC message and transmit the same to the base station (1l-15). The second RRC message may include some of the following pieces of information:
A first RRC message identifier having the same value as the first RRC message identifier included in the first RRC message
An indicator or identifier indicating successful reception of the first RRC message

Upon receiving the second RRC message, the base station (for example, master base station) may identify whether the same is a response message to the first RRC message, through the first identifier. The base station may identify the first RRC message and may transmit an indication message, which includes an indication of cell group configuration or addition or release or activation or resumption or suspension or deactivation to the secondary cell group base station, to the secondary base station through an Xn interface (for example, inter-base station interface) or Sn interface (interface between a base station and an AMF or a UMF or between base stations) (1l-20). The indication message may include some of the following pieces of information:
An identifier enabling distinction of the indication message
Configuration information or an indicator indicating that the dual connectivity or a cell group (for example, secondary cell group) or a cell is configured or released or added or deactivated or activated or resumed or changed or reconfigured or suspended (for example, configuration information or an indicator for the secondary cell group)

Upon receiving the indication message, the base station (for example, secondary base station) may read or identify configuration information or a message included in the indication message, may generate an indication identification message as a response message to the indication message, and may transmit the same to the master base station (1l-25).
An identifier having the same value as the identifier included in the indication message
An indicator or identifier indicating successful reception of the indication message
A response indicator indicating successful application of the indication message

The signaling procedures proposed in the disclosure may be combined with each other, modified, and expanded to new signaling procedures. For example, upon receiving the message 1l-05 from the UE, the master base station may inquire or request the secondary base station like 1l-20 or 1k-10 in FIG. 1K, may receive a response message like 1l-25 or 1k-15 in FIG. 1K, may configure an RRC message corresponding to 1l-10 according to the response message, and may transmit the same to the UE. The UE may configure a cell group according to the instruction in the RRC message, and may transmit the message 1l-15 to the master base station in response thereto.

FIG. 1M illustrates a third signaling procedure in which dual connectivity according to an embodiment of the disclosure is configured or released, or in which a secondary cell group configured by the dual connectivity is configured or released or activated or resumed or suspended or deactivated.

In FIG. 1M, the UE may configure RRC connection to a network or a base station as in FIG. 1F of the disclosure, and may transmit or receive data with the base station (for example, master cell group, maser node (MN) or master cell group (MCG) or master cell group's cells (PCell or SCell)).

In FIG. 1M, according to the configuration procedure in FIG. 1F, the base station may configure an SRB (for example, SRB3) for the UE such that a control message or RRC message can be directly transmitted or received between the UE and the secondary base station.

The base station (for example, secondary or master base station) may configure dual connectivity for the UE for a specific reason (for example, if a high data transmission rate is necessary, or at the UE's request (1m-05), or if a high level of QoS requirement is to be satisfied, or the like). For example, the UE may send a request to the base station to configure or release or release or activate or deactivate or resume or suspend the dual connectivity or a cell group (for example, secondary cell group) or a cell, or may send a request to the secondary base station through the SRB3, and the request message may include a frequency (or channel) measurement result report or a cell group identifier or cell identifiers or measurement results (1m-05). As another method, the (secondary) base station may determine whether to configure or release or add or deactivate or activate or resume or change or reconfigure or suspend the dual connectivity or a cell group (for example, secondary cell group) or a cell in consideration of the amount of downlink (or uplink) data or the amount of buffer.

The secondary base station (secondary node (SN) or secondary cell group (SCG)) may receive a frequency-specific or channel-related frequency or channel measurement report from the UE, and may determine, based on the measurement result, whether to configure or release or add or deactivate or activate or resume or change or reconfigure or suspend the dual connectivity or a cell group (for example, secondary cell group) or a cell. Alternatively, the secondary base station may determine whether to configure or release or add or deactivate or activate or resume or change or reconfigure or suspend the dual connectivity or a cell group (for example, secondary cell group) or a cell, in consideration of the amount of downlink (or uplink) data or the amount of buffer.

The secondary base station may transmit a first RRC message to the UE through SRB3 in order to configure or release or add or deactivate or activate or resume or change or reconfigure or suspend the dual connectivity or a cell group (for example, secondary cell group) or a cell (1m-10). In the first RRC message, each separate new request message may be defined and used to indicate to the UE whether to configure or release or add or deactivate or activate or resume or change or reconfigure or suspend the dual connectivity or a cell group (for example, secondary cell group) or a cell. As another method, in an existing message (for example, RRCReconfiguration or RRCResume message), a new indicator may be defined to instruct (or request) to configure or release or add or deactivate or activate or resume or change or reconfigure or suspend a cell group (for example, secondary cell group) or a cell. The first RRC message may include some of the following pieces of information:
A first RRC message identifier (for example, rrc-Transaction identifier) for distinguishing the first RRC message. Since the UE and the base station (for example, secondary base station) transmit or receive multiple RRC messages with each other, the RRC message may include identifiers for distinguishing respective RRC messages. For example, an RRC message (for example, RRCReconfiguration) transmitted by the transmitting end or an RRC message (for example, RRCReconfigurationComplete) corresponding to the RRC message (for example, RRCReconfiguration) transmitted by the receiving end or an RRC message corresponding to the RRC message transmitted by the transmitting end may include the same first RRC message identifier.
Configuration information or indicator (for example, configuration information or indicator for the UE) for configuring or releasing or adding or deactivating or activating or resuming or changing or reconfiguring or suspending the dual connectivity or a cell group (for example, secondary cell group) or a cell
An indicator indicating the state of a cell group (for example, activated or deactivated or suspended or resumed)
A cell group identifier for distinguishing cell groups. The cell group identifier may be allocated by the master base station, or one of pre-promised identifiers may be allocated by the secondary base station.
Cell group or cell configuration information
Bearer configuration information. For example, indicator information indicating operations of a protocol layer device (for example, SDAP layer device or PDCP layer device or RLC layer device or MAC layer device) of each bearer (for example, a PDCP suspension indicator or a PDCP reestablishment indicator or a PDCP data restoration indictor or an RLC reestablishment indicator or a MAC partial reset indicator or a MAC reset indicator or an indicator triggering a new operation)
If configuration information or indicator for configuring or adding or activating or resuming or changing or reconfiguring the dual connectivity or a cell group (for example, secondary cell group) or a cell is included, a first indicator (for example, mobilityControlInfor or ReconfigurationWithSync) may be included together. However, if configuration information or indicator for releasing or deactivating or reconfiguring or suspending the dual connectivity or a cell group (for example, secondary cell group) or a cell is included, the first indicator (for example, mobilityControlInfor or ReconfigurationWithSync) may not be included. The first indicator may be an indicator for triggering a random access procedure by the cell group or cell, or an indicator for synchronizing signals with a new cell, or an indicator indicating the UE's frequency shift, or an indicator indicating the cell group's (or cell's) change. As another method, the UE may perform PDCCH monitoring in the designated or configured cell group or cell, and may trigger and perform a random access procedure as indicated in the PDCCH. For example, the upper layer device (for example, RRC layer device) may send an indicator for triggering the random access procedure to the lower layer device (for example, MAC layer device).
If configuration information or indicator for configuring or adding or activating or resuming or changing or reconfiguring the dual connectivity or a cell group (for example, secondary cell group) or a cell is included, random access configuration information may be included together. However, if configuration information or indicator for releasing or deactivating or reconfiguring or suspending the dual connectivity or a cell group (for example, secondary cell group) or a cell is included, the random access configuration information may not be included. The random access configuration information may include random access transmission resource information (time or frequency transmission resource) for preamble transmission regarding the cell group or cell, or designated preamble information or the like.
Time information indicating when the dual connectivity or a cell group (for example, secondary cell group) or a cell (PSCell or SCG SCell) is to be activated or resumed or deactivated or suspended (for example, information (for example, X) indicating timing, time unit, subframe or time slot or symbol unit), for example, if the message was received at the n^{th} time unit, time information indicating whether the cell is to be activated or resumed or deactivated or suspended at the (n+X)^{th})
Cell-specific or BWP-specific first channel measurement configuration information
Cell-specific or BWP-specific second channel measurement configuration information
An indicator for adding cell group configuration or an indicator (ReconfigurationWithSync) indicating a cell group change or an indicator (ReconfigurationWithSync or a newly defined indicator) indicating a random access procedure
An indicator (ReconfigurationWithSync or a newly defined indicator) indicating whether to activate a cell group by performing a random access procedure when activating the cell group or to activate the cell group without the random access procedure
Radio resource management (RRM) configuration information or frequency measurement configuration information or separate radio resource management (RRM) configuration information to be applied or performed when a cell group is deactivated, or frequency measurement configuration information (for example, simplified frequency measurement configuration information (for example, reduced or relaxed RRM configuration information) for battery saving)
Configuration information for radio link monitoring (RLM) or configuration information for RLM to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the RLM procedure is to be performed. As another method, when the cell group state is a deactivated state, the UE may perform the RLM procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the RLM procedure in the BWP activated last (or previously) before the cell group state is deactivated, thereby maintaining the state of connection to the cell group (for example, if there is no BWP configuration information configured to indicate in what BWP the RLM procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the RLM procedure is to be performed when the cell group is activated, the RLM procedure may be performed in the BWP activated last (or previously). In addition, the configuration information may include beam-related configuration information (which, for example, may be indicated by a BWP identifier or TCI state or QCL configuration information) which indicates in what beam the RLM procedure is to be performed. As another method, when the cell group state is a deactivated state, the UE may perform the RLM procedure in a beam (for example, TCI state or QCL configuration information) configured in the RRC message, or may activate the beam and perform the RLM procedure, and may early monitor the beam to be activated when the cell group is activated, thereby minimizing cell group activation delay. As another method, when the cell group state is configured as a deactivated (or activated) state, the UE may perform the RLM procedure in the beam activated last (or previously) before the cell group state is deactivated, thereby maintaining the state of connection to the cell group (for example, if there is no beam-related configuration information configured to indicate in what beam the RLM procedure is to be performed), or the UE may perform an activation procedure in the beam configured in the RRC message, when the cell group is activated. If there is no beam-related configuration information configured to indicate in what beam the RLM procedure is to be performed when the cell group is activated, the RLM procedure may be performed in the beam activated last (or previously).
Configuration information for a beam failure detection (BFD) procedure or configuration information for a BFD to be applied or performed when a cell group is deactivated. For example, the same may be configuration information of a cell unit beam or configuration information of a BWP-specific beam, which is to be measured by the UE when a cell group is deactivated, and may include beam-related configuration information (transmission configuration indication (TCI) state or quasi co-location (QCL)), or may include a timing advance (TA) value (or offset value) for synchronizing the base station's downlink signal or the base station's uplink signal, or a time alignment timer (TAT) indicating the validity of the TA value, or a TAT value, or may include measurement object synchronization signal block (SSB) configuration information or channel state information reference signal (CSI-RS) configuration information or reference signal (RS) configuration information or transmission resource information (for example, PUCCH configuration information (for example, scheduling request (SR) information or specific transmission resource) or frequency transmission resource or time transmission resource) which may be used to report the result when a beam failure occurs. In addition, the configuration information may include BWP configuration information (which, for example, may be indicated by a BWP indicator) indicating in what BWP the BFD procedure is to be performed. As another method, when the cell group state is a deactivated state, the UE may perform the BFD procedure in the first active BWP (or first active downlink BWP, firstActiveDownlinkBWP-ID) configured in the RRC message such that the first active BWP to be activated when the cell group is activated can be monitored early, thereby minimizing cell group activation delay. As another method, when the cell group state is configured as a deactivated (or activated) state, the UE may perform the BFD procedure in the BWP activated last (or previously) before the cell group state is deactivated, thereby maintaining the state of connection to the cell group (for example, if there is no BWP configuration information configured to indicate in what BWP the BFD procedure is to be performed), or the UE may perform an activation procedure in the first active BWP (or first active downlink BWP, firstActiveDownlinkBWP-ID) configured in the RRC message, when the cell group is activated. If there is no BWP-related configuration information configured to indicate in what BWP the BFD procedure is to be performed when the cell group is activated, the BFD procedure may be performed in the BWP activated last (or previously). In addition, the configuration information may include beam-related configuration information (which, for example, may be indicated by a BWP identifier or TCI state or QCL configuration information) which indicates in what beam the BFD procedure is to be performed. As another method, when the cell group state is a deactivated state, the UE may perform the BFD procedure in a beam (for example, TCI state or QCL configuration information) configured in the RRC message, and may thus early monitor the beam to be activated when the cell group is activated, thereby minimizing cell group activation delay. As another method, when the cell group state is configured as a deactivated (or activated) state, the UE may perform the BFD procedure in the beam activated last (or previously) before the cell group state is deactivated, thereby maintaining the state of connection to the cell group (for example, if there is no beam-related configuration information configured to indicate in what beam the BFD procedure is to be performed), or the UE may perform an activation procedure in the beam configured in the RRC message, when the cell group is activated. If there is no beam-related configuration information configured to indicate in what beam the BFD procedure is to be performed when the cell group is activated, the BFD procedure may be performed in the beam activated last (or previously).

Upon receiving the first RRC message 1m-15 through SRB3 from the secondary base station (SCG, SN), the UE may read and identify the first RRC message, and the UE may configure or add or change or resume or suspend or deactivate the dual connectivity or a cell group (for example, secondary cell group). In addition, if the first RRC message includes a first indicator for triggering a random access procedure, the UE may trigger a random access procedure with regard to the configured or indicated cell group or cell. When the UE performs the random access procedure, if there is random access information in the RRC message, or if there is random access information that has been stored, a random access procedure (for example, contention-free random access procedure (for example, four-step random access or two-step random access)) may be performed based on random access information which has been stored, or which is received in the RRC message, or based on system information. If there is no random access information in the RRC message, the UE may perform a random access procedure (for example, contention-based random access procedure (for example, four-step random access or two-step random access)). As another method, the UE may perform PDCCH monitoring in the designated or configured cell group or cell and may trigger and perform a random access procedure as indicated in the PDCCH. For example, the upper layer device (for example, RRC layer device) may send an indicator for triggering the random access procedure to the lower layer device (for example, MAC layer device).

The UE may receive a first RRC message 1m-10 or may apply received configuration information, may generate a second RRC message and transmit the same to the secondary base station through the SRB3 (1m-15). The second RRC message may include some of the following pieces of information:
A first RRC message identifier having the same value as the first RRC message identifier included in the first RRC message
An indicator or identifier indicating successful reception of the first RRC message

Upon receiving the second RRC message, the base station (for example, secondary base station) may identify whether the same is a response message to the first RRC message, through the first identifier. The base station may identify the first RRC message and may transmit an indication message, which includes an indication of cell group configuration or addition or release or activation or resumption or suspension or deactivation to the master base station or master cell group base station, to the master base station through an Xn interface (for example, inter-base station interface) or Sn interface (interface between a base station and an AMF or a UMF or between base stations) (1m-20). The indication message may include some of the following pieces of information:
An identifier enabling distinction of the indication message
Configuration information or an indicator indicating that the dual connectivity or a cell group (for example, secondary cell group) or a cell is configured or released or added or deactivated or activated or resumed or changed or reconfigured or suspended (for example, configuration information or an indicator for the secondary cell group)

Upon receiving the indication message, the base station (for example, master base station) may read or identify configuration information or a message included in the indication message, may generate an indication identification message as a response message to the indication message, and may transmit the same to the secondary base station (1m-25).
An identifier having the same value as the identifier included in the indication message
An indicator or identifier indicating successful reception of the indication message
A response indicator indicating successful application of the indication message

If a message is sent to the UE to configure or indicate the cell group or cell configuration information proposed in the disclosure for the UE, and if the message includes, for example, configuration information or an indicator for configuring or adding or activating or resuming or changing or reconfiguring the dual connectivity or a cell group (for example, secondary cell group) or a cell, SDAP configuration information may be included or reconfigured, or the SDAP layer device's bearer and QoS flow's mapping configuration information may be included or configured or reconfigured. However, if the message includes configuration information or an indicator for releasing or deactivating or reconfiguring or suspending the dual connectivity or a cell group (for example, secondary cell group) or a cell, the SDAP configuration information may not be included or may not be reconfigured, or the SDAP layer device's bearer and QoS flow's mapping configuration information may not be included or may not be configured or may not be reconfigured, or application thereof may be suspended.

The signaling procedures proposed in the disclosure may be combined with each other, modified, and expanded to new signaling procedures.

The signaling procedures proposed in the disclosure may be expanded to multi-access technology. For example, configuration information of multiple cell groups may be configured for a UE through an RRC message, and one of multiple configured cell groups or multiple cell groups (or cells) may be activated or resumed by a PDCCH indicator or a MAC control element or an RRC message, or one or multiple cell groups may be suspended or deactivated thereby.

Next, the disclosure proposes UE operations regarding each cell (PSCell or SCG SCell) when the dual connectivity proposed in the disclosure or a cell group (for example, secondary cell group) or a cell (PSCell or SCG SCell) is activated or resumed or added or deactivated or released or suspended, or UE operations regarding each protocol layer device (for example, an SDAP layer device or a PDCP layer device or an RLC layer device or a MAC layer device or a PHY layer device).
1> If the UE receives configuration information or an indicator for configuring or adding or activating or resuming or changing or reconfiguring the dual connectivity or a cell group (for example, secondary cell group) or a cell (for example, through DCI of the PDCCH or a MAC control element or an RRC message), the UE may perform some of the following procedures:
2> The upper layer device (for example, RRC layer device) may indicate the configuration information or indictor to the lower layer device (for example, PDCP layer device or RLC layer device or MAC layer device or PHY layer device).
2> The UE's operation regarding the PSCell: upon receiving the configuration information or indicator, the UE may maintain the PSCell activated, may activate the downlink BWP of the PSCell to be a normal BWP (for example, a first active BWP or a BWP which is not a dormant BWP) configured in the RRC message or the lastly activated BWP, and may perform a UE operation in the activated BWP. As another method, upon receiving the configuration information or indicator, the UE may maintain the PSCell activated, may reconfigure or switch the PDCCH monitoring cycle or DRX configuration cycle of the PSCell to a short cycle, based on first DRX configuration information, may perform PDCCH monitoring, and may perform the activated cell's UE operation. According to a method as described above, a UE operation regarding the PSCell may be performed to quickly receive a scheduling instruction from the cell group or cell and to start data transmission or reception. In addition, in order to more quickly receive a scheduling instruction from the cell group or cell and to start data transmission or reception, the UE may measure many or frequent channel signals, based on first channel measurement configuration information configured in the RRC message, and quickly may report the channel measurement result to the base station. If the predetermined condition is satisfied, the UE may again measure channel signals, based on second channel measurement configuration information, and may report the measurement result to the base station.
2> UE operations regarding the SCell of the secondary cell group: upon receiving the configuration information or indicator, the UE may activate the SCell of the secondary cell group, may activate the downlink BWP or uplink BWP to be the BWP (for example, first active BWP) configured in the RRC message, and may perform a UE operation of the activated SCell or BWP. As another method, if the UE receives the configuration information or indicator, and if there is a dormant BWP configured in the SCell of the secondary cell group, the UE may maintain the SCell activated, may activate the downlink BWP of the SCell to be the BWP (for example, first active BWP) configured in the RRC message, and may perform a UE operation in the activated BWP. Alternatively, if there is no dormant BWP configured in the SCell of the secondary cell group, the UE may switch the SCell to an activated state, may activate the downlink BWP or uplink BWP to be the BWP (for example, first active BWP) configured in the RRC message, and may perform a UE operation of the activated SCell or BWP. As another method, upon receiving the configuration information or indicator, the UE may determine to switch or activate or deactivate the state of the SCell or the BWP according to the SCell configuration information or indicator configured in the message including the configuration information or indicator, and may perform a UE operation.
2> UE operations of the MAC layer device regarding the secondary cell group: upon receiving the configuration information or indicator, the UE may perform a reset procedure (MAC reset) with regard to the MAC layer device (for example, configuration information configured for the MAC layer device may be reset or cleared, configured timers may be suspended or reset, or the HARQ procedure may be suspended or reset). For example, it may be considered that the timing advance timer (TAT) timer that indicates the validity of signal synchronization between the UE and the base station is suspended or expired. As another method, upon receiving the configuration information or indicator, the UE may perform a MAC partial reset process (or if the message including the configuration information or indicator includes an indicator indicating a MAC partial reset process, the MAC partial reset process may be performed). For example, the timing advance timer (TAT) timer that indicates the validity of signal synchronization between the UE and the base station may be continuously maintained, or HARQ retransmission that is being retransmitted may be continuously performed. As another method, no procedure may be performed with regard to the MAC layer device, and the current configuration may be maintained. In addition, if the upper layer device (for example, RRC layer device) indicates that a random access procedure is to be triggered, or if the TAT timer is suspended or expired, the UE may trigger the random access procedure. As another method, if the TAT timer is not suspended or has not expired, no random access procedure may be triggered or performed. This is because, if the TAT timer is being driven, signal synchronization with the secondary cell group is correct or is maintained, and an unnecessary random access procedure would thus be performed. As another method, if the base station triggered a random access procedure through a PDCCH indication, the UE may trigger the random access procedure and may configure or adjust the timing advance (TA) value or may start the TA timer. After the random access procedure is completed, the secondary cell group may be resumed or activated, and data transmission or reception may be restarted. As the random access procedure, a contention-based random access (CBRA) procedure may be performed. As another method, if the message (or previously received message) indicating activation or resumption of the cell group when the random access procedure is performed has designated random access configuration information (dedicated RACH config or dedicated preamble) configured (or included) therein, a contention-free random access (CFRA) procedure may be performed. Alternatively, if the message (or previously received message) indicating activation or resumption of the cell group has no designated random access configuration information (dedicated RACH config or dedicated preamble) configured (or included) therein, a contention-based random access (CBRA) procedure may be performed, or no random access procedure may be performed.
2> Operations regarding the data radio bearer (DRB) configured in the secondary cell group: upon receiving the configuration information or indicator, the UE may resume DRBs included in the secondary group (or an SN (SCG) terminated DRB or a DRB having a PDCP layer device configured in the SCG or a bearer using an RLC UM mode or a bearer using an RLC AM mode). For example, with regard to a split bearer having a PDCP layer device configured in the master cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the secondary cell group, or the UE may perform a reestablishment procedure with regard to the RLC layer device configured in the secondary cell group. For example, with regard to a split bearer having a PDCP layer device configured in the secondary cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the master cell group, or may also include an indicator that triggers a PDCP reestablishment procedure (reestablishPDCP) or a PDCP resumption procedure (PDCP resume) in the PDCP layer device configured in the secondary cell group. Alternatively, the UE may perform a reestablishment procedure with regard to the RLC layer device configured in the master cell group, or may perform a PDCP reestablishment procedure or a PDCP resumption procedure (PDCP resume) in the PDCP layer device configured in the secondary cell group. For example, with regard to bearers configured in the secondary cell group, the bearers may be resumed, or the RRC layer device may instruct the PDCP layer device to trigger a PDCP reestablishment procedure or a PDCP resumption procedure, or the PDCP layer device may perform a PDCP reestablishment procedure or a PDCP resumption procedure (PDCP resume). The UE may trigger a first PDCP resumption procedure with regard to bearers configured in the secondary cell group (or bearers using the RLC UM mode or bearers using the RLC AM mode), or may perform the first PDCP resumption procedure in the PDCP layer device. As another method, in order to solve the security issue problem caused by transmission of different pieces of data with the same security key when the secondary cell group is activated or resumed, the UE may trigger a second PDCP resumption procedure with regard to bearers configured in the secondary cell group (or bearers using the RLC UM mode or bearers using the RLC AM mode), or may perform the second PDCP resumption procedure in the PDCP layer device. As another method, if the upper layer device triggered a PDCP layer device resumption procedure, a first PDCP resumption procedure may be triggered and performed. If the upper layer device issued an indicator for triggering a PDCP layer device resumption procedure or activating or resuming a cell group (or cell), a second PDCP resumption procedure may be triggered and performed. As another method, in order to solve the above-mentioned security issue problem caused by transmission of different pieces of data with the same security key, when the base station issued an indicator for activating or resuming a cell group (or cell), the RRC message including the indicator for activating or resuming a cell group (or cell) may include security key configuration information (for example, sk-counter) such that a new security key is configured, and the security key is changed or updated. Alternatively, the RRC message may include a PDCP reestablishment procedure indicator to change or update the security key of bearers configured in the secondary cell group (or bearers using the RLC UM mode or bearers using the RLC AM mode), or the UE may perform a PDCP reestablishment procedure with regard to the bearers. As another method, if security configuration information is included in the message including the instruction to resume or activate a cell group (or cell), or if a security configuration information change (or update) is indicated thereby, or if an indicator of a first PDCP resumption procedure is included therein, the UE may trigger a first PDCP resumption procedure with regard to bearers configured in the secondary cell group (or bearers using the RLC UM mode or bearers using the RLC AM mode), or may perform a first PDCP resumption procedure in the PDCP layer device. However, if no security configuration information is included in the message including the instruction to resume or activate a cell group (or cell), or if no security configuration information change (or update) is indicated thereby, or if an indicator of a second PDCP resumption procedure is included therein, the UE may trigger a second PDCP resumption procedure with regard to bearers configured in the secondary cell group (or bearers using the RLC UM mode or bearers using the RLC AM mode) in order to solve the security issue problem caused by transmission of different pieces of data with the same security key when the secondary cell group is activated or resumed, or may perform a second PDCP resumption procedure in the PDCP layer device. The methods proposed above may be performed when a message including an instruction to suspend or deactivate the cell group is received. In addition, the methods proposed above may be applied to SCG bearers (bearers having a PDCP layer device in the SCG, or SCG terminated bearers).
2> Operations regarding the signaling radio bearer (SRB) configured in the secondary cell group: the UE may receive the configuration information or indicator and may activate the PSCell. Alternatively, if the activated downlink BWP of the PSCell is a normal BWP which is not a dormant BWP, or if the activated PSCell monitors the PDCCH at a long cycle, based on first DRX configuration information, the UE may continuously maintain SRBs included in the secondary cell group (or SN (SCG) terminated SRBs or SRBs having a PDCP layer device configured in the SCG, or SRB3) (for example, the UE may continuously transmit or receive control messages with the secondary base station). Alternatively, the UE may perform a data discarding procedure for discarding old data (for example, PDCP SDU or PDCP PDU) stored in the SRBs configured in the secondary cell group (for example, the PDCP layer device is instructed to discard the data, or an RLC reestablishment procedure). As another method, upon receiving the configuration information or indicator, the UE may resume SRBs included in the secondary cell group (or SN (SCG) terminated SRBs or SRBs having a PDCP layer device configured in the SCG, or SRB3). Alternatively, the UE may perform a data discarding procedure for discarding old data (for example, PDCP SDU or PDCP PDU) stored in the SRBs configured in the secondary cell group (for example, the PDCP layer device is instructed to discard the data, or an RLC reestablishment procedure). For example, with regard to a split bearer having a PDCP layer device configured in the master cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the secondary cell group, or the UE may perform a reestablishment procedure with regard to the RLC layer device configured in the secondary cell group. For example, with regard to a split bearer having a PDCP layer device configured in the secondary cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the master cell group, or may also include an indicator that triggers a PDCP reestablishment procedure (reestablishPDCP) or a PDCP resumption procedure (PDCP resume) in the PDCP layer device configured in the secondary cell group. Alternatively, the UE may perform a reestablishment procedure with regard to the RLC layer device configured in the master cell group, or may perform a PDCP reestablishment procedure or a PDCP resumption procedure (PDCP resume) in the PDCP layer device configured in the secondary cell group. For example, with regard to bearers configured in the secondary cell group, the bearers may be resumed, or the RRC layer device may instruct the PDCP layer device to trigger a PDCP reestablishment procedure or a PDCP resumption procedure, or the PDCP layer device may perform a PDCP reestablishment procedure or a PDCP resumption procedure (PDCP resume). The UE may trigger a first PDCP resumption procedure with regard to bearers configured in the secondary cell group, or may perform the first PDCP resumption procedure in the PDCP layer device. As another method, in order to solve the security issue problem caused by transmission of different pieces of data with the same security key when the secondary cell group is activated or resumed, the UE may trigger a second PDCP resumption procedure with regard to bearers configured in the secondary cell group, or may perform the second PDCP resumption procedure in the PDCP layer device. As another method, if the upper layer device triggered a PDCP layer device resumption procedure, a first PDCP resumption procedure may be triggered and performed. If the upper layer device issued an indicator for triggering a PDCP layer device resumption procedure or activating or resuming a cell group (or cell), a second PDCP resumption procedure may be triggered and performed. As another method, in order to solve the above-mentioned security issue problem caused by transmission of different pieces of data with the same security key, when the base station issued an indicator for activating or resuming a cell group (or cell), the RRC message including the indicator for activating or resuming a cell group (or cell) may include security key configuration information (for example, sk-counter) such that a new security key is configured, and the security key is changed or updated. Alternatively, the RRC message may include a PDCP reestablishment procedure indicator to change or update the security key of bearers configured in the secondary cell group, or the UE may perform a PDCP reestablishment procedure with regard to the bearers. As another method, if security configuration information is included in the message including the instruction to resume or activate a cell group, or if a security configuration information change (or update) is indicated thereby, or if an indicator of a first PDCP resumption procedure is included therein, the UE may trigger a first PDCP resumption procedure with regard to bearers configured in the secondary cell group, or may perform a first PDCP resumption procedure in the PDCP layer device. However, if no security configuration information is included in the message including the instruction to resume or activate a cell group, or if no security configuration information change (or update) is indicated thereby, or if an indicator of a second PDCP resumption procedure is included therein, the UE may trigger a second PDCP resumption procedure with regard to bearers configured in the secondary cell group in order to solve the security issue problem caused by transmission of different pieces of data with the same security key when the secondary cell group is activated or resumed, or may perform a second PDCP resumption procedure in the PDCP layer device. The methods proposed above may be performed when a message including an instruction to suspend or deactivate the cell group is received. In addition, the methods proposed above may be applied to SCG bearers (bearers having a PDCP layer device in the SCG, or SCG terminated bearers).
2> UE operations regarding the PUCCH SCell of the secondary cell group: upon receiving the configuration information or indicator, the UE may activate the PUCCH SCell of the secondary cell group, may activate the uplink BWP or uplink BWP to be the BWP (for example, first active BWP) configured in the RRC message, and may perform a UE operation of the activated SCell or BWP. As another method, upon receiving the configuration information or indicator, if a dormant BWP is configured in the PUCCH SCell of the secondary cell group, the UE may maintain the SCell activated, may activate the downlink BWP of the SCell to be the BWP (for example, first active BWP) configured in the RRC message, and may perform a UE operation in the activated BWP. Alternatively, if there is no dormant BWP configured in the SCell of the secondary cell group, the UE may switch the SCell to an activated state, may activate the downlink BWP or uplink BWP to be the BWP (for example, first active BWP) configured in the RRC message, and may perform a UE operation of the activated SCell or BWP. As another method, upon receiving the configuration information or indicator, the UE may determine to switch or activate or deactivate the state of the SCell or the BWP according to the SCell configuration information or indicator configured in the message including the configuration information or indicator, and may perform a UE operation. As another method, upon receiving the configuration information or indicator, the UE may apply first DRX configuration information configured in the RRC message to the PUCCH SCell (for example, suspend second DRX information and reconfigure the same by first DRX information), and if PDCCH monitoring can be performed, may perform a UE operation in the activated SCell.
2> The UE may transmit an indicator to the master cell group or secondary cell group to indicate a cell group (for example, secondary cell group) was configured or added or activated or resumed or changed or reconfigured. The UE may transmit the indicator to the secondary cell group (or base station) or master cell group (or base station) by using a physical signal (for example, HARQ ACK or NACK or new transmission resource) or a MAC control element or an RRC message.
2> Upon receiving an indicator instructing the same to resume or activate or add a cell group (for example, secondary cell group) or a cell, the UE may trigger a PDCP state report in the PDCP layer device with regard to configured SCG bearers, or bearers connected to the SCG RLC layer device, or SCG split bearers, or MCG bearers, or MCG split bearers such that the same is reported to the base station. This is because, by transmitting the PDCP state report, data lost between the UE and the base station, or the state of window parameters can be identified, thereby synchronizing between the transmitting and receiving windows.
1> If the UE receives configuration information or an indicator for releasing or deactivating or reconfiguring or suspending the dual connectivity or a cell group (for example, secondary cell group) or a cell (for example, through DCI of the PDCCH or a MAC control element or an RRC message), the UE may perform some of the following procedures:
2> The upper layer device (for example, RRC layer device) may indicate the configuration information or indictor to the lower layer device (for example, PDCP layer device or RLC layer device or MAC layer device or PHY layer device).
2> The UE's operation regarding the PSCell: upon receiving the configuration information or indicator, the UE may maintain the PSCell activated, may activate the downlink BWP of the PSCell to be the dormant BWP configured in the RRC message and may perform a UE operation in the dormant BWP. As another method, upon receiving the configuration information or indicator, the UE may maintain the PSCell activated, may reconfigure or switch the PDCCH monitoring cycle or DRX configuration cycle of the PSCell to a substantially long cycle, based on second DRX configuration information, may perform PDCCH monitoring, and may perform the activated cell's UE operation. As another method, upon receiving the configuration information or indicator, the UE may deactivate the PSCell and may perform a deactivated cell's UE operation. The UE's power consumption may be reduced by performing UE operations regarding the PSCell in a method as described above.
2> UE operations regarding the SCell of the secondary cell group: upon receiving the configuration information or indicator, the UE may deactivate the SCell of the secondary cell group, and may perform the deactivated SCell's UE operation. As another method, if the UE receives the configuration information or indicator, and if there is a dormant BWP configured in the SCell of the secondary cell group, the UE may maintain the SCell activated, may activate the downlink BWP of the SCell to be a dormant BWP, and may perform a UE operation in the dormant BWP. Alternatively, if there is no dormant BWP configured in the SCell of the secondary cell group, the UE may switch the SCell to a deactivated state, and may perform a UE operation in the deactivated cell or BWP. As another method, upon receiving the configuration information or indicator, the UE may determine to switch or activate or deactivate the state of the SCell or the BWP according to the SCell configuration information or indicator configured in the message including the configuration information or indicator, and may perform a UE operation.
2> UE operations of the MAC layer device regarding the secondary cell group: upon receiving the configuration information or indicator, the UE may perform a reset procedure (MAC reset) with regard to the MAC layer device (for example, configuration information configured for the MAC layer device may be reset or cleared, configured timers may be suspended or reset, or the HARQ procedure may be suspended or reset). For example, it may be considered that the timing advance timer (TAT) timer that indicates the validity of signal synchronization between the UE and the base station is suspended or expired. As another method, in order to prevent data loss due to the MAC layer device's reset procedure, the UE may perform a MAC partial reset process upon receiving the configuration information or indicator (or if the message including the configuration information or indicator includes an indicator indicating a MAC partial reset process, the MAC partial reset process may be performed). For example, the timing advance timer (TAT) timer that indicates the validity of signal synchronization between the UE and the base station may be continuously maintained, or HARQ retransmission that is being retransmitted may be continuously performed. As another method, no procedure may be performed with regard to the MAC layer device, and the current configuration may be maintained. If the TAT timer is continuously maintained, and if the TAT timer expires, the UE may perform a random access procedure even if the secondary cell group is suspended or deactivated, thereby again adjusting or configuring the timing advance (TA). When performing the random access procedure, the UE may send an indicator to the base station to indicate that the same was a random access procedure for adjusting the TA (for example, a buffer state report (MAC control element) may be included and transmitted to indicate that there is no data to transmit, or a new indicator may be introduced). Alternatively, the base station may transmit a message including an instruction to suspend or deactivate the cell group again to the UE after completing the random access procedure. Alternatively, the UE may maintain the cell group suspended or deactivated after completing the random access procedure (as another method, without the base station's instruction, the UE may autonomously maintain the cell group suspended or deactivated). As another method, if the TAT timer is continuously maintained, and if the TAT timer expires, the master cell group or secondary cell group may trigger a random access procedure (for adjusting or reconfiguring the TA) by the UE through a cell (PCell or SCell or PSCell) because the base station is driving the same TAT timer, or may transmit a message including an indicator to resume or activate the cell group to the UE.
2> Operations regarding the data radio bearer (DRB) configured in the secondary cell group (or a bearer that uses an RLC UM mode or a bearer that uses an RLC AM mode): upon receiving the configuration information or indicator, the UE may suspend DRBs included in the secondary group (or an SN (SCG) terminated DRB or a DRB having a PDCP layer device configured in the SCG or a bearer using an RLC UM mode or a bearer using an RLC AM mode). For example, with regard to a split bearer having a PDCP layer device configured in the master cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the secondary cell group, or may also include an indicator that triggers a PDCP data recovery procedure in the PDCP layer device configured in the master cell group, or the UE may perform a reestablishment procedure with regard to the RLC layer device configured in the secondary cell group, or may perform a PDCP data recovery procedure in the PDCP layer device configured in the master cell group. For example, with regard to a split bearer having a PDCP layer device configured in the secondary cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the master cell group, or may also include an indicator that triggers a PDCP reestablishment procedure (reestablishPDCP) or a PDCP suspension procedure (PDCP suspend) in the PDCP layer device configured in the secondary cell group. Alternatively, the UE may perform a reestablishment procedure with regard to the RLC layer device configured in the master cell group, or may perform a PDCP reestablishment procedure or a PDCP suspension procedure (PDCP suspend) in the PDCP layer device configured in the secondary cell group. For example, with regard to bearers configured in the secondary cell group (for example, bearers using the RLC UM mode or bearers using the RLC AM mode), the bearers may be suspended, or the RRC layer device may instruct the PDCP layer device to trigger a PDCP reestablishment procedure or a PDCP suspension procedure, or the PDCP layer device may perform a PDCP reestablishment procedure or a PDCP suspension procedure (PDCP suspend). The UE may trigger a first PDCP suspension procedure with regard to bearers configured in the secondary cell group (or bearers using the RLC UM mode or bearers using the RLC AM mode), or may perform the first PDCP suspension procedure in the PDCP layer device. As another method, in order to solve the security issue problem caused by transmission of different pieces of data with the same security key when the secondary cell group is activated or resumed, the UE may trigger a second PDCP suspension procedure with regard to bearers configured in the secondary cell group (or bearers using the RLC UM mode or bearers using the RLC AM mode), or may perform the second PDCP suspension procedure in the PDCP layer device. As another method, if the upper layer device triggered a PDCP layer device suspension procedure, a first PDCP suspension procedure may be triggered and performed. If the upper layer device issued an indicator for triggering a PDCP layer device suspension procedure or deactivating or suspending a cell group (or cell), a second PDCP suspension procedure may be triggered and performed. As another method, if security configuration information is included in the message including the instruction to suspend or deactivate a cell group, or if a security configuration information change (or update) is indicated thereby, or if an indicator of a first PDCP suspension procedure is included therein, the UE may trigger a first PDCP suspension procedure with regard to bearers configured in the secondary cell group (or bearers using the RLC UM mode or bearers using the RLC AM mode), or may perform a first PDCP suspension procedure in the PDCP layer device. However, if no security configuration information is included in the message including the instruction to suspend or deactivate a cell group, or if no security configuration information change (or update) is indicated thereby, or if an indicator of a second PDCP suspension procedure is included therein, the UE may trigger a second PDCP suspension procedure with regard to bearers configured in the secondary cell group (or bearers using the RLC UM mode or bearers using the RLC AM mode) in order to solve the security issue problem caused by transmission of different pieces of data with the same security key when the secondary cell group is activated or resumed, or may perform a second PDCP suspension procedure in the PDCP layer device. The methods proposed above may be performed when a message including an instruction to resume or activate the cell group is received. In addition, the methods proposed above may be applied to SCG bearers (bearers having a PDCP layer device in the SCG, or SCG terminated bearers).
2> Operations regarding the signaling radio bearer (SRB) configured in the secondary cell group: the UE may receive the configuration information or indicator and may activate the PSCell. Alternatively, if the activated downlink BWP of the PSCell is a normal BWP which is not a dormant BWP, or if the activated PSCell monitors the PDCCH at a long cycle, based on second DRX configuration information, the UE may continuously maintain SRBs included in the secondary cell group (or SN (SCG) terminated SRBs or SRBs having a PDCP layer device configured in the SCG, or SRB3) without suspending the same (for example, the UE may continuously transmit or receive control messages with the secondary base station). Alternatively, the UE may perform a data discarding procedure for discarding old data (for example, PDCP SDU or PDCP PDU) stored in the SRBs configured in the secondary cell group (for example, the PDCP layer device is instructed to discard the data, or an RLC reestablishment procedure). As another method, upon receiving the configuration information or indicator, the UE may suspend SRBs included in the secondary cell group (or SN (SCG) terminated SRBs or SRBs having a PDCP layer device configured in the SCG, or SRB3). Alternatively, the UE may perform a data discarding procedure for discarding old data (for example, PDCP SDU or PDCP PDU) stored in the SRBs configured in the secondary cell group (for example, the PDCP layer device is instructed to discard the data, or an RLC reestablishment procedure). For example, with regard to a split SRB bearer having a PDCP layer device configured in the master cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the secondary cell group, or may also include an indicator that triggers a PDCP data recovery procedure in the PDCP layer device configured in the master cell group. Alternatively, the UE may perform a reestablishment procedure with regard to the RLC layer device configured in the secondary cell group, or may perform a PDCP data recovery procedure in the PDCP layer device configured in the master cell group. For example, with regard to a split bearer having a PDCP layer device configured in the secondary cell group (a bearer having an RLC layer device configured in the master cell group and having another RLC layer device configured in the secondary cell group), the RRC message including the configuration information or indicator may also include an indicator (reestablishRLC) that triggers a procedure of reestablishing the RLC layer device configured in the master cell group, or may also include an indicator that triggers a PDCP reestablishment procedure (reestablishPDCP) or a PDCP suspension procedure (PDCP suspend) in the PDCP layer device configured in the secondary cell group. Alternatively, the UE may perform a reestablishment procedure with regard to the RLC layer device configured in the master cell group, or may perform a PDCP reestablishment procedure or a PDCP suspension procedure (PDCP suspend) in the PDCP layer device configured in the secondary cell group. For example, with regard to bearers configured in the secondary cell group, the bearers may be suspended, or the RRC layer device may instruct the PDCP layer device to trigger a PDCP reestablishment procedure or a PDCP suspension procedure, or the PDCP layer device may perform a PDCP reestablishment procedure or a PDCP suspension procedure (PDCP suspend). The UE may trigger a first PDCP suspension procedure with regard to bearers configured in the secondary cell group, or may perform the first PDCP suspension procedure in the PDCP layer device. As another method, in order to solve the security issue problem caused by transmission of different pieces of data with the same security key when the secondary cell group is activated or resumed, the UE may trigger a second PDCP suspension procedure with regard to bearers configured in the secondary cell group, or may perform the second PDCP suspension procedure in the PDCP layer device. As another method, if the upper layer device triggered a PDCP layer device suspension procedure, a first PDCP suspension procedure may be triggered and performed. If the upper layer device issued an indicator for triggering a PDCP layer device suspension procedure or deactivating or suspending a cell group (or cell), a second PDCP suspension procedure may be triggered and performed. As another method, if security configuration information is included in the message including the instruction to suspend or deactivate a cell group, or if a security configuration information change (or update) is indicated thereby, or if an indicator of a first PDCP suspension procedure is included therein, the UE may trigger a first PDCP suspension procedure with regard to bearers configured in the secondary cell group, or may perform a first PDCP suspension procedure in the PDCP layer device. However, if no security configuration information is included in the message including the instruction to suspend or deactivate a cell group, or if no security configuration information change (or update) is indicated thereby, or if an indicator of a second PDCP suspension procedure is included therein, the UE may trigger a second PDCP suspension procedure with regard to bearers configured in the secondary cell group in order to solve the security issue problem caused by transmission of different pieces of data with the same security key when the secondary cell group is activated or resumed, or may perform a second PDCP suspension procedure in the PDCP layer device. The methods proposed above may be performed when a message including an instruction to resume or activate the cell group is received. In addition, the methods proposed above may be applied to SCG bearers (bearers having a PDCP layer device in the SCG, or SCG terminated bearers).
2> UE operations regarding the PUCCH SCell of the secondary cell group: upon receiving the configuration information or indicator, the UE may deactivate the PUCCH SCell of the secondary cell group, and may perform a UE operation of the deactivated SCell. As another method, upon receiving the configuration information or indicator, if a dormant BWP is configured in the PUCCH SCell of the secondary cell group, the UE may maintain the SCell activated, may activate the downlink BWP of the SCell to be a dormant BWP, and may perform a UE operation in the dormant BWP. Alternatively, if there is no dormant BWP configured in the SCell of the secondary cell group, the UE may switch the SCell to a deactivated state and may perform a UE operation in the deactivated cell or BWP. As another method, upon receiving the configuration information or indicator, the UE may determine to switch or activate or deactivate the state of the SCell or the BWP according to the SCell configuration information or indicator configured in the message including the configuration information or indicator, and may perform a UE operation. As another method, upon receiving the configuration information or indicator, the UE may apply second DRX configuration information configured in the RRC message to the PUCCH SCell, and if PDCCH monitoring can be performed based on a long cycle, may perform a UE operation in the activated SCell.
2> The UE may transmit an indicator to the master cell group or secondary cell group to indicate a cell group (for example, secondary cell group) or a cell was suspended or deactivated or released or changed. The UE may transmit the indicator to the secondary cell group (or base station) or master cell group (or base station) by using a physical signal (for example, HARQ ACK or NACK or new transmission resource) or a MAC control element or an RRC message.
2> Upon receiving an indicator instructing the same to suspend or deactivated or release a cell group (for example, secondary cell group) or a cell, the UE may trigger a PDCP state report in the PDCP layer device with regard to configured SCG bearers, or bearers connected to the SCG RLC layer device, or SCG split bearers, or MCG bearers, or MCG split bearers such that the same is reported to the base station. This is because, by transmitting the PDCP state report, data lost between the UE and the base station, or the state of window parameters can be identified, thereby synchronizing between the transmitting and receiving windows.

As another method, the PDCP suspension procedures proposed in the disclosure may be applied only to bearers (UM DRB) which use an RLC UM mode belonging to (or configured in) the cell group (or SCG) when the cell or cell group state is configured as a deactivated state. For example, the bearers (UM DRB) which use the RLC UM mode belonging to (or configured in) the cell group (or SCG) may be suspended when the cell or cell group state is configured as a deactivated state, and the PDCP suspension procedures proposed in the disclosure may be triggered with regard to PDCP layer devices of the bearers (UM DRB) which use the RLC UM mode belonging to (or configured in) the cell group (or SCG), or may be indicated to be performed, or may be performed. This is because, if the bearers (UM DRB) which use the RLC UM mode are not suspended, or if the PDCP suspension procedure is not performed, data may be generated with regard to the bearers in advance, and if the security key is changed when the cell group is activated, a PDCP reestablishment procedure or RLC reestablishment procedure is triggered, thereby discarding all data generated in advance, and the PDCP reestablishment procedure performs no retransmission procedure with regard to the bearers (UM DRB) which use the RLC UM mode, thereby causing data loss inside the UE. Therefore, in order to prevent such data loss, the bearers (UM DRB) which use the RLC UM mode belonging to (or configured in) the cell group (or SCG) may be suspended when the cell or cell group state is configured as a deactivated state, and the PDCP suspension procedures proposed in the disclosure may be triggered with regard to PDCP layer devices of the bearers (UM DRB) which use the RLC UM mode belonging to (or configured in) the cell group (or SCG), or may be indicated to be performed, or may be performed. In contrast, the PDCP suspension procedures proposed in the disclosure may not be applied to bearers (AM DRB) which uses an RCL AM mode belonging to (or configured in) the cell group (or SCG) when the cell or cell group state is configured as a deactivated state. For example, data may be generated in advance with regard to the bearers (AM DRB) which uses the RCL AM mode belonging to (or configured in) the cell group (or SCG) when the cell or cell group state is configured as a deactivated state, thereby shortening the data processing time if there is no security key change (for example, only transmission may be suspended with regard to the cell group). In addition, if the security key is changed when the cell group is activated, a PDCP reestablishment procedure or an RLC reestablishment procedure is triggered, thereby discarding all data generated in advance, but the PDCP reestablishment procedure performs a retransmission procedure with regard to the bearers (AM DRB) which use the RLC AM mode, thereby causing no data loss. As another method, if the security key is changed (or will be changed) when the cell or cell group is activated, the proposed bearer suspension or PDCP suspension procedure may be performed with regard to each bearer (UM DRB or AM DRB) when deactivation is indicated with regard to the cell or cell group. If the security key is not changed (or will not be changed) when the cell or cell group is activated, the proposed bearer suspension or PDCP suspension procedure may not be performed with regard to each bearer (UM DRB or AM DRB) when deactivation is indicated with regard to the cell or cell group (for example, only transmission may be suspended with regard to the cell group).

As another method, the base station may define a new indicator in the RRC message (for example, RRCReconfiguration) so as to indicate, with regard to respective bearers (UM DRB or AM DRB), whether or not to suspend the bearers, or whether or not to perform a PDCP suspension procedure. The UE may receive the RRC message and, if the indicator indicates a bearer suspension or PDCP suspension procedure with regard to a bearer, may perform the proposed procedures.

The partial reset of the MAC layer device proposed in the disclosure may include one or multiple UE operations among the following procedures:
The UE performs an operation of flushing remaining HARQ processes (that is, normal HARQ processes or HARQ processes for system information) other than the HARQ process for MBS, among HARQ processes configured for the serving cell, and performs an operation of emptying (flushing) or clearing (flushing) or resetting (flushing) the HARQ process for MBS after handover completion or after an RRC state mode transition (to an RRC deactivated mode or RRC idle mode), or omitting the flushing.
In the case of flushing operation, at a timepoint at which the target base station becomes able to receive the MBS service after handover completion or after an RRC state mode transition (to an RRC deactivated mode or RRC idle mode), or at a timepoint at which G-RNTI monitoring starts, data of the HARQ process related to the MBS may be flushed. Alternatively, data may be continuously received through the G-RNTI until the handover is completed, or until the RRC state mode transition (to an RRC deactivated mode or RRC idle mode) is completed. In the case of handover, an operation of monitoring the -C-RNTI in the target allocated through the RRC message may be performed by the target base station. As another method, data may be continuously received through the G-RNTI even before the random access is completed from the target base station.
If there is a random access procedure that is being performed, it may be suspended.
Specifically, if there is a configured or indicated preamble identifier or preamble configuration information or PRACH (random access configuration-related information) configuration information, it may be discarded.
If there is a temporary cell identifier (C-RNTI), it may be cleared.
The buffer for message3 transmission may be flushed.
All new data indicators regarding the HARQ process regarding the uplink may be configure to be 0.
If the uplink DRX retransmission timer is being driven with regard to the uplink, it may be suspended.
If all uplink HARQ-related timers are being driven, they may be suspended.
All TAT timers (for example, TAT timers related to the secondary timing advance group (STAG)) other than the TAT (TimeAlignmentTimer) related to the cell (PSCell) or primary timing advance group (PTAG) are considered as expired or are suspended (if the TAT timers have been configured). For example, the TAT timer related to the PTAG may be continuously maintained without being suspended such that, when the UE reactivates the cell or cell group, the same can be quickly activated without a random access procedure. In addition, the TAT timer related to the secondary timing advance group (STAG) may be suspended or considered as expired, thereby removing unnecessary UE procedures (if the TAT timers have been configured). If the TAT (TimeAlignmentTimer) related to the primary timing advance group (PTAG) expired in the deactivated cell or cell group, the MAC layer device may inform the upper layer device (for example, RRC layer device) that the TAT expired. Alternatively, if the TAT (TimeAlignmentTimer) related to the primary timing advance group (PTAG) expired in the deactivated cell or cell group, the UE may suspend the beam failure detection procedure or RLM procedure (or may consider that a beam failure occurred, or that the radio link is invalid). As another method, upon detecting a beam failure, the UE may suspend the TAT timer related to the PTAG (or consider the same as expired), or may suspend the RLM procedure. As another method, upon detecting a radio link failure, the UE may suspend the TAT timer related to the PTAG (or consider the same as expired), or may suspend the beam failure detection procedure (or consider that a beam failure occurred).

When the MAC layer device reset procedure is performed, or if no partial reset procedure indicator of the MAC layer device is included or indicated or performed, the UE may perform the entire MAC layer device's reset procedure, and the UE may thus flush all normal HARQ processes or HARQ processes for MBS or HARQ processes for system information.

Next, the disclosure proposes procedures of the MAC layer device to be performed by a UE if a cell group (or SCG) is configured as a deactivated state through an RRC message with regard to a UE for which dual connectivity is configured as proposed above, or if a beam failure detection procedure is configured, or if an RLM procedure is configured. For example, it is proposed that the UE perform a different beam failure detection procedure or beam failure recovery procedure according to whether the cell group state configured through the RRC message is a deactivated state or an activated state.
1> If the UE received an RRC message, and if a beam failure detection procedure or a first BFR procedure or a second BFR procedure is configured in the RRC message, or if the cell (PSCell or SCell) or cell group for which the beam failure detection procedure is not configured in a deactivated state (or is configured in an activated state),
2> The UE performs a beam failure detection procedure.
2> If a beam failure is detected with regard to the cell (PSCell or SCell) or cell group,
3> The first BFR procedure or second BFR procedure proposed in the disclosure is performed.
2> If a problem in the random access procedure is detected due to a beam failure,
3> The UE reports the random access procedure problem due to the beam failure to the base station.
1> Else if the UE received an RRC message, and if a beam failure detection procedure or a first BFR procedure or a second BFR procedure is configured in the RRC message, or if the cell (PSCell or SCell) or cell group (for example, SCG) is configured in a deactivated state, and if a beam failure detection procedure or a first BFR procedure or a second BFR procedure is configured with regard to the cell group, or if the cell or cell group for which a beam failure detection procedure is configured is configured in a deactivated state,
2> The UE performs a beam failure detection procedure.
2> If a beam failure is detected with regard to the cell (PSCell or SCell) or cell group,
3> The first BFR procedure or second BFR procedure proposed in the disclosure is not performed. This is because an unnecessary random access procedure may be triggered with regard to the deactivated cell group. The MAC layer device may indicate or report beam failure detection to the upper layer device (or RRC layer device).
2> If a beam failure is detected with regard to the deactivated cell group (SCG) or cell (PSCell) or MAC layer device,
3> The UE reports the beam failure to the base station (or MCG). For example, an SCG failure report message (SCGFailureInformation) including the beam failure may be transmitted to the base station to report the same.
2> If a problem in the random access procedure is detected due to a beam failure,
3> The UE reports the random access procedure problem due to the beam failure to the base station.

The disclosure proposes a detailed procedure regarding the proposed beam failure detection procedure of the MAC layer device of the UE if the beam failure detection procedure is configured in the RRC message.
1> If an indication that a beam failure occurred is received from the lower layer device,
2> A timer for beam failure detection (BeamFailureDetectionTimer) may be started or restarted. (The timer may be configured in the RRC message.)
2> The value of a parameter for counting the number of beam failures (BFI_COUNTER) is increased by 1.
2> If the value of the parameter for counting the number of beam failures is larger than or equal to the maximum number of beam failures (beamFailureInstanceMaxCount) (the maximum number of beam failures may be configured in the RRC message),
3> If the serving cell (the cell in which a beam failure occurred) is an SCell,
4> A beam failure recovery (BFR) procedure may be triggered or performed with regard to the cell.
3> Else if the serving cell (the cell in which a beam failure occurred) is a PSCell or a deactivated cell group or deactivated cell group's cell (PSCell),
4> The upper layer device (for example, RRC layer device) may be informed that a beam failure occurred with regard to the cell.
4> The TAT (TimeAlignmentTimer) timer corresponding (or related) to the primary timing advance group (PTAG) may be considered as expired. Alternatively, the TAT timer related to the PTAG may be suspended. This is because, if a beam failure occurred with regard to a deactivated cell group or cell, the TA value may be deemed to be no longer valid, and it is thus unnecessary to drive the TAT timer. Alternatively, the RLM procedure may also be suspended, or a radio link failure may be announced. This is because, if a beam failure occurred with regard to a deactivated cell group or cell, the radio link may be deemed to be no longer valid.
3> Else,
A random access procedure may be started or performed with regard to the SpCell.

The beam failure recovery (BFR) procedure proposed in the disclosure is as follows:

In the disclosure, the first BFR procedure (for example, Rel-15 BFR (beam failure recovery)) is possible only with regard to the PCell or SpCell. That is, if a beam failure occurs in a connected mode UE, a random access procedure is performed. The random access procedure follows whether a preamble for BFR is configured in the RRC message. The preamble may be configured for each beam. If the preamble for BFR is configured, a search space for BFR is also configured. If the preamble for BFR is configured, CFRA is performed. That if, if a failure occurs in beam no. 1, the beam is searched for. If a beam is deemed valid in beam no. 3, it is identified whether a preamble for BFR is configured for beam no. 3, and if configured, the preamble is used to perform CFRA. A response is awaited, and the PDCCH is monitored in the configured search space. The base station is informed through the preamble that a beam failure occurred if the UE performs random access, and give the UE scheduling (DL assignment or UL grant) through the PDCCH. The UE then continuously transmits or receives data in the beam, and the beam is recovered. (The base station accurately knows the beam failure in the case of CFRA, and there is no need to transmit an RAR for TA reconfiguration.)

If no preamble for BFR is configured in the RRC message, the UE performs CBRA. That is, if a beam failure occurs in beam no. 1, the beam is searched for. If a beam is deemed valid in beam no. 3, it is identified whether a preamble for BFR is configured for beam no. 3, and if not configured, CBRA is performed. A response is then awaited, and an RAR is awaited. The base station gives an RAR without knowing why the UE suddenly did a random access, and completes the random access procedure. The UE then transmits/receives data in the beam according to a PDCCH instruction, and the beam is recovered.

The BeamFailureRecovery Config regarding the first BFR procedure (for example, Rel-15 BFR (beam failure recovery)) or SpCell is configured for the UL BWP. This is because, if BFR is triggered, a BFR dedicated preamble may be configured. For CFRA

The second BFR procedure of the disclosure (Rel-16 BFR) is possible not only for the SpCell, but also for the SCell. A dedicated scheduling request (SR) (Or transmission resource of the PUCCH) for BFR may be configured for each cell and for each BWP through the RRC message. If a beam failure occurs with regard to a BWP of the SCell, a BFR MAC CE is generated. In addition, if beam failure occurs with regard to the BWP, and if the dedicated SR has been configured (PCell or PUCCH SR), the UE transmits the SR in the PUCCH. If the dedicated SR continuously fails to report the beam failure, the UE performs random access procedure according to CBRA. If the SR number is exceeded, only CBRA may be performed likewise even if a BSR is send based on the legacy. The random access procedure is performed in the PCell. Therefore, the UE may optionally report a valid beam with regard to each SCell if the UE discovered which SCell has a failure when the MAC CE is sent through the PCell with regard to the SCell, and if the UE discovered a valid one among TCI sets (or TCI states) configured by RRC. If the UE sent a MAC CE including a valid beam with regard to the SCell, and if a HARQ ACK is received with regard to a MAC PDU including the MAC CE, the UE and the base station uses the valid beam with regard to the SCell. If the MAC CE includes no valid beam with regard to the SCell, the base station may designate a beam through DCI of the PDCCH or a TCI state MAC CE as a response.

In addition, in the second BFR procedure (Rel-16 BFR), the BFR procedure regarding the SpCell may be improved as well.

For example, the second BFR procedure (Rel-16 BFR) is possible with regard to the PCell or SpCell similarly to Rel-15. That is, if a beam failure occurs, the UE performs a random access procedure. The random access procedure differs depending on whether a preamble for BFR is configured or not. The preamble may be configured for each beam. If the preamble for BFR is configured, a search space for BFR is also configured. If the preamble for BFR is configured, the UE performs CFRA by the preamble. That if, if a failure occurs in beam no. 1, the UE searches for the beam. If a beam is deemed valid in beam no. 3, it is identified whether a preamble for BFR is configured for beam no. 3, and if configured, CFRA is performed. The UE awaits a beam response, and monitors the PDCCH in the configured search space. The base station is informed through the preamble that a beam failure occurred if the UE performs random access, and gives the UE scheduling (DL assignment or UL grant) through the PDCCH. The UE then continuously transmits or receives data in the beam, and the beam is recovered. (The base station accurately knows the beam failure in the case of CFRA, and there is no need to transmit an RAR for TA reconfiguration.)

If no preamble for BFR is configured, the UE performs CBRA. That is, if a beam failure occurs in beam no. 1, the UE searches for the beam. If a beam is deemed valid in beam no. 3, it is identified whether a preamble for BFR is configured for beam no. 3, and if not configured, CBRA is performed. The UE awaits a response and awaits an RAR. The base station gives an RAR without knowing why suddenly did a random access. The UE receives the RAR, generates a BFR MAC CE, and transmits the same in Msg3. The MAC CE cannot include a valid beam with regard to the SpCell. This is because, with regard to the BFR that occurred in the PCell, the BFR MAE CE is sent by the PCell, unlike the SCell. That is, if a beam failure occurs in the PCell, the UE searches for a valid beam and shoots a preamble with regard to the valid beam. Therefore, the base station and the UE already know a valid beam with regard to the PCell in the random access procedure. That is, a valid beam is already included. Therefore, if the random access procedure is completed, the UE transmits/receives data in beam no. 3, and the beam is recovered.

That is, if BFR is triggered with regard to the Rel-16 SpCell, random access triggered unconditionally regardless of the SR, and a BFR MAC CE is configured and transmitted (if there is no configured preamble for BFR). In the RRC message regarding the Rel-16 BFR or SCell, BeamFailureRecoverySCellConfig is configured for the DL BWP. This is for the purpose of configuring a candidate RS that may be included in the BFR MAC CE if BFR is triggered. The dedicated SR for SCell BFR is included in MAC-CellGroupConfig in the RRC message (configured in schedulingRequestConfig).

In addition, the base station may configure a beam failure RS in the RRC message such that the UE can identify a beam failure. If any failure occurs in the RS, the UE detects a beam failure and performs a random access procedure.

If the base station pre-configured a preamble for beam failure recovery, the UE performs CFRA as the random access procedure, and the base station may know that the UE performed a random access procedure for beam recovery with reference to the preamble.

However, if the base station pre-configured no preamble for beam failure recovery, the UE performs CBRA. The base station cannot distinguish this from a case in which BSR is triggered to transmit uplink data with no configured SR, and a random access procedure is triggered. However, the base station may confirm one between the two by recognizing that the UE suddenly performed a random access procedure. If there is a BSR, BSR information is received. If there is none, BFR is identified. Even if the two cases are triggered simultaneously, the BSR may be read, and the base station can implicitly make a determination with reference to the preamble. When reading the SSB, the UE may know how many beams are transmitted at what cycle, at what time, and through what frequency resource. With regard to a beam exceeding a specific reference as a result of beam strength measurement, a random access procedure may be performed. If a beam is selected, random access may be performed with regard to the beam in consideration of the time/frequency resource or cycle.

Next, the disclosure proposes procedures to be performed by the UE if a cell group's state is configured as an activated state or deactivated state, or if the PSCell of the cell group is configured in an activated state or deactivated state. The UE may receive an indication regarding an activated state or deactivated state through an RRC message (RRCReconfiguration or RRCResume) or a MAC control element or a PDCCH DCI, with regard to a cell group or cell (PSCell). For example, if a deactivated state is configured in the RRC message (RRCReconfiguration or RRCResume) or MAC control element or PDCCH DCI, the cell group (or SCG) or cell (or PSCell) may be deactivated. If no deactivated state is configured (or if an activated state is configure) in the RRC message (RRCReconfiguration or RRCResume) or MAC control element or PDCCH DCI, the cell group or cell may be activated.

UE operations regarding a case in which an instruction to activate a cell group or cell is received (or no deactivation instruction is received) are as follows:
If an instruction to activate the UE's cell group (or SCG) or cell (or PSCell) is received through DCI (L1 control signal) of the PDCCH or a MAC CE or an RRC message (or if no deactivation instruction is received), one of the following operations or multiple operations may be performed:
The cell group or cell is activated.
The uplink BWP or downlink BWP (for example, first active downlink BWP or first active uplink BWP) configured in the RRC message is switched to or activated. As another method, if a random access procedure is performed (or if reconfigurationWithSync is configured or if a beam failure is detected or if a radio link failure is detected or if a TAT timer is not being driven (or expired)) such that the cell group or cell is activated, the uplink BWP or downlink BWP (for example, first active downlink BWP or first active uplink BWP or newly defined BWP) configured in the RRC message is switched to or activated. In addition, if a random access procedure is performed, the random access procedure may be performed in the BWP. However, if no random access procedure is performed (or if configured to perform no random access procedure or if no beam failure is detected or if no radio link failure is detected or if a TAT timer is being driven (or not expired)), the UE may activate the BWP activated previously (or lastly).
A sounding reference signal (SRS) is transmitted such that the base station can perform channel measurement regarding the uplink in the activated BWP. For example, the same may be transmitted periodically.
If there is a PUCCH configured in the activated BWP, PUCCH transmission is performed.
If there is a suspended type 1 configuration transmission resource, the stored type 1 transmission resource may be reset and used according to the original configuration. The type 1 configuration transmission resource refers to a periodic transmission resource (uplink or downlink) allocated in advance through an RRC message, and may be activated through an RRC message and then used.
A PHR is triggered with regard to the BWP. The PHR may be triggered with regard to the MCG or SCG. The PHR may also be reported to the MCG or SCG.
In the activated BWP, the UE may report a channel measurement result (CSI or CQI or PMI or RI or PTI or CRI or the like) according to the base station configuration with regard to the downlink.
The PDCCH monitored to read the base station's instruction in the activated BWP.
The PDCCH monitored to read cross-scheduling regarding the activated BWP.
The BWP inactivity timer is started or restarted. As another method, the BWP inactivity timer may be started or restarted only if there is no configured BWP inactivity timer. If the BWP inactivity timer can be configured through an RRC message, the BWP may be switched to a dormancy or dormant BWP when the timer expires. For example, the BWP inactivity timer may be started or restarted with regard to a dormant BWP only.

UE operations when an instruction to deactivate a cell group or a cell is received in the disclosure are as follows:
If an instruction to deactivate the UE's cell group (or SCG) or cell (or PSCell) is received through DCI (L1 control signal) of the PDCCH or a MAC CE or an RRC message), one of the following operations or multiple operations may be performed:
The cell group or cell or the indicated uplink or downlink BWP is deactivated.
All TAT timers (for example, TAT timers related to the secondary timing advance group (STAG)) other than the TAT (TimeAlignmentTimer) related to the cell (PSCell) or primary timing advance group (PTAG) are considered as expired or are suspended (if the TAT timers have been configured). For example, the TAT timer related to the PTAG may be continuously maintained without being suspended such that, when the UE reactivates the cell or cell group, the same can be quickly activated without a random access procedure. In addition, the TAT timer related to the secondary timing advance group (STAG) may be suspended or considered as expired, thereby removing unnecessary UE procedures (if the TAT timers have been configured). If the TAT (TimeAlignmentTimer) related to the primary timing advance group (PTAG) expired in the deactivated cell or cell group, the MAC layer device may inform the upper layer device (for example, RRC layer device) that the TAT expired. Alternatively, if the TAT (TimeAlignmentTimer) related to the primary timing advance group (PTAG) expired in the deactivated cell or cell group, the UE may suspend the beam failure detection procedure or RLM procedure (or may consider that a beam failure occurred, or that the radio link is invalid). As another method, upon detecting a beam failure, the UE may suspend the TAT timer related to the PTAG (or consider the same as expired), or may suspend the RLM procedure. As another method, upon detecting a radio link failure, the UE may suspend the TAT timer related to the PTAG (or consider the same as expired), or may suspend the beam failure detection procedure (or consider that a beam failure occurred).
The UE suspends the BWP inactivity timer (for example, inactivity timer for the downlink BWP) which is configured for the cell or BWP and currently driven.
The UE may clear a periodic downlink transmission resource (DL SPS or configured downlink assignment) configured for the cell or BWP or a periodic uplink transmission resource (UL SPS or configured uplink grant Type 2) configured therefor. As used herein, “to clear” means that configuration information such as cycle information configured in the RRC message is stored in the UE, but information regarding a periodic transmission resource indicated or activated through L1 signaling (for example, DCI) is removed and no longer used. The periodic transmission resource may also be referred to as a type 2 configuration transmission resource. In addition, the operation of clearing the periodic transmission resource may be performed only when the Scell transitions from an activated state to a deactivated state. This is because there was no periodic transmission resource in the dormant state when transitioning from a dormant state to a deactivated state, and no clearing operation is thus necessary. As another method, the periodic transmission resources may be cleared only if the periodic downlink transmission resource or periodic uplink transmission resource is configured or configured and used currently.
The periodic uplink transmission resource (configured uplink grant Type 1 configured by RRC) configured for the cell or BWP may be suspended. As used herein, “to suspend” means that transmission resource configuration information configured in the RRC message is stored by the UE but is no longer used. The periodic transmission resource may also be referred to as a type 1 configuration transmission resource. In addition, the operation of clearing the periodic transmission resource may be performed only when the Scell transitions from an activated state to a deactivated state. This is because there was no periodic transmission resource in the dormant state when transitioning from a dormant state to a deactivated state, and no clearing operation is thus necessary. As another method, the periodic transmission resources may be cleared only if the periodic downlink transmission resource or periodic uplink transmission resource is configured or configured and used currently.
All HARQ buffers configured with regard to the cell or BWP are emptied.
If there is a PUSCH transmission resource configured for periodic channel measurement report (semi-persistent CSI reporting) with regard to the cell or BWP, the same is cleared.
The UE transmits no SRS with regard to the cell or BWP.
With regard to the cell or BWP, the UE neither performs nor reports channel measurement (CSI or CQI or PMI or RI or PTI or CRI or the like) with regard to the downlink.
In the cell or BWP, no uplink data is transmitted through the UL-SCH.
No random access procedure with regard to the cell or BWP.
The does not monitor the PDCCH with regard to the cell or BWP. In addition, in the case of cross-scheduling as well, in a scheduled cell, the PDCCH regarding the cell is not monitored.
In the cell or BWP, the UE does not monitor the PDCCH.
In the cell or BWP, no PUCCH or SPUCCH transmission is performed.

The first PDCP suspension (or resumption) procedure proposed in the disclosure may include one or multiple UE operations among the following procedures. The proposed procedure may be applied to or configured for a bearer that uses an RLC UM mode or a bearer that uses an RLC AM mode. Alternatively, the UE may perform the proposed procedure with regard to a bearer that uses an RLC UM mode or a bearer that uses an RLC AM mode.
The UE's transmission PDCP layer device may reset a transmission window parameter or configure the same as an initial value or may discard stored data (for example, PDCP PDU or PDCU SDU). As another method, only the PDCP PDU may be discarded to prevent data loss. This procedure is for preventing transmission or retransmission of old data when the secondary cell group is later activated or resumed.
If a reordering timer (t-reordering) (timer for ordering data in ascending order with reference to the PDCP serial number of COUNT value) is being driven, the UE's reception PDCP layer device may suspend or reset the timer. Alternatively, a header decompression procedure may be performed with regard to stored data (for example, PDCP SDU), and the data may be delivered to the upper layer device in the ascending order of COUNT value. The UE's reception PDCP layer device may reset a reception window parameter or configure the same as an initial value.

The second PDCP suspension (or resumption) procedure proposed in the disclosure may include one or multiple UE operations among the following procedures. The proposed procedure may be applied to or configured for a bearer that uses an RLC UM mode or a bearer that uses an RLC AM mode. Alternatively, the UE may perform the proposed procedure with regard to a bearer that uses an RLC UM mode or a bearer that uses an RLC AM mode.
The UE's transmission PDCP layer device may not reset the transmission window parameter or configure the same as an initial value, but may maintain the parameter value intact. The reason the parameter value (for example, COUNT value) is maintained is to solve the security issue problem caused by transmission of different pieces of data with the same security key (for example, COUNT value) when the secondary cell group is activated or resumed. The UE's transmission PDCP layer device may discard stored data (for example, PDCP PDU or PDCU SDU). As another method, only the PDCP PDU may be discarded to prevent data loss. This procedure is for preventing transmission or retransmission of old data when the secondary cell group is later activated or resumed. As another method, the transmission PDCP layer device may store the value of transmission window parameters and may reset the window parameters (for example, configure the same as 0). The reset window parameters may be used if security configuration information is changed when the cell group is resumed or activated, or if security configuration information is included in a message indicating resumption or activation of the cell group, or if a security key change is indicated. Alternatively, the stored value of transmission window parameters may be restored, or the value of transmission window parameters may be configured or reconfigured or reset with the stored value of transmission window parameters and then used if security configuration information is not changed when the cell group is resumed or activated, or if no security configuration information is included in a message indicating resumption or activation of the cell group, or if no security key change is indicated.
If a reordering timer (t-reordering) (timer for ordering data in ascending order with reference to the PDCP serial number of COUNT value) is being driven, the UE's reception PDCP layer device may suspend or reset the reordering timer. Alternatively, a header decompression procedure may be performed with regard to stored data (for example, PDCP SDU), and the data may be delivered to the upper layer device in the ascending order of COUNT value. The UE's reception PDCP layer device may not reset the reception window parameter or configure the same as an initial value, but may maintain the parameter value intact. The reason the parameter value (for example, COUNT value) is maintained is to solve the security issue problem caused by transmission of different pieces of data with the same security key (for example, COUNT value) when the secondary cell group is activated or resumed. As another method, the UE may configure or update the RX_NEXT window parameter (a parameter indicating the COUNT value of data expected to be received next) to the value of RX_DELIV window parameter ((a parameter indicating the COUNT value of next data of data delivered to the upper layer device) or to the COUNT value of data initially received by the UE such that, when the secondary cell group is activated or resumed, or when data is received, the reordering timer is not instantly trigger even through there is no COUNT value or PDCP serial number gap. As another method, if a reordering timer value is configured in the message, or if an indicator is received from the upper layer device, the RX_REORD window parameter (a parameter indicating the COUNT value of next data of data that triggered the reordering timer) to the value of RX_NEXT window parameter, or may suspend or restart the reordering timer. As another method, the reception PDCP layer device may store the value of reception window parameters and may reset the window parameters (for example, configure the same as 0). The reset window parameters may be used if security configuration information is changed when the cell group is resumed or activated, or if security configuration information is included in a message indicating resumption or activation of the cell group, or if a security key change is indicated. Alternatively, the stored value of reception window parameters may be restored, or the value of reception window parameters may be configured or reconfigured or reset with the stored value of reception window parameters and then used if security configuration information is not changed when the cell group is resumed or activated, or if no security configuration information is included in a message indicating resumption or activation of the cell group, or if no security key change is indicated.

When the UE receives configuration information or an indicator for releasing or deactivating or reconfiguring or suspending the dual connectivity or a cell group (for example, secondary cell group) or a cell (for example, through DCI of the PDCCH or a MAC control element or an RRC message), when the UE performs the proposed UE operations, and if data to be transmitted by the UE through the uplink occurs or is generated, the UE may transmit a scheduling request (SR) or a MAC control element (or an indicator or the amount of buffer or a buffer state report) to the master base station or secondary base station in a transmission resource of a PUCCH configured in the RRC message, thereby requesting an uplink transmission resource or requesting that the dual connectivity or a cell group (for example, secondary cell group) or a cell be configured or added or activated or resumed or changed or reconfigured. As another method, when the UE receives configuration information or an indicator for releasing or deactivating or reconfiguring or suspending the dual connectivity or a cell group (for example, secondary cell group) or a cell (for example, through DCI of the PDCCH or a MAC control element or an RRC message), when the UE performs the proposed UE operations, and if data to be transmitted by the UE through the uplink occurs or is generated, the UE may generate an RRC message and transmit the same to the master base station or secondary base station, thereby requesting an uplink transmission resource or requesting that the dual connectivity or a cell group (for example, secondary cell group) or a cell be configured or added or activated or resumed or changed or reconfigured.

The procedures proposed in the disclosure may be expanded to multi-access technology. For example, configuration information of multiple cell groups may be configured for a UE through an RRC message, and one of multiple configured cell groups or multiple cell groups (or cells) may be activated or resumed by a PDCCH indicator or a MAC control element or an RRC message, or one or multiple cell groups may be suspended or deactivated thereby.

Next, the disclosure proposes UE operations for reactivating or resuming a cell group or a cell if uplink data regarding a secondary cell group is generated or occurs in the UE (or in bearers belonging to the secondary cell group) while the secondary cell group or the secondary cell group's PSCell remains deactivated or suspended by means of the cell group or cell deactivation or suspension procedure proposed in the disclosure.

If a cell group or a cell is deactivated or suspended as proposed in the disclosure, the UE cannot transmit or receive data, and if uplink data is generated in the UE's secondary group (or in bearers belonging to the secondary cell group), the cell group or cell needs to be reactivated or resumed. The procedure in which the UE requests the base station (master base station or secondary base station) to reactivate or resume the cell group or cell may be performed by one of the following methods or by a method expanded by combining or applying the following methods:
First method: the UE composes a message (for example, RRC message) for requesting reactivation or resumption of the secondary cell group or cell and transmits the same to the master base station. Upon receiving the message, the master base station may request the secondary base station perform a resumption procedure similarly to the first signaling procedure in FIG. 1K, may receive a response, may compose a message (for example, RRC message) indicating reactivation or resumption of the secondary cell group, and may transmit the same to the UE. As another method, the master base station may compose a message (for example, RRC message) indicating reactivation or resumption of the secondary cell group similarly to the second signaling procedure in FIG. 1L, and transmit the same to the UE, and may indicate activation or resumption to the secondary base station. As another method, the UE may compose a message (for example, RRC message) requesting reactivation or resumption of the secondary cell group or cell similarly to the third signaling procedure in FIG. 1M, and may transmit the same to the secondary base station through SRB3. The secondary base station may compose a message (for example, RRC message) indicating reactivation or resumption of the secondary cell group, may transmit the same to the UE, and may indicate activation or resumption to the master base station.
Second method: the UE composes a message (for example, MAC control element) for requesting reactivation or resumption of the secondary cell group or cell and transmits the same to the master base station. Upon receiving the message, the master base station may request the secondary base station perform a resumption procedure similarly to the first signaling procedure in FIG. 1K, may receive a response, may compose a message (for example, RRC message or MAC control element) indicating reactivation or resumption of the secondary cell group, and may transmit the same to the UE. As another method, the master base station may compose a message (for example, RRC message or MAC control element) indicating reactivation or resumption of the secondary cell group similarly to the second signaling procedure in FIG. 1L, may transmit the same to the UE, and may indicate activation or resumption to the secondary base station. As another method, the UE may compose a message (for example, RRC message) requesting reactivation or resumption of the secondary cell group or cell similarly to the third signaling procedure in FIG. 1M, and may transmit the same to the secondary base station through SRB3. The secondary base station may compose a message (for example, RRC message or MAC control element) indicating reactivation or resumption of the secondary cell group, may transmit the same to the UE, and may indicate activation or resumption to the master base station. When the MAC control element is used to request or indicate cell group activation or resumption, the MAC control element may be newly defined and designed. As another method, a new field (or indicator) may be defined in an existing MAC control element (for example, buffer state report), or a new value (field value or identifier value) may be defined therein, thereby indicating the same.
Third method: the UE composes a message (for example, a physical signal of a PHY layer device) for requesting reactivation or resumption of the secondary cell group or cell and transmits the same to the master base station. Upon receiving the message, the master base station may request the secondary base station perform a resumption procedure similarly to the first signaling procedure in FIG. 1K, may receive a response, may compose a message (for example, an RRC message or a physical signal of a PHY layer device) indicating reactivation or resumption of the secondary cell group, and may transmit the same to the UE. As another method, the master base station may compose a message (for example, an RRC message or a physical signal of a PHY layer device) indicating reactivation or resumption of the secondary cell group similarly to the second signaling procedure in FIG. 1L, may transmit the same to the UE, and may indicate activation or resumption to the secondary base station. As another method, the UE may compose a message (for example, a physical signal of a PHY layer device) requesting reactivation or resumption of the secondary cell group or cell similarly to the third signaling procedure in FIG. 1M, and may transmit the same to the secondary base station through SRB3. The secondary base station may compose a message (for example, an RRC message or a physical signal of a PHY layer device) indicating reactivation or resumption of the secondary cell group, may transmit the same to the UE, and may indicate activation or resumption to the master base station. When the physical signal of a PHY layer device is used to request or indicate cell group activation or resumption, the physical signal of a PHY layer device may be defined and designed by a new transmission resource (for example, a new scheduling request (SR) transmission resource for the secondary cell group (for example, a PUCCH transmission resource of the PCell or PSCell) or a new field of DCI (a PDCCH transmission resource transmitted from the PSCell or from the PCell) of the PDCCH). As another method, a new field (or indicator) may be defined in an existing physical signal of a PHY layer device (for example, a scheduling request (SR) transmission resource (for example, a PUCCH transmission resource of the PCell or PSCell) or a field of DCI (a PDCCH transmission resource transmitted from the PSCell or from the PCell) of the PDCCH), or a new value (field value or identifier value) may be defined therein, thereby indicating the same. As another method, when the UE applies second DRX configuration information to perform PDCCH monitoring with regard to the PSCell of the secondary cell group with a long cycle, or when the UE's secondary cell group is in a deactivated state or suspended state, and if the PSCell triggers a random access procedure by the UE through DCI of the PDCCH, the UE may interpret the indication as activation or resumption of the secondary cell group. As used herein, a physical transmission resource may refer to a transmission resource for random access. The UE may perform a random access procedure if uplink data regarding the secondary cell group occurs while the secondary cell group remains suspended or deactivated. As another method, if uplink data regarding the secondary cell group occurs while the secondary cell group remains suspended or deactivated, and if there is a configured SR transmission resource (or if a TA timer is being driven), the UE may transmit an SR transmission resource to the master or secondary cell group. If there is no configured SR transmission resource (or if the TA timer expired), the UE may perform a random access procedure. As the random access procedure, a contention-based random access (CBRA) procedure may be performed. As another method, if the message (or previously received message) indicating suspension or deactivation of the cell group has designated random access configuration information (dedicated RACH config or dedicated preamble) configured (or included) therein, the UE may perform a contention-free random access (CFRA) procedure. Alternatively, if the message (or previously received message) indicating deactivation or suspension of the cell group has no designated random access configuration information (dedicated RACH config or dedicated preamble) configured (or included) therein, the UE may perform a contention-based random access (CBRA) procedure. The UE may transmit an indicator (for example, buffer state report (MAC control element)) to the base station to inform that uplink data occurred during the random access procedure or after completion of the random access procedure. Upon receiving the indicator, or if the random access procedure is completed, the base station (for example, secondary or master base station) may transmit a message to the UE to indicate secondary cell group resumption or activation such that the secondary cell group is resumed or activated, and may again transmit or receive data.

Next, the disclosure specific operations of the UE for reactivating or resuming a cell group or a cell if uplink data regarding a secondary cell group is generated or occurs in the UE (or in bearers belonging to the secondary cell group) while the secondary cell group or the secondary cell group's PSCell remains deactivated or suspended by means of the cell group or cell deactivation or suspension procedure proposed in the disclosure.

If uplink data regarding the secondary cell group (or suspended bearers belonging to the cell group) is generated or has occurred, the UE may indicate the data volume of the PDCP layer device (or RLC layer device) regarding the uplink data to the lower layer device (MAC layer device) or upper layer device (RRC layer device). Alternatively, the UE may generate an RRC message for reporting the occurrence of the uplink data or may generate (or trigger) a buffer state report (BSR) (or regular BSR) for reporting the volume of the uplink data to the base station, thereby indicating that uplink data occurred in the UE.
1> If it is indicated that uplink data occurred in the UE through the above method,
2> If uplink data regarding the cell or cell group occurred, and if the message including an instruction to deactivate the cell or cell group has no dedicated PUCCH transmission resource (MCG or SCG's PUCCH or scheduling request (SR) resource) configured (or included) for the purpose of indicating the occurrence,
3> The UE may perform a random access procedure in the cell or cell group and, when performing the random access procedure, the UE may perform the random access procedure (normal random access procedure (four-step random access procedure) or two-step random access procedure (RACH) in consideration of the message or system information) in the BWP determined in the procedure proposed in the disclosure or in the current BWP (or previously activate BWP or lastly activated BWP) or in the first active downlink (or uplink) BWP (firstActiveDownlinkBWP or firstActiveUplinkBWP or newly defined BWP) configured in the message (for example, RRC message) or in the initial BWP (or initial BWP broadcast (or configured) in system information of the cell or cell group). In the random access procedure or after completion of the random access procedure, the UE may transmit the generated RRC message (information indicating the occurrence of uplink data) or a MAC control element (a buffer state report or a new MAC control element) to inform the base station that uplink data was generated with regard to the cell or cell group. As another method, if uplink data regarding the cell or cell group occurred, and if the message including an instruction to deactivate the cell or cell group has a dedicated random access resource (RACH transmission resource or time resource or frequency resource or preamble information) configured for the purpose of indicating the occurrence, the dedicated random access resource may be used in the random access procedure to perform the random access procedure, thereby informing the base station that uplink data was generated with regard to the cell or cell group.
2> If uplink data regarding the cell or cell group occurred, and if the message including an instruction to deactivate the cell or cell group has a dedicated PUCCH transmission resource (MCG or SCG's PUCCH or scheduling request (SR) resource) configured (or included) for the purpose of indicating the occurrence,
3> If the message (or previous message) includes a new indicator (for example, RACH-less indication or second reconfigurationWithcSync) to indicate that no random access procedure is to be performed (Or if reconfigurationWithSync or first reconfigurationWithSync is not configured), or if the TAT (TimeAlignmentTimer) timer (a timer for determining the validity of a timing advance (TA) value for synchronization between the UE and the base station) currently driven in the MAC layer device is being driven (or if the timer has not expired, or if no indication of expiration was received from the lower layer device), or if no indication of beam failure detection was received from the lower layer device (or if no beam failure occurred), or if there is a beam failure detection procedure or RLM procedure configured with regard to a deactivated cell group, or if no radio link failure procedure was detected in the RLM procedure (or if the second timer (T310) has not expired, or if the radio link with the SCG is valid), or if reconfigurationWithSync configuration information is not included in spCellConfig of the SCG in the message (or previous message),
4> The UE may transmit a signal (or SR) through the dedicated PUCCH transmission resource (MCG or SCG's PUCCH or scheduling request (SR) resource) configured with regard to the cell or cell group. When transmitting a signal through the dedicated PUCCH transmission resource (MCG or SCG's PUCCH or scheduling request (SR) resource), the signal may be transmitted in the BWP determined in the procedure proposed in the disclosure or in the current BWP (or previously activate BWP or lastly activated BWP) or in the first active downlink (or uplink) BWP (firstActiveDownlinkBWP or firstActiveUplinkBWP or newly defined BWP) configured in the message (for example, RRC message) or in the initial BWP (or initial BWP broadcast (or configured) in system information of the cell or cell group), thereby informing the base station that uplink data was generated with regard to the cell or cell group. When transmitting the SR transmission resource, SR transmission can be performed the number of times configured in the RRC message. Alternatively, if the SR was transmitted the configured number of times, and if no corresponding response was received from the base station (for example, if PDCCH monitoring performed after SR transmission confirms that no uplink transmission resource was allocated, or if no uplink transmission resource was allocated during a predetermined period of time (or before timer expiration)), the UE may fall back and perform the proposed random access procedure (for example, the random access procedure may be followed if there is no configured dedicated PUCCH transmission resource (MCG or SCG's PUCCH or scheduling request (SR) resource)). The SR transmission may be performed periodically based on a timer, or a predetermined timer may be introduced to prevent SR transmission during a specific time interval (for example, SR retransmission may be possible if the timer expired (of if the timer is not being driven)). The UE may also suspend the timer upon receiving a response from the base station.

Upon transmitting the indication that uplink data occurred with regard to the deactivated cell or cell group to the cell group (MCG or SCG), the UE may wait until a response (for example, MAC control element or RRC message or DCI of PDCH or transmission resource allocation) is received from the base station (MCG or SCG). As another method, if no response is received from the base station during the predetermined period of time (for example, a timer may be introduced and driven, or while the timer is being driven), or before the predetermined period of time elapsed (or before the timer expired), the UE may perform the proposed procedure of indicating that uplink data occurred with regard to the deactivated cell or cell group to the cell group. Upon receiving the indication that uplink data occurred with regard to the deactivated cell or cell group, the base station may transmit a corresponding response (for example, MAC control element or RRC message or DCI of PDCH or transmission resource allocation) to the UE.

When the UE activates or resumes a cell group (for example, secondary cell group) or a cell (for example, PSCell) by a PDCCH or a MAC control element or an RRC message's indicator as proposed in the disclosure, activation or resumption of the cell group or cell may be completed at a first timepoint. The first timepoint may be configured by the RRC message as proposed in the disclosure. For example, the RRC message may include time information indicating when the dual connectivity or the cell group (for example, secondary cell group) or the cell (PSCell or SCG SCell) is to be activated or resumed or deactivated or suspended (for example, information (for example, X) indicating timing, time unit, subframe or time slot or symbol unit). For example, time information may be configured such that, if the PDCCH or MAC control element or RRC message indicating that the dual connectivity or the cell group (for example, secondary cell group) or the cell (PSCell) is to be activated or resumed or deactivated or suspended was received at the n^{th} time unit, the cell group or cell is to be completely activated or resumed or deactivated or suspended at the (n+X)^{th}). As another method, the time information (for example, X) may not be configured by the base station, but a pre-promised and defined fixed value may be used. As another example, time information may be configured such that, if random access is started (or preamble is transmitted) at the n^{th} time unit after receiving the PDCCH or MAC control element or RRC message indicating that cell group (for example, secondary cell group) or cell (PSCell) is to be activated or resumed or deactivated or suspended, or if the random access is successfully completed, the cell group or cell is to be completely activated or resumed or deactivated or suspended at the (n+X)^{th}. As another method, the time information (for example, X) may not be configured by the base station, but a pre-promised and defined fixed value may be used. When the cell group or cell is completely activated or resumed or deactivated or suspended, the UE may perform UE operations proposed in the disclosure according to each cell or BWP's state (for example, activated or dormant or deactivated). In addition, when the cell group or cell is completely activated or resumed, the UE's DRX operation may be started or restarted, or when the cell group or cell is completely deactivated or suspended, the UE's DRX operation may be suspended or deactivated.

In addition, when the UE activates a cell (for example, PSCell or SCell) of a cell group (for example, master cell group or secondary cell group) as instructed by the MAC control element as proposed in the disclosure, activation of the cell may be completed at a second timepoint. The second timepoint may be configured by the RRC message as proposed in the disclosure. For example, the RRC message may include time information indicating when the carrier aggregation or dual connectivity or a cell group (for example, master cell group or secondary cell group) or a cell (MCG PSCell or SCG SCell) is to be activated or deactivated (for example, information (for example, X) indicating timing, time unit, subframe or time slot or symbol unit). For example, time information may be configured such that, if the UE received a MAC control element indicating that a cell (for example, SCell) is to be activated or deactivated at the n^{th} time unit, the cell is to be completely activated or deactivated at the (n+X)^{th}. As another method, the time information (for example, X) may not be configured by the base station, but a pre-promised and defined fixed value may be used. As another example, time information may be configured such that, if random access is started (or preamble is transmitted) at the n^{th} time unit after receiving a MAC control element indicating that a cell (for example, SCell or PSCell) is to be activated or deactivated, or if the random access is successfully completed, the cell is to be completely activated or deactivated at the (n+X)^{th}. As another method, the time information (for example, X) may not be configured by the base station, but a pre-promised and defined fixed value may be used. When the cell group or cell is completely activated or suspended or deactivated or resumed, the UE may perform UE operations proposed in the disclosure according to each cell or BWP's state (for example, activated or dormant or deactivated). In addition, when the cell group or cell is completely activated or resumed, the UE's DRX operation may be started or restarted, or when the cell group or cell is completely deactivated or suspended, the UE's DRX operation may be suspended or deactivated.

In addition, when the UE activates a cell (for example, PSCell or SCell) of a cell group (for example, master cell group or secondary cell group) as instructed by the RRC message as proposed in the disclosure, activation of the cell may be completed at a third timepoint. The third timepoint may be configured by the RRC message as proposed in the disclosure. For example, the RRC message may include time information indicating when the carrier aggregation or dual connectivity or a cell group (for example, master cell group or secondary cell group) or a cell (MCG PSCell or SCG SCell or PSCell) is to be activated or deactivated (for example, information (for example, X) indicating timing, time unit, subframe or time slot or symbol unit). For example, time information may be configured such that, if the UE received an RRC message indicating that a cell (for example, SCell) is to be activated or deactivated at the n^{th} time unit, the cell is to be completely activated or deactivated at the (n+X)^{th}. As another method, the time information (for example, X) may not be configured by the base station, but a pre-promised and defined fixed value may be used. As another example, time information may be configured such that, if random access is started (or preamble is transmitted) at the n^{th} time unit after receiving an RRC message indicating that a cell (for example, SCell or PSCell) is to be activated or deactivated, or if the random access is successfully completed, the cell is to be completely activated or deactivated at the (n+X)^{th}. As another method, the time information (for example, X) may not be configured by the base station, but a pre-promised and defined fixed value may be used. The X may be configured or promised with reference to the slot number, or may be configured or promised with reference to the shortest slot length among configured PCells or PSCells or SCells. When the cell group or cell is completely activated or suspended or deactivated or resumed, the UE may perform UE operations proposed in the disclosure according to each cell or BWP's state (for example, activated or dormant or deactivated). In addition, when the cell group or cell is completely activated or resumed, the UE's DRX operation may be started or restarted, or when the cell group or cell is completely deactivated or suspended, the UE's DRX operation may be suspended or deactivated.

The concept of a cell group proposed in the disclosure may be expanded to a sub-cell group. For example, a first cell group and a second cell group are configured such that dual connectivity is configured for a UE in the disclosure, and are applied as a master cell group and a secondary cell group such that dual connectivity is configured, and data can be transmitted or received with two base stations. However, if the concept of a cell group is expanded to a sub-cell group, multiple sub-cell groups may be configured in the cell group for a UE connected to one base station, or a sub-cell group identifier may be configured for each sub-cell group. Although the UE transmits or receives data with regard to one base station, an activation or suspension or resumption or deactivation procedure may be expanded and applied by means of the PDCCH or MAC control element or RRC message proposed in the disclosure with regard to different frequencies or cells for each sub-cell group. For example, when the UE communicates with one base station through multiple frequencies or cells, the base station may configure multiple sub-cell groups with regard to multiple frequencies or cells of the base station corresponding to the cell group (master cell group) such that the UE can apply carrier aggregation, and may define fields indicating the sub-cell groups, respectively, in the PDCCH or MAC control element or RRC message such that respective fields indicate activation or deactivation or suspension or resumption of respective sub-cell groups. The UE may apply an activation or suspension or resumption or deactivation procedure by means of the PDCCH or MAC control element or RRC message proposed in the disclosure with regard to different frequencies or cells for each sub-cell group. As another method, the proposed sub-cell group may be implemented by introducing a downlink or uplink logical channel restriction regarding each cell. For example, configuration information may be included in the RRC message and configured for the UE so as to restrict logical channels belonging to one cell group such that data can be transmitted or received with regard to a specific frequency or cell only. Logical channels (for example, logical channel identifiers) may be mapped to respective cells or frequencies as above and configured such that the logical channels are groups and are considered like the proposed sub-cell group, and fields indicating the cells, respectively, may be defined in the PDCCH or MAC control element or RRC message such that respective fields indicate activation or deactivation or suspension or resumption of respective cells.

In addition, if the master cell group detects a radio link failure when a UE for which the dual connectivity is configured in the disclosure transmits or receives data with the master or secondary cell group, or when the secondary cell group is suspended or deactivated, the UE may report the radio link failure to the secondary cell group or to the master cell group through the secondary cell group. For example, the UE may compose an RRC message for reporting the radio link failure and may transmit the same through a split SRB1 or SRB3, thereby reporting the same. If the split SRB1 is configured, the radio link failure may always be reported through the split SRB1. As another method, if the master cell group detects a radio link failure when the UE for which the dual connectivity is configured transmits or receives data with the master or secondary cell group, or when the secondary cell group is suspended or deactivated, the UE may announce a radio link failure and may perform an RRC connection re-establishment procedure.

In addition, if the secondary cell group detects a radio link failure when the UE for which the dual connectivity is configured in the disclosure transmits or receives data with the master or secondary cell group, or when the secondary cell group is suspended or deactivated, the UE may report the radio link failure to the master cell group or to the secondary cell group through the master cell group. For example, the UE may compose an RRC message for reporting the radio link failure and may transmit the same through a split SRB1 or SRB3, thereby reporting the same. If the SRB1 or split SRB1 is configured, the radio link failure may always be reported through the split SRB1.

The description that the secondary cell group is released when the UE has dual connectivity configured therefor in the disclosure mean that the connection (data transmission or reception) to the secondary cell group is released, or configuration information of the secondary cell group (or bearer configuration information or protocol layer device configuration information (PHY or MAC or RLC or PDCP or SDAP layer device)) is discarded or cleared. In contrast, the description that the secondary cell group is suspended or deactivated means that the connection (data transmission or reception) to the secondary cell group is released or suspended, but the configuration information of the secondary cell group (or bearer configuration information or protocol layer device configuration information (PHY or MAC or RLC or PDCP or SDAP layer device)) is maintained or suspended or stored, or connection to the secondary cell group can be quickly or activated later, based on the stored configuration information of the secondary cell group.

Next, the disclosure proposes that, if a frequency measurement procedure or a frequency measurement reporting procedure is configured for the UE through the RRC message (for example, RRCReconfiguration) of the disclosure, or if dual connectivity is configured for the UE, or if the frequency measurement procedure or frequency measurement reporting procedure is configured with regard to a cell group (or SCG), the UE prioritize the SRB3 and thus report the frequency measurement result through the SRB3, and proposes that the frequency measurement result be reported through the SRB1 (or MCG's SRB) only if there is no configured SRB3. However, it is proposed that the UE will not perform measurement reporting through the SRB3 if the cell group (SCG) is deactivated. For example, the disclosure proposes a procedure in which the UE performs frequency measurement result reporting through the SRB3, as long as the SRB3 is configured, only if the cell group is not deactivated. Alternatively, the disclosure proposes a procedure in which the frequency measurement result is reported through the SRB1 (or MCG's SRB) if the cell group is deactivated. This is because, if the frequency measurement result is reported through the SRB3 while the cell group (SCG) is deactivated, the cell group needs to be activated unnecessarily. Specific procedures of the UE are as follows:
1> If a frequency measurement procedure or a frequency measurement reporting procedure is configured to the UE,
2> If the UE is configured for (NG) EN-DC (or if the frequency measurement procedure or frequency measurement reporting procedure is configured with regard to a cell group (or SCG)),
3> If an SRB3 is configured for the UE, and the state of the cell group (SCG) is not configured to a deactivated state,
4> The UE submits a frequency measurement result report message to the lower layer device for transmission via (through) the SRB3.
3> Else,
4> The UE submits a frequency measurement result report message to the lower layer device for transmission via the SRB1 (or SRB of MCG (E-UTRA)).
2> If the UE is configured for NR-DC, or if the frequency measurement procedure or frequency measurement reporting procedure is configured with regard to a cell group (or SCG)),
3> If an SRB3 is configured for the UE, and the state of the cell group (SCG) is not configured to a deactivated state,
4> The UE submits a frequency measurement result report message to the lower layer device for transmission via the SRB3.
3> Else,
4> The UE submits a frequency measurement result report message to the lower layer device for transmission via the SRB1 (or SRB of MCG (E-UTRA)).

FIG. 1N illustrates operations of a UE according to an embodiment of the disclosure.

In FIG. 1N, the UE 1n-01 may receive a message (for example, DCI of PDCCH or MAC control element or RRC message) from a base station (1n-05). If the message includes cell group configuration information or a cell group state or a cell group indicator, the UE may identify whether configuration or addition or activation or resumption of a cell group is indicated or release or deactivation or suspension of the cell group is indicated (1n-10). If configuration or addition or activation or resumption of the cell group is indicated, the cell group configuration or addition or activation or resumption procedure proposed in the disclosure may be performed (1n-20). If release or deactivation or suspension of the cell group is indicated, the cell group release or deactivation or suspension procedure proposed in the disclosure may be performed (1n-30).

FIG. 1O illustrates signaling procedures regarding a conditional handover method according to an embodiment of the disclosure.

In FIG. 1O, the UE 1o-01 in an RRC connected mode state may report cell measurement information (measurement report) to the current source gNB 1o-02 periodically or if a specific event is satisfied (1o-05). In the cell measurement result reporting procedure, the UE 1o-01 may include multiple results regarding frequencies or cells if a predetermined condition configured in the RRC message is satisfied. Upon receiving the measurement result from the UE 1o-01, the source gNB 1o-02 may determine, based on the information, whether to configure (or indicate) a conditional reconfiguration procedure (conditional handover or conditional PCell change or conditional PSCell change or addition or release) or conditional SCG change (or addition or release) with regard to the UE 1o-01. The conditional reconfiguration procedure refers to a technology wherein the source gNB (or cell or cell group) 1o-02 which provides a service to the UE 1o-01 in an RRC connected mode state is changed (or added or released) to another gNB (or to another cell or another cell group of the same gNB), or the secondary cell group (or cell or SCG or PSCell) of the UE 1o-01 for which dual connectivity is configured is changed (or added or released) to another cell group (or cell or SCG or PSCell or to another cell in the same gNB or to a cell of another gNB), and is characterized in that conditions are configured for the 1o-01 to determine multiple target cell (or cell group or gNB) candidates and target cells (or cell groups), and the UE 1o-01 selects one target cell (or cell group) among the multiple target cells (or cell groups) according to the conditions and performs a conditional reconfiguration procedure. The conditions to determine target cells (or cell groups) may be variously configured as follows: the strength of a frequency signal will be higher than a configured threshold, the frequency will have signal synchronization performed first, or UE implementation will be determined due to absence of conditions.

If the source cell (or cell group) 1o-02 determined a conditional reconfiguration procedure, the source gNB 1o-02 may send a request message (handover over request or SCG (or PSCell) change or addition or modification request) to multiple new cell (or cell group or gNB) candidates to provide a service to the UE 1o-01, that is, to multiple target cell (or cell group or gNB) candidates (Target gNB 1, Target gNB 1o-03, 1o-04), thereby requesting the conditional reconfiguration procedure (1o-10). If the multiple target gNBs 1o-03, 1o-04 accept the conditional reconfiguration procedure request, a response message (for example, handover (or SCG (or PSCell) change or addition or modification) request Ack message) to the source cell (or cell group or gNB) 1o-02 (1o-15). Upon receiving the message, the source gNB 1o-02 may transmit a handover (HO) command message (or RRCReconfiguration) to the UE 1o-01 (1o-20). The RRCReconfiguration may include conditional reconfiguration configuration information (conditionalReconfiguration) as proposed in the RRC message configuration procedure (FIG. 1F) of the disclosure, and may configure (or indicate) a conditional reconfiguration procedure (conditional handover or conditional PCell change or conditional PSCell change or addition or release) or conditional SCG change (or addition or release).

When the source gNB 1o-02 transmits an RRC message (for example, RRC Reconfiguration message) to the UE 1o-01 in the conditional reconfiguration procedure, random access transmission resource information or preamble information or bearer configuration information or cell information or the like regarding multiple target cells (or cell groups or gNBs) 1o-03, 1o-04 in which the UE 1o-01 has to perform the conditional reconfiguration procedure may be configured in the RRC message, and an indicator may be used to define what kind of handover the UE 1o-01 has to perform. For example, respective indicators regarding multiple handover methods may be defined, and if one of the indicators is configured, the corresponding handover method may be configured to be performed by the UE 1o-01. The multiple handover methods may include a RACH-less handover method or a make before break (MBB) handover method or an enhanced make before break (eMBB) method or a conditional reconfiguration procedure method or the like. In addition, the handover command message may include an indicator indicating whether or not a PDCP state report is to be generated and transmitted to the source gNB 1o-02 or target gNB 1o-03, 1o-04 with regard to each bearer (UM DRB or AM DRB) of the UE 1o-01 or the PDCP layer device. In addition, if the conditional reconfiguration procedure is indicated, the RRC message may include a condition enabling the UE 1o-01 to select one target cell (or cell group or gNB) from multiple target cells (or cell groups or gNBs) 1o-03, 1o-04. The conditions to determine a target cell (or cell group or gNB) may be variously configured as follows: the strength of a frequency signal will be higher than a configured threshold, the frequency will have signal synchronization performed first, or UE implementation will be determined due to absence of conditions. In response to successful reception of the first RRCReconfiguration message 1o-20 from the source gNB 1o-02, the UE 1o-01 may transmit a first RRCReconifgurationComplete message 1o-23 to the source gNB 1o-02 (1o-23).

Upon receiving the RRC message, the UE 1o-01 may start a T304 timer and perform a conditional reconfiguration procedure. Specifically, the UE 1o-01 may start a cell reselection procedure or sell search procedure regarding multiple target cells (or cell groups or gNBs) 1o-03, 1o-04 or frequencies according to conditions included in the RRC message or UE implementation (10-25). If a target cell (or cell group or gNB) appropriate for the conditions or UE implementation is determined, the UE 1o-01 may attempt random access to the target cell (or cell group or gNB) 1o-03 (1o-40). The random access is for the purpose of informing the target cell 1o-03 that the UE 1o-01 is moving through a conditional reconfiguration procedure, and for making uplink synchronization. For the random access, the UE 1o-01 may transmit a preamble corresponding to a preamble ID received from the source gNB 1o-02 or a randomly selected preamble ID to the target cell 1o-03. After a specific number of subframes pass since preamble transmission, the UE 1o-01 may monitor whether a random access message (RAR) is transmitted from the target cell 1o-03. The monitoring time interval is referred to as a random access response (RAR) window. If a RAR is received during the specific time (1o-45), the UE 1o-01 may transmit a conditional reconfiguration completion message to the target gNB 1o-03 as a second RRC Reconfiguration Complete message (1o-55). The second RRCReconfigurationComplete message is a response message indicating that a conditional reconfiguration procedure was performed according to conditional reconfiguration information (conditionalReconfiguration) included in the received first RRCReconfiguration message 1o-20, one target cell (or cell group or gNB) was selected, configuration information of the second RRCReconfiguration message 1o-21 included in the conditional reconfiguration information corresponding to the target cell (or cell group or gNB) was applied, and the application was completed. The second RRCReconfigurationComplete message 1o-55 is transmitted to the target cell (or cell group or gNB) 1o-03 in response to the second RRCReconfiguration message 1o-21. Upon successfully receiving the RAR from the target gNB 1o-03, the UE 1o-01 may suspend or reset the T304 timer. The target gNB 1o-03 may request path modification to modify the path of bearers which has been configured to the source gNB 1o-02, and may notify the source gNB 1o-02 that UE context of the UE 1o-01 is to be deleted. Therefore, the UE 1o-01 may attempt data reception from the RAR window starting timepoint, with regard to the target gNB 1o-03, may transmit an RRC Reconfiguration Complete message after receiving the RAR 10-55, and may start transmission/reception with the target cell (or cell group or gNB) 1o-03.

As proposed in FIG. 1O, the conditional reconfiguration procedure (conditional handover or conditional PCell change or conditional PSCell change or addition or release) or conditional SCG change (or addition or release)) may be started or configured or indicated through a source gNB (or cell or cell group or master node (MN) or MCG).

Next, the disclosure proposes a procedure in which the conditional reconfiguration procedure is started or configured or indicated through a secondary base station (or cell or cell group or secondary node (SN) or SCG).

FIG. 1P illustrates a procedure in which a conditional reconfiguration procedure according to an embodiment of the disclosure is started through a secondary base station (or cell or cell group or secondary node (SN) or SCG) or configured or instructed through a source base station (or cell or cell group or master node (MN) or MCG).

In FIG. 1P, the UE may report a frequency measurement result to the secondary base station (or cell or cell group or secondary node (SN) or SCG) through the SRB1 or SRB3 (1p-05). The secondary base station (or cell or cell group or secondary node (SN) or SCG) may determine a conditional reconfiguration procedure, based on the measurement result, and may transmit a message including configuration information for the conditional reconfiguration procedure to the source base station (or cell or cell group or master node (MN) or MCG) to request the same to instruct the UE to perform a conditional reconfiguration procedure (1p-10). Upon receiving the message, the source base station (or cell or cell group or master node (MN) or MCG) may configure or instruct the UE to perform a conditional reconfiguration procedure, based on the procedure proposed in FIG. 1O, or the UE may perform a conditional reconfiguration procedure, based on the procedure proposed in FIG. 1O.

FIG. 1Q illustrates a procedure in which a conditional reconfiguration procedure according to an embodiment of the disclosure is started or configured or instructed through a secondary base station (or cell or cell group or secondary node (SN) or SCG).

In FIG. 1Q, the UE may report a frequency measurement result to the secondary base station (or cell or cell group or secondary node (SN) or SCG) through the SRB1 or SRB3 (1q-05). The secondary base station (or cell or cell group or secondary node (SN) or SCG) may determine a conditional reconfiguration procedure, based on the measurement result, and may transmit a message including configuration information for the conditional reconfiguration procedure directly (for example, through SRB3) to the UE (1q-10). Upon receiving the message, the UE may be configured or instructed to perform a conditional reconfiguration procedure, based on the procedure proposed in FIG. 1O, or the UE may perform a conditional reconfiguration procedure, based on the procedure proposed in FIG. 1O.

Next, the disclosure proposes efficient RRC message configuration methods capable of lowering the degree of complexity of UE implementation when implementing the procedure of deactivating (or activating) the cell or cell group state proposed in the disclosure, or conditional reconfiguration procedure.

In the first embodiment of the efficient RRC message configuration method, when the state of secondary cell group (or cell or cell group) is configured to be deactivated, or when the state of the secondary cell group (or cell or cell group) is already configured as a deactivated state, conditional reconfiguration configuration information (conditionalReconfiguration) to indicate the conditional reconfiguration procedure proposed in the disclosure (conditional handover or conditional PCell change or conditional PSCell change (conditional PSCell change or addition or release) or conditional SCG change (or addition or release)) is restricted to be configured, thereby lowering the degree of complexity of UE implementation. For example, when the RRC message configures the state of secondary cell group (or cell or cell group) is configured to be deactivated, or when the state of the secondary cell group (or cell or cell group) is already configured as a deactivated state, the conditional reconfiguration information (conditionalReconfiguration) may be restricted such that the same is absent in the RRC message, or cannot be configured (or included), or cannot be configured (or included) together. As another method, If the conditional reconfiguration information exists (is included) or is configured in the RRC message, it may be restricted such that the state of the secondary cell group (or cell or cell group) cannot be configured to be deactivated, or information that configures the state of the secondary cell group (or cell or cell group) does not exist (absent) (or cannot be configured or included).

Therefore, in order to configure the state of the secondary cell group (or cell or cell group) to be deactivated, it is after the conditional reconfiguration procedure is successfully completed, or if the conditional reconfiguration information (conditionalReconfiguration) does not exist (or is cleared) that the state of the secondary cell group (or cell or cell group) can be configured to be deactivated through an RRC message.

In addition, in order to configure the conditional reconfiguration information (conditionalReconfiguration), the conditional reconfiguration information (conditionalReconfiguration) may be configured through an RRC message after the state of the secondary cell group (or cell or cell group) is configured as an activated state, or with regard to the activated secondary cell group (or cell or cell group). As another method, if the RRC message includes configuration information for configuring the state of the secondary cell group (or cell or cell group) as an activated state, the conditional reconfiguration configuration information may be included and configured together in the RRC message.

In the second embodiment of the efficient RRC message configuration method, even when the state of secondary cell group (or cell or cell group) is configured to be deactivated, or even when the state of the secondary cell group (or cell or cell group) is already configured as a deactivated state, conditional reconfiguration configuration information (conditionalReconfiguration) may be configured to indicate the conditional reconfiguration procedure proposed in the disclosure (conditional handover or conditional PCell change or conditional PSCell change or addition or release) or conditional SCG change (or addition or release)) such that, when the state of secondary cell group (or cell or cell group) is activated, the UE can successfully perform a cell group addition or change procedure through the conditional reconfiguration procedure. However, the state of a cell group (or cell) cannot be configured as a deactivated state in each RRCReconfiguration information regarding multiple target cells (or cell group or secondary cell group) included in the conditional reconfiguration configuration information (conditionalReconfiguration), or the same is restricted such that configuration information for configuring the state of the cell group (or cell) does not exist (or is not included) therein, thereby always activating the cell or cell group after the conditional reconfiguration procedure. The degree of complexity of UE implementation may be reduced only if the cell or cell group is activated always as in the conditional reconfiguration procedure. That is, the number of cases of UE implementation may be reduced.

As another method, if the state of a cell group (or cell) can be configured as a deactivated state in each RRCReconfiguration information regarding multiple target cells (or cell group or secondary cell group) included in the conditional reconfiguration configuration information (conditionalReconfiguration), or if configuration information for configuring the state of the cell group (or cell) can be included therein, a new indicator may be introduced in the RRC message to indicate whether to start or suspend the conditional reconfiguration procedure, or to store configuration information only. For example, if the state of a target cell (or cell group) selected by the UE after performing the conditional reconfiguration procedure is configured as a deactivated state, the UE may be allowed to perform a random access procedure only if the new indicator is received. As another method, if the state of a target cell (or cell group) selected by the UE after performing the conditional reconfiguration procedure is configured as a deactivated state, the UE may perform a random access procedure to the target cell, may complete the conditional reconfiguration procedure, and may deactivate the cell or cell group (or may perform the procedure according to the base station's RRC message's instruction).

The third embodiment of the efficient RRC message configuration method proposes that, if the secondary cell group (or cell or PSCell) is changed in a conditional reconfiguration procedure (conditional PSCell change or additional or release or conditional SCG change or addition or release), and if a conditional reconfiguration procedure is performed with one of multiple cells in the same secondary cell group (or base station), the second embodiment of the efficient RRC message configuration method proposed in the disclosure is applied, and if a conditional reconfiguration procedure is performed with one of multiple cells in a different (or new) secondary cell group (or base station) instead of performing the conditional reconfiguration procedure with one of multiple cells in the same secondary cell group (or base station), the first embodiment of the efficient RRC message configuration method proposed in the disclosure is applied. That is, the above procedure is proposed because determining a conditional reconfiguration procedure in the same secondary base station can be easily implemented in the base station, but determining a conditional reconfiguration procedure in different base stations is complicated.

For example, if a conditional reconfiguration procedure is performed with one of multiple cells in the same secondary cell group (or base station), configuration information for indicating the cell group's state and conditional reconfiguration conditional reconfiguration can be configured as in the second embodiment of the efficient RRC message configuration method proposed in the disclosure, and if a conditional reconfiguration procedure is performed with one of multiple cells in a different (or new) secondary cell group (or base station) instead of performing the conditional reconfiguration procedure with one of multiple cells in the same secondary cell group (or base station), configuration information for indicating the cell group's state and conditional reconfiguration conditional reconfiguration may be restricted and thus cannot be configured together, as in the first embodiment of the efficient RRC message configuration method proposed in the disclosure.

In addition, if the UE has conditional reconfiguration information configured therefor regarding the secondary cell group, or if the UE is performing the conditional reconfiguration procedure, and if configuration information indicating the state of the secondary cell group to be a deactivated state is received through the RRC message, the UE may release the conditional reconfiguration configuration information. If the cell or cell group state is configured as a deactivated state as above, conditional reconfiguration configuration information which has been configured, or which is being performed, may be released (or the conditional reconfiguration procedure may be suspended), thereby simplifying UE implementation.

The disclosure proposes a procedure (MCG failure recovery) such that, if a UE for which dual connectivity is configured detected a radio link failure regarding the MCG, but if the radio link regarding the SCG is valid (or if no radio link failure is detected), the radio link failure regarding the MCG is reported to the SCG through a split SRB (for example, split SRB1) or SRB3, or the SCG informs the MCG of the radio link failure regarding the MCG of the UE such that the radio link regarding the MCG can be quickly recovered. A fifth timer configured in the RRC message may be started when a radio link failure regarding the MCG is reported, and when a message is transmitted to report the MCG link failure. The fifth timer may be suspended if an RRCRelease or RRCReconfiguration message is received as a response message to the failure report message through the SCG, or the MCG radio link may be restored according to the response message.

Next, the disclosure proposes an efficient procedure of the UE regarding the MCG link failure recovery procedure if the state of the secondary cell group or cell is configured as a deactivated state, or has been configured as a deactivated state.
1> If a DAPS bearer has been configured, and if the first timer T304 is being driven,
2> When the second timer (T310) timer has expired in the source SpCell,
2> When an indication or the occurrence of a random access problem is received from the source MCG MAC layer device,
2> When an indication that the maximum number of retransmission is reached was received from the source MCG MAC layer device,
2> When a continuous listen before talk (LBT) failure indicator is received from the source MCG MAC layer device,
3> It is considered that a radio link failure is detected with regard to the source MCG.
3> Transmission or reception is suspended with regard to all bearers (for example, DRBs) configured for the source MCG.
3> The MAC layer device regarding the source MCG is reset.
3> The source link is released.
1> Else (or if no DAPS bearer has been configured, or if the first timer T304 is not being driven,
2> If a DAPS handover is being performed, the following procedure is applied to the target PCell.
2> When the second timer (T310) timer has expired in the PCell,
2> When the third timer (T312) timer has expired in the PCell,
2> When the T300 or T301 or T304 or T311 or T319 timer is not being driven, and when an indication or the occurrence of a random access problem is received from the source MCG MAC layer device,
2> When an indication that the maximum number of retransmission is reached was received from the source MCG MAC layer device,
2> If connected to an integrated access and backhaul (IAB) radio node, and when a backhaul radio link failure (RLF) indication is received from the BAP layer device of the MCG,
2> When a continuous listen before talk (LBT) failure indicator is received from the source MCG MAC layer device while the first timer (T304) is not being driven,
3> If the indicator was received from the MCG RLC layer device, if carrier aggregation (CA) duplication is configured, if activated with regard to the MCG, and if a corresponding (or transmittable) logical channel (allowedServingCells) includes only SCells with regard to the duplication procedure,
4> A procedure of reporting the failure of the RLC layer device is performed.
3> Else,
4> It is considered that a radio link failure was detected with regard to the source MCG.
4> If there exists a divided RRC message segment of an RRC message, the same is discarded.
4> If a security function (AS security) is not activated,
5> The reason of disconnection is configured as “other”, and a procedure of transitioning to an RRC idle mode is performed.
4> If the security function is activated, but if at least one DRB is not established (or configured) with the SRB2, or if there is no SRB2 established (or configured) with the IAB, 5> Radio link failure information may be stored.
5> The reason of disconnection is configured as “RRC connection failure”, and a procedure of transitioning to an RRC idle mode is performed.
4> Else,
5> Radio link failure information may be stored.
5> If the fifth timer (T316) is configured,
5> And if SCG transmission is not suspended, or if the state of the SCG is not configured (or indicated or included) as a deactivated state, or if state configuration information of the SCG is not configured (or indicated or included) as a deactivated state,
5> Or if PSCell change or addition is not being performed (or if the first timer (T304) regarding the NR PSCell is not being driven, or if the timer (T307) regarding the E-UTRA PSCell is not being driven,
6> The UE may start a procedure for transmitting an MCG failure report message.
Else,
6> The UE may perform an RRC connection reestablishment procedure.

If the UE receives the RRC message while the fifth timer (T316) is being driven, and if the RRC message indicates the state regarding the secondary cell group as a deactivated state, the UE may suspend the fifth timer or consider the same as expired, or may perform an RRC connection reestablishment procedure.

In addition, it is proposed that, if the fifth timer (T316) has been configured for the UE, and if the state of the secondary cell group (SCG) has been configured as a deactivated state even though a radio link failure occurred in the MCG, the fifth timer will not be started. This is because, if the SCG's state is a deactivated state, the MCG link failure cannot be reported through the SCG. For example, if the fifth timer (T316) has been configured for the UE, and if a radio link failure occurred in the MCG, the MCG link failure reporting procedure may be started, and the fifth timer may be started, only if the state of the SCG is not configured as a deactivated state.

As another method, if the fifth timer (T316) has been configured for the UE, and if a radio link failure occurred in the MCG, or if the state of the SCG is configured as a deactivated state, the UE may send a message (RRC message or random access procedure or SR transmission or designated preamble or MAC control element) to the secondary cell group to request that the state of the SCG be configured as an activated state (for example, the message may be transmitted through SRB3), or may perform the procedure proposed in the disclosure wherein the UE requests the base station (MCG or SCG) to activate the secondary cell group when uplink data occurred in the secondary cell group.

FIG. 1R illustrates the structure of a UE according to an embodiment of the disclosure.

Referring to FIG. 1R, the UE includes a radio frequency (RF) processing unit 1r-10, a baseband processing unit 1r-20, a storage unit 1r-30, and a controller 1r-40.

The RF processing unit 1r-10 performs functions for transmitting/receiving signals through a radio channel, such as signal band conversion and amplification. That is, the RF processing unit 1r-10 up-converts a baseband signal provided from the baseband processing unit 1r-20 to an RF band signal, transmits the same, and down-converts an RF band signal received through the antenna. For example, the RF processing unit 1r-10 may include a transmission filter, a reception filter, an amplifier, a mixer, an oscillator, a digital-to-analog converter (DAC), and an analog-to-digital converter (ADC) and the like. Although only one antenna is illustrated in FIG. 1R, the UE may include multiple antennas. In addition, the RF processing unit 1r-10 may include multiple RF chains. Furthermore, the RF processing unit 1r-10 may perform beamforming. For the beamforming, the RF processing unit 1r-10 may adjust the phase and magnitude of signals transmitted/received through multiple antennas or antenna elements, respectively. In addition, the RF processing unit 1r-10 may perform MIMO, and may receive multiple layers when performing a MIMO operation. The RF processing unit 1r-10 may appropriately select multiple antennas or antenna elements under the control of the controller 1r-40 so as to perform received beam sweeping, or may adjust the direction and beam width of received beams such that received beams are coordinated with transmitted beams.

The baseband processing unit 1r-20 performs functions of conversion between baseband signals and bitstrings according to the system's physical layer specifications. For example, during data transmission, the baseband processing unit 1r-20 encodes and modulates a transmitted bitstring to generate complex symbols. In addition, during data reception, the baseband processing unit 1r-20 demodulates and decodes a baseband signal provided from the RF processing unit 1r-10 to restore a received bitstring. For example, when following the orthogonal frequency division multiplexing (OFDM) scheme, during data transmission, the baseband processing unit 1r-20 encodes and modulates a transmitted bitstring to generate complex symbols, maps the complex symbols to subcarriers, and configures OFDM symbols through inverse fast Fourier transform (IFFT) operation and cyclic prefix (CP) insertion. In addition, during data reception, the baseband processing unit 1r-20 splits a baseband signal provided from the RF processing unit 1r-10 at the OFDM symbol level, restores signals mapped to subcarriers through fast Fourier transform (FFT) operation, and restores a received bitstring through demodulation and decoding.

The baseband processing unit 1r-20 and the RF processing unit 1r-10 transmit and receive signals as described above. Therefore, the baseband processing unit 1r-20 and the RF processing unit 1r-10 may be referred to as a transmitter, a receiver, a transceiver, or a communication unit. Furthermore, at least one of the baseband processing unit 1r-20 and the RF processing unit 1r-10 may include multiple communication modules to support multiple different radio access technologies. In addition, at least one of the baseband processing unit 1r-20 and the RF processing unit 1r-10 may include different communication modules to process signals in different frequency bands. For example, the different radio access technologies may include LTE networks, NR networks, and the like. In addition, the different frequency bands may include a super high frequency (SHF) (for example, 2.5 GHz, 5 Ghz) bands and millimeter wave (for example, 60 GHz) bands.

The storage unit 1r-30 stores data such as basic programs for operation of the UE, application programs, configuration information. The storage unit 1r-30 provides the stored data at the request of the controller 1r-40.

The controller 1r-40 controls overall operations of the UE. For example, the controller 1r-40 transmits/receives signals through the baseband processing unit 1r-20 and the RF processing unit 1r-10. In addition, the controller 1r-40 records and reads data in the storage unit 1r-40. To this end, the controller 1r-40 may include at least one processor. For example, the controller 1r-40 may include a communication processor (CP) configured to perform control for communication, and an application processor (AP) configured to control upper layers such as application programs.

FIG. 1S illustrates the block configuration of a base station according to an embodiment of the disclosure.

Referring to FIG. 1S, the base station includes an RF processing unit 1s-10, a baseband processing unit 1s-20, a backhaul communication unit 1s-30, a storage unit 1s-40, and a controller 1s-50.

The RF processing unit 1s-10 performs functions for transmitting/receiving signals through a radio channel, such as signal band conversion and amplification. That is, the RF processing unit 1s-10 up-converts a baseband signal provided from the baseband processing unit 1s-20 to an RF band signal, transmits the same, and down-converts an RF band signal received through the antenna. For example, the RF processing unit 1s-10 may include a transmission filter, a reception filter, an amplifier, a mixer, an oscillator, a DAC, and an ADC. Although only one antenna is illustrated in FIG. 1S, the base station include multiple antennas. In addition, the RF processing unit 1s-10 may include multiple RF chains. Furthermore, the RF processing unit 1s-10 may perform beamforming. For the beamforming, the RF processing unit 1s-10 may adjust the phase and magnitude of signals transmitted/received through multiple antennas or antenna elements, respectively. The RF processing unit Is transmit one or more layers to perform a downward MIMO operation.

The baseband processing unit 1s-20 performs functions of conversion between baseband signals and bitstrings according to the physical layer specifications of first radio access technology. For example, during data transmission, the baseband processing unit 1s-20 encodes and modulates a transmitted bitstring to generate complex symbols. In addition, during data reception, the baseband processing unit 1s-20 demodulates and decodes a baseband signal provided from the RF processing unit 1s-10 to restore a received bitstring. For example, when following the OFDM scheme, during data transmission, the baseband processing unit 1s-20 encodes and modulates a transmitted bitstring to generate complex symbols, maps the complex symbols to subcarriers, and configures OFDM symbols through IFFT operation and CP insertion. In addition, during data reception, the baseband processing unit 1s-20 splits a baseband signal provided from the RF processing unit 1s-10 at the OFDM symbol level, restores signals mapped to subcarriers through FFT operation, and restores a received bitstring through demodulation and decoding. The baseband processing unit 1s-20 and the RF processing unit 1s-10 transmit and receive signals as described above. Therefore, the baseband processing unit 1s-20 and the RF processing unit 1s-10 may be referred to as a transmitter, a receiver, a transceiver, or a communication unit.

The backhaul communication unit 1s-30 provides an interface for communicating with other nodes in the network.

The storage unit 1s-40 stores data such as basic programs for operation of the base station, application programs, configuration information. Particularly, the storage unit 1s-40 may store regarding a bearer allocated to a connected UE, a measurement result reported from the connected UE, and the like. In addition, the storage unit 1s-40 may store information serving as a reference to determine whether to provide multi-connection to a UE or to suspend the same. In addition, the storage unit 1s-40 provides the stored data at the request of the controller 1s-50.

The controller 1s-50 controls overall operations of the base station. For example, the controller 1s-50 transmits/receives signals through the baseband processing unit 1s-20 and the RF processing unit 1s-10 or through the backhaul communication unit 1s-30. In addition, the controller 1s-50 records and reads data in the storage unit 1s-40. To this end, the controller 1s-50 may include at least one processor.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

What is claimed is:

1. A method performed by a terminal in a wireless communication system, the method comprising:
receiving, from a base station, a first message comprising configuration information related to conditional reconfiguration;
selecting a cell or a cell group in case that a preconfigured condition is satisfied based on the configuration information related to the conditional reconfiguration; and
performing a random access procedure with the cell or the cell group,
wherein, in case that the first message comprises the configuration information related to the conditional reconfiguration, the first message does not comprise information indicating that a secondary cell group (SCG) is in a deactivated state.

2. The method of claim 1, wherein the conditional reconfiguration comprises at least one of conditional handover, conditional primary cell (PCell) addition, conditional PCell change, conditional primary secondary cell (PSCell) addition, or conditional PSCell addition.

3. The method of claim 1, further comprising:
receiving, from the base station, a second message for radio resource control (RRC) reconfiguration,
wherein, in case that the conditional reconfiguration is configured for the terminal according to the first message, the second message does not comprise information indicating that the SCG is in a deactivated state.

4. The method of claim 1, further comprising:
in case that the first message comprises configuration information related to frequency measurement, the terminal is configured for dual connectivity (DC), the SCG is not in a deactivated state, and a signaling radio bearer 3 (SRB3) is configured for the terminal, submitting a frequency measurement report message to a lower layer device to transmit the frequency measurement report message via the SRB3.

5. A method performed by a base station in a wireless communication system, the method comprising:
transmitting, to a terminal, a first message comprising configuration information related to conditional reconfiguration; and
receiving, from the terminal, a random access preamble regarding a cell or a cell group related to the base station selected in case that a preconfigured condition is satisfied based on the configuration information related to the conditional reconfiguration,
wherein, in case that the first message comprises the configuration information related to the conditional reconfiguration, the first message does not comprise information indicating that a secondary cell group (SCG) is in a deactivated state.

6. The method of claim 5, wherein the conditional reconfiguration comprises at least one of conditional handover, conditional primary cell (PCell) addition, conditional PCell change, conditional primary secondary cell (PSCell) addition, or conditional PSCell addition.

7. The method of claim 5, further comprising:
transmitting, to the terminal, a second message for radio resource control (RRC) reconfiguration,
wherein, in case that the conditional reconfiguration is configured for the terminal according to the first message, the second message does not comprise information indicating that the SCG is in a deactivated state.

8. A terminal in a wireless communication system, the terminal comprising:
a transceiver; and
a controller coupled with the transceiver and configured to:
receive, from a base station, a first message comprising configuration information related to conditional reconfiguration,
select a cell or a cell group in case that a preconfigured condition is satisfied based on the configuration information related to the conditional reconfiguration, and
perform a random access procedure with the cell or the cell group,
wherein, in case that the first message comprises the configuration information related to the conditional reconfiguration, the first message does not comprise information indicating that a secondary cell group (SCG) is in a deactivated state.

9. The terminal of claim 8, wherein the conditional reconfiguration comprises at least one of conditional handover, conditional primary cell (PCell) addition, conditional PCell change, conditional primary secondary cell (PSCell) addition, or conditional PSCell addition.

10. The terminal of claim 8,
wherein the controller is configured to receive, from the base station, a second message for radio resource control (RRC) reconfiguration, and
wherein, in case that the conditional reconfiguration is configured for the terminal according to the first message, the second message does not comprise information indicating that the SCG is in a deactivated state.

11. The terminal of claim 8, wherein the controller is configured to, in case that the first message comprises configuration information related to frequency measurement, the terminal is configured for dual connectivity (DC), the SCG is not in a deactivated state, and a signaling radio bearer 3 (SRB3) is configured for the terminal, submit a frequency measurement report message to a lower layer device to transmit the frequency measurement report message via the SRB3.

12. A base station in a wireless communication system, the base station comprising:
a transceiver; and
a controller coupled with the transceiver and configured to:
transmit, to a terminal, a first message comprising configuration information related to conditional reconfiguration, and
receive, from the terminal, a random access preamble regarding a cell or a cell group related to the base station selected in case that a preconfigured condition is satisfied based on the configuration information related to the conditional reconfiguration,
wherein, in case that the first message comprises the configuration information related to the conditional reconfiguration, the first message does not comprise information indicating that a secondary cell group (SCG) is in a deactivated state.

13. The base station of claim 12, wherein the conditional reconfiguration comprises at least one of conditional handover, conditional primary cell (PCell) addition, conditional PCell change, conditional primary secondary cell (PSCell) addition, or conditional PSCell addition.

14. The base station of claim 12,
wherein the controller is configured to transmit, to the terminal, a second message for radio resource control (RRC) reconfiguration, and
wherein, in case that the conditional reconfiguration is configured for the terminal according to the first message, the second message does not comprise information indicating that the SCG is in a deactivated state.
